(19) United States
(12) Patent Application Publication
(10) Pub. No.: US 2026/0310859 A1
(43) Pub. Date: Oct. 8, 2026

(54) DIGITAL TWINS OF CHEMICAL PRODUCTS

(71) Applicant: BASF SE, Ludwigshafen am Rhein (DE)

(72) Inventors: Felipe BUSTILLO MEDINA, Madrid (ES); George Valentin UTUTUI, Madrid (ES); Guel BEKCIOGLU-NEFF, Ludwigshafen am Rhein (DE); Gabriele ECKARDT, Ludwigshafen am Rhein (DE); Claudia Elena HERRERA GARCIA, Madrid (ES); Carsten HOFF, Ludwigshafen am Rhein (DE)

(21) Appl. No.: 19/474,876

(22) PCT Filed: Mar. 28, 2024
(86) PCT No.: PCT/EP2024/058425

§ 371 Date: Oct. 13, 2025

(30) Foreign Application Priority Data
Apr. 12, 2023 (EP) 23167499.5

(51) Int. Cl. G06F 30/27

(52) U.S. Cl. CPC G06F 30/27

(57) ABSTRACT

The present disclosure relates to an apparatus and a system for generating a digital twin associated with a chemical product and a respective computer program element, a computer-implemented method for generating a digital twin associated with a chemical product and a respective computer program element, methods for providing a chemical product associated with such a digital twin and respective apparatuses and a respective computer program element, a use of the digital twin, a chemical product associated with such a digital twin, such a digital twin, and a computer-implemented method for generating a digital access element associated with such a digital twin and a respective computer program element.

### TECHNICAL FIELD

The present disclosure relates to an apparatus and a system for generating a digital twin associated with a chemical product and a respective computer program element, a computer-implemented method for generating a digital twin associated with a chemical product and a respective computer program element, methods for providing a chemical product associated with such a digital twin and respective apparatuses and a respective computer program element, a use of the digital twin, a chemical product associated with such a digital twin, such a digital twin, and a computer-implemented method for generating a digital access element associated with such a digital twin and a respective computer program element.

### TECHNICAL BACKGROUND

In the supply of chemical products multiple regulatory requirements need to be met, which differ depending on the chemical product. For instance, in automotive supply chains chemical companies provide standardized information using the International Chemical Product Data System (IMDS). Such system allows to collect data along the entire automotive supply chain. Participants in the automotive supply chain register with the IMDS service and maintain product entries in the central database as provided and hosted by a third-party provider.

Systems like IMDS are static regarding data, prone to error and cumbersome in handling or maintenance. Owing to the highly specific and centralized setup of such systems, generation, exchange and sharing of digital twins of chemical products is laborious. Hence, there is a need to simplify generation, exchange and sharing of digital twins of chemical products.

### SUMMARY OF THE INVENTION

In an aspect, the disclosure relates to an apparatus for generating a digital twin of a chemical product, the apparatus comprising: one or more computing nodes; and one or more computer-readable media having thereon computer-executable instructions which, when executed by the one or more computing nodes, configure the apparatus to perform the steps of:
receiving a request to generate the digital twin, the request including data related to the chemical product and data related to at least one aspect model associated with chemical products,
gathering data associated with the chemical product from one or more distributed data sources based on the received data related to the chemical product, wherein the data associated with the chemical product includes at least one measured physical and/or chemical property of the chemical product and/or at least one physical and/or chemical property determined from collected data associated with a production and/or a use of the chemical product,
providing a decentral digital twin identifier associated with the gathered data and optionally a data owner,
retrieving—based on the received data related to the at least one aspect model—at least one aspect model associated with chemical products,
generating—for each retrieved aspect model—a digital twin data set by applying the respective aspect model to the gathered data,
generating the digital twin including the provided decentral identifier and at least part of the generated digital twin data sets.

In another aspect the disclosure relates to an apparatus for generating a digital twin of a physical entity of a chemical product, the apparatus comprising:
at least one data gathering unit configured to receive a request to generate the digital twin, the request including data related to the chemical product and data related to at least one aspect model associated with chemical products, and in response to the request, configured to gather data associated with the chemical product from one or more distributed data sources based on the received data related to the chemical product, wherein the data associated with the chemical product includes at least one measured physical and/or chemical property of the chemical product and/or at least one physical and/or chemical property determined from collected data associated with a production and/or a use of the chemical product,
at least one decentral identifier provider configured to provide a decentral digital twin identifier associated with the gathered data and optionally a data owner, and
at least aspect agent configured to retrieve-based on the received data related to the at least one aspect model-at least one aspect model associated with chemical products and to generate-for each retrieved aspect model-a digital twin data set by applying the respective aspect model to the gathered data,
at least one digital twin generator configured to generate the digital twin including the provided decentral identifier and at least part of the generated digital twin data sets.

In yet another aspect the disclosure relates to a system for generating a digital twin of a physical entity of a chemical product, the system comprising:
a data source layer configured to provide data associated with the chemical product from one or more distributed data source(s), wherein the data associated with the chemical product includes the at least one measured physical and/or chemical property of the chemical product and/or at least one physical and/or chemical property determined from collected data associated with a production and/or a use of the chemical product,
optionally a service layer configured to gather the data provided by the one or more distributed data source(s), to optionally transform the gathered data, and to provide the gathered or transformed data,
a consumer layer configured to consume the data provided by the one or more distributed data sources or provided by the service layer and to generate the digital twin according to the computer-implemented method for generating the digital twin as disclosed herein or by the apparatus for generating the digital twin as disclosed herein, and
optionally a connector layer comprising at least one decentral data providing network node configured to provide access to the generated digital twin and/or to at least one digital twin data set contained in the digital twin by at least one decentral data consuming network node associated with a decentral network participant.

In an aspect the disclosure relates to a computer-implemented method for generating a digital twin of a physical entity of a chemical product, the method comprising:
receiving a request to generate the digital twin, the request including data related to the chemical product and data related to at least one aspect model associated with chemical products,
gathering data associated with the chemical product from one or more distributed data sources based on the received data related to the chemical product, wherein the data associated with the chemical product includes the at least one measured physical and/or chemical property of the chemical product and/or at least one physical and/or chemical property determined from collected data associated with a production and/or the use of a chemical product,
providing a decentral digital twin identifier associated with the gathered data and optionally a data owner, and
retrieving—based on the received data related to the at least one aspect model—at least one aspect model associated with chemical products,
generating—for each retrieved aspect model—a digital twin data set by applying the respective aspect model to the gathered data,
generating the digital twin including the provided decentral digital twin identifier and at least part of the generated digital twin data sets.

In yet another aspect the disclosure relates to an apparatus for providing a chemical product associated with a digital twin, the apparatus comprising:
a requestor configured to generate a request to generate the digital twin, the request including data related to the chemical product and data related to at least one aspect model associated with chemical products,
at least one apparatus or system for generating a digital twin of a physical entity of a chemical product as disclosed herein,
at least one assignor configured to assign a physical identifier associated with the chemical product to the decentral digital twin identifier included in the digital twin.

In yet another aspect the disclosure relates to a system for providing a chemical product associated with a digital twin, the system comprising:
a chemical production configured to produce the chemical product from one or more input materials,
a requestor configured generate a request to generate the digital twin, the request including data related to the chemical product and data related to at least one aspect model associated with chemical products,
an apparatus or a system for generating a digital twin of a physical entity of a chemical product as disclosed herein, and
an assignor configured to assign a physical identifier associated with the produced chemical product to the decentral identifier included in the digital twin.

In yet another aspect the disclosure relates to a method for providing a chemical product associated with a digital twin, the method comprising:
producing the chemical product from one or more input materials by a chemical production,
generating the digital twin according to the computer-implemented method for generating the digital twin as disclosed herein or by the apparatus for generating the digital twin as disclosed herein or by the system for generating the digital twin as disclosed herein, and
assigning a physical identifier associated with the produced chemical product to the decentral digital twin identifier included in the digital twin.

In yet another aspect the disclosure relates to a computer-implemented method for providing a chemical product associated with a digital twin, wherein the chemical product is produced from one or more input materials by a chemical production, the method comprising:
receiving a request to generate the digital twin, the request including data related to the chemical product and data related to at least one aspect model associated with chemical products,
gathering data associated with the chemical product from one or more distributed data sources based on the received data related to the chemical product, wherein the data associated with the chemical product includes the at least one measured physical and/or chemical property of the chemical product and/or at least one physical and/or chemical property determined from collected data associated with a production and/or a use of the chemical product,
providing, based on a physical identifier associated with the chemical product, a decentral digital twin identifier associated with the gathered data and optionally a data owner, and assigning the provided decentral digital twin identifier to the physical identifier,
retrieving at least one aspect model associated with chemical products based on the received data related to the at least one aspect model,
generating—for each retrieved aspect model—a digital twin data set by applying the respective aspect model to the gathered data, and
generating the digital twin including the decentral identifier and at least part of the generated digital twin data sets.

In yet another aspect the disclosure relates to an apparatus for providing a chemical product associated with a digital twin, the apparatus comprising: one or more computing nodes and one or more computer-readable media having thereon computer-executable instructions which, when executed by the one or more computing nodes, configure the apparatus to perform the method for providing the chemical product associated with the digital twin as disclosed herein.

In yet another aspect the disclosure relates to a computer-implemented method for providing access to a digital twin of a physical entity of a chemical product, wherein the access to the digital twin by one or more decentral data consuming network node(s) associated with decentral participant(s) of a decentral network is controlled by a decentral data providing network node associated with the digital twin and wherein the digital twin is generated according to the computer-implemented method for generating the digital twin as disclosed herein or by the apparatus for generating the digital twin as disclosed herein or by the system for generating the digital twin as disclosed herein, the method comprising:
receiving at the decentral data providing network node associated with the digital twin a request to access the digital twin or a part thereof by the at least one decentral data consuming network node, wherein the request contains the decentral identifier associated with the digital twin,
optionally authenticating and/or authorizing the request to access the digital twin or the part thereof by the decentral data providing network node,
based on the decentral digital twin identifier and optionally the authentication and/or authorization, providing the decentral data consuming network node access to the digital twin or a part thereof by the decentral data providing network node.

In yet another aspect the disclosure relates to a use of a digital twin as generated according to the computer-implemented for generating the digital twin as disclosed herein or by the apparatus for generating the digital twin as disclosed herein or by the system for generating the digital twin as disclosed herein to process the chemical product associated with the digital twin.

In yet another aspect the disclosure relates to a chemical product associated with a digital twin, wherein the digital twin is generated according to the computer-implemented method for generating the digital twin as disclosed herein or by the apparatus for generating the digital twin as disclosed herein or by the system for generating the digital twin as disclosed herein.

In yet another aspect the disclosure relates to a chemical product associated with a digital twin, wherein the chemical product associated with the digital twin is provided according to the methods, apparatuses or systems as claimed herein.

In yet another aspect the disclosure relates to a digital twin as generated according to the methods, by the apparatus or by the system as disclosed herein.

In yet another aspect the disclosure relates to a computer-implemented method for generating a digital access element associated with a digital twin of a chemical product, said method comprising:
generating the digital twin associated with the chemical product according to the computer-implemented method for generating the digital twin as disclosed herein or by the apparatus for generating the digital twin as disclosed herein or by the system for generating the digital twin as disclosed herein,
receiving a request to provide a decentral access element identifier associated with the digital twin of the chemical product,
in response to the request, providing the decentral access element identifier and generating the access element including the provided decentral access element identifier associated with the digital twin and access data,
optionally providing the generated digital access element for access to the digital twin or a part thereof by a decentral data consuming network node under control by a decentral data providing network node associated with a data owner of the digital twin or the part thereof.

In yet another aspect the disclosure relates to an apparatus for or generating an access element associated with a digital twin of a chemical product, the apparatus comprising: one or more computing nodes; and one or more computer-readable media having thereon computer-executable instructions which, when executed by the one or more computing nodes, configure the apparatus to perform the method for generating a chemical product passport associated with a digital twin of a chemical product.

In another the disclosure relates to a computer element, such as a computer readable storage medium, a computer program, or a computer program product, comprising instructions, which when executed by a computing node or a computing system, direct the computing node or computing system to carry out the steps of the computer-implemented methods disclosed herein.

In another aspect the disclosure relates to a computer element, such as a computer readable storage medium, a computer program, or a computer program product, comprising instructions, which when executed by the apparatuses or systems disclosed herein, direct the apparatuses or systems to carry out steps the apparatuses or systems disclosed herein are configured to execute.

Any disclosure, embodiments and examples described herein relate to the methods, the systems, the apparatuses, the digital twins, the chemical products, the uses, the digital access elements, and computer elements lined out above and below. Advantageously, the benefits provided by any of the embodiments and examples equally apply to all other embodiments and examples.

### Embodiments

The methods, apparatuses, systems, digital twins, chemical products, uses, digital access elements and computer elements disclosed herein provide an efficient, secure and robust way for generating digital twins of chemical products having a highly defined data structure from various data associated with chemical products, allowing sharing and exchange of said digital twins across different participant nodes in chemical value chains. Using a layered approach to generate the digital twins ensures availability, integrity and confidentiality. In particular, the digital twins can be generated from data contained in multiple distributed data sources, such as different distributed databases. The digital twin may correspond to the digital representation of a physical entity of a chemical product. The digital twin may be linked with the chemical product via a linking of the decentral identifier included in the digital twin with a physical identifier physically connected to the chemical product, hence allowing to share data of a chemical product in the virtual world using the decentral digital twin identifier included in the digital twin. For example, the chemical product comprising the physical identifier may be provided from a chemical product producer to a chemical product consumer while the digital twin of said chemical product may be shared with said chemical product consumer in a decentral network by a decentral data consuming network node associated with the chemical product consumer requesting access to said digital twin or a part thereof at a decentral data providing network node associated with the chemical product producer using the decentral digital twin identifier linked to the physical identifier. Sharing of the digital twin or the part thereof may be controlled via the decentral data providing network node by the data owner of the digital twin or the part thereof, such as the chemical product producer. The decentral data providing network node may implement one or more authorization mechanisms, such that sharing or exchange of the digital twin or a part thereof may be conducted in a more flexible manner with multiple decentral data consuming network nodes from different participants of the chemical supply chain accessing the digital twin or a part thereof. The data owner may thus control access by participant nodes or data consuming services of the decentral network to the digital twin or parts thereof. This way, the digital twin or a part thereof can be shared securely and under the sovereignty of the data owner within the decentral network. This way, a more reliable and efficient further processing of supplied chemical product by upstream participants of the chemical supply chain can be achieved, while the digital twin or part thereof remains in the ownership of the chemical supplier supplying the upstream participant.

It is an object of the present invention to provide digital twins of chemical products having a highly defined data structure which can be shared in a simplified and flexible manner from chemical industry to chemical supply chain participants. These and other objects, which become apparent upon reading the following description, are solved by the subject matters of the independent claims. The dependent claims refer to preferred embodiments of the invention.

In the following, embodiments of the present disclosure will be outlined by ways of examples. It is to be understood that the present disclosure is not limited to said embodiments and/or examples.

In an embodiment, the digital twin of the chemical product may be a digital representation of a physical entity of the chemical product with a defined semantic description of said physical entity of the chemical product. The digital twin of the physical entity of the chemical product is hence a digital version of said physical entity. Once created, the digital twin can be used to represent the physical entity of the chemical product in a digital representation of a real-world system. The digital twin may be uniquely linked to the physical chemical product via at least the decentral digital twin identifier. The digital twin may be created such that it is identical in form and behavior of the corresponding chemical product. Additionally, the digital twin may mirror the properties of the chemical product during its lifetime. For example, sensors may capture real-time (or near real-time) data, such as transport data or use data, from the physical chemical product to relay it back to a remote digital twin. The digital twin may then be updated to maintain its correspondence to the physical entity of the chemical product. Hence, the digital twin may at any time represent the current state of the physical entity of the chemical product. The digital twin may contain one or more digital twin data sets. At least one digital twin data set may contain at least one measured physical and/or chemical property of the chemical product and/or at least one physical and/or chemical property determined from collected data associated with the production and/or the use of the chemical product. Each digital twin data set may contain defined chemical product data. Each digital twin data set may be associated with the decentral digital twin identifier. Each digital twin data set may further be associated with a digital twin data set identifier. This allows to uniquely identify each digital twin data set contained in the digital twin by using the digital twin data set identifier associated with said digital twin data set. The digital twin may comprise the decentral digital twin identifier, the digital twin data set(s) and digital twin data set identifier(s) associated with the digital twin data set(s). The digital twin may further contain a chemical product identifier.

In an embodiment, the chemical product may be a chemical product obtained from at least one chemical reaction. The chemical product may include natural chemical products. Natural chemical products may include any chemical product that is produced by nature without human interaction or intervention, i.e. any unprocessed chemical substance that is found in nature, such as chemicals from plants, micro-organisms, animals, the earth and the sea or any chemical substance that is found in nature and extracted using a process that does not change its chemical composition. Natural chemical products may include biologicals like enzymes as well naturally occurring inorganic or organic chemical products. Natural chemical products may be isolated and purified prior to their use or they can be used in unisolated and/or unpurified form. Chemical products may be synthetic chemical products. Synthetic chemical products may include chemical products produced with human interaction or intervention. Synthetic chemical products may be produced with the same chemical reactions occurring in nature or with different chemical reactions. Chemical products may be any inorganic or organic chemical product obtained by reacting inorganic and/or organic chemical reactants. The inorganic and organic chemical reactants may be natural chemical products or may be synthetic chemical products. Chemical reactions may include any chemical reaction commonly known in the state of the art in which the reactants are converted to one or more different chemical products. Chemical reactions may involve the use of catalysts, enzymes, bacteria, etc. to achieve the chemical reaction between the reactants. The chemical product may be produced from one or more input material(s) by a chemical production. The chemical product may include a raw material. The chemical product may include a chemical material produced by reacting at least two raw materials. The chemical product may include a component. The chemical product may include a component assembly. The chemical product may include an end product.

In an embodiment, physical entity may relate to the physical embodiment of the chemical product. The physical entity may be any chemical product in the chemical supply chain. The physical entity of the chemical product may be a raw material or basic substance, a chemical product, a chemical material, a chemical formulation, a chemical mixture, a component, a component assembly, an end product or a combination thereof.

In an embodiment, the data associated with the chemical product may be distributed across several data sources, called distributed data sources hereinafter. A distributed data source may be a collection of data stored at different sites of a computer network. Each site might expose a degree of autonomy, providing services for the execution of local applications, but also participating in the execution of a global application. For instance, a distributed data source may be a distributed database. A distributed database can be created by splitting and scattering the data of an existing database over different sites or by federating together multiple existing databases. Each data source may contain only a fragment of the data associated with the chemical product. This leads to a fragmentation of said data. Two common types of data fragmentation are horizontal fragmentation, wherein (possibly overlapping) subsets of data tuples are stored at different sites; and vertical fragmentation, wherein (possibly overlapping) subtuples of data tuples are stored at different sites. More generally, the data associated with the chemical product may be fragmented into a set of relations (tables of a relational database, distributed across multiple sites).

In an embodiment, the aspect model may contain a semantic description of the respective digital twin data set associated with the digital twin. The semantic description may include the structure of at least a portion of the digital twin data set, and/or properties of the digital twin data set. The properties of the digital twin data set may include data types. The properties of the digital twin data set may include possible or allowable values and/or value ranges. The properties of the digital twin data set may be a physical unit of parameter(s) described by values contained in the digital twin data set.

In an embodiment, a digital twin data set may correspond to the data structure obtained upon applying the respective aspect model to the gathered data associated with the physical entity of the chemical product. The digital twin data set may include values and/or value ranges defined in the aspect model used to generate the digital twin data set. Hence, each digital twin data set contains the data structure and data defined by the aspect model used for its generation. This ensures that each digital twin data set has a defined structure and contains defined data, thus allowing to simplify data exchange and processing of the exchanged data on chemical products. In an embodiment, a digital twin data set may be a data set suitable for representing at least part of the gathered data. The digital twin data set may represent at least part of the gathered data. The digital twin data set may comprise a subset of the gathered data. The digital twin data set may refer to a selection of data points within the gathered data.

In an embodiment, the decentral digital twin identifier and/or the decentral access element identifier may comprise any unique identifier uniquely associated with the digital twin and/or digital twin data set(s), and optionally the data owner. The decentral digital twin identifier and/or the decentral access element identifier may connect the physical entity of the chemical product to the digital twin. The decentral digital twin identifier and/or decentral access element identifier may include one or more Universally Unique Identifier(s) (UUID(s)) or Digital Identifier(s) (DID(s)). The one or more DID(s) and/or UUID(s) may be associated with the digital twin and/or the digital twin data set. The one or more DID(s) and/or UUID(s) may further be associated with the chemical product. The decentral digital twin identifier and/or the decentral access element identifier may be generated by the data owner or on behalf of the data owner of the digital twin data. The decentral digital twin identifier and/or the decentral access element identifier may include authentication information. Via the decentral digital twin identifier and/or the decentral passport identifier and its unique association with the digital twin (and hence with the chemical product) and optionally the data owner, access to the digital twin generated from said data or access to parts of the digital twin, such as digital twin data set(s) contained in the digital twin, may be controlled by the data owner. This contrasts with central authority schemes, where identifiers are provided by such central authority and access to data is controlled by such central authority. Decentral in this context refers to the usage of the decentral identifier(s) in implementations as controlled by the data owner. The decentral digital twin identifier and/or the decentral passport identifier may include or be associated with one or more identifier(s) used in the decentral network and allowing for data exchange via the decentral network. For instance, the decentral digital twin identifier and/or the decentral passport identifier may include or be associated with digital twin data set identifier(s) of digital twin data sets, such as UUID(s) of digital twin data set(s). Any combination of UUID(s) and DID(s) may be possible. For instance, the decentral digital twin identifier and/or the decentral passport identifier may be a DID while the digital twin data identifier(s) may be UUID(s). In another instance, the decentral digital twin identifier and/or the decentral passport identifier, and the digital twin data identifier(s) may be UUIDs. Data exchange may include discovery of the decentral identifier and optionally identifier(s) associated with said decentral identifier for participant nodes of the decentral network, authentication of participant nodes of the decentral network and/or authorization of data transfers via a peer-to-peer communication between participant nodes of the decentral network. The decentral identifier may be associated with any participant of the supply chain including raw chemical product supplier, intermediate chemical products manufacturer, intermediate part manufacturer, component manufacturer, component assembly manufacturer or end product manufacturer. The decentral identifier may be associated with a machine, a system, or a device used for producing the raw material, the basic substance, the chemical product, the intermediate product, the component, the component assembly or the end product, or a collection of such machine(s), device(s) and/or system(s).

In an embodiment, the chemical property may be a property of the chemical product that becomes evident during, or after, a chemical reaction. Hence, the chemical property may be any quality that can be established only by changing the chemical identity of the chemical product. Examples of chemical properties include heat of combustion, enthalpy of formation, toxicity, chemical stability in a given environment, flammability, oxidation state(s), ability to corrode, combustibility, acidity and basicity, chemical product composition, recyclate content used for producing or manufacturing the chemical product, bio-based content used for producing or manufacturing the chemical product, renewable content used for producing or manufacturing the chemical product and pH value.

In an embodiment, physical property may be any property that is measurable. Hence, the value of a physical property describes a state of the chemical product. Examples of physical properties include absorption, brittleness, boiling point, capacitance, color, concentration, density, ductility, distribution, efficacy, elasticity, electric charge, electrical conductivity, electrical impedance, electric potential, flow rate, fluidity, hardness, heat capacity, inductance, intrinsic impedance, luminance, luminescence, luster, mass, melting point, opacity, permeability, permittivity, plasticity, pressure, radiance, resistivity, reflectivity, refractive index, solubility, specific heat, strength, stiffness, temperature, tension, thermal conductivity, thermal resistance, viscosity, volume and wave impedance.

In an embodiment, the measured at least one physical and/or chemical property is obtained by sensors configured to measure the physical and/or chemical property. The sensor may be included in a measuring device. The sensor may correspond to the measuring device. For example, the physical and/or chemical property may include a property provided by sensors of a mobile device such as a camera, or measurement devices configured to measure at least one physical and/or chemical property.

In an embodiment, the data associated with the production of the chemical product is collected before, during and/or after production of the chemical product. The collected chemical product data may be used to determine at least one physical and/or chemical property of the produced chemical product. For instance, emission data of the chemical product may be determined based on chemical product data collected during production of the chemical product. Data associated with the production of the chemical product may include chemical production data from the production of the chemical product. Data associated with the production of the chemical product may include monitoring and/or control data associated with the production of the chemical product.

In an embodiment, data associated with the use of the chemical product is collected via at least one identifier associated with the chemical product. The data may be collected during and/or after use of the chemical product. Collected data may include at least one measured physical and/or chemical property of the used chemical product. The measured physical and/or chemical property may include the chemical and/or physical properties described previously. The data may be collected with a suitable sensor configured to measure the chemical and/or physical property. The sensor data may be interrelated with the identifier associated with the chemical product. The chemical and/or physical property determined from the sensor data may be interrelated with the identifier associated with the chemical product. The identifier may be the chemical product identifier. The identifier may be the decentral digital twin identifier. The decentral digital twin identifier may be linked to other decentral product identifier(s) according to a physical relation of the chemical product entity with other physical entities e.g. those produced using the chemical product or those produced from the chemical product. This way decentral participant node(s) of the decentral network may be able to interpret the relation of the decentral digital twin identifier corresponding to the physical relation of the physical chemical entity to other physical entities. The linking of the decentral digital twin identifier with other decentral product identifier(s) allows to determine the decentral participant node(s) storing the collected data associated with the use of the chemical product or the determined physical and/or chemical property. The collected data and/or the determined chemical and/or physical property may be provided by said decentral participant node(s) and may be stored within the digital twin. For instance, a new data set may be generated by applying an aspect model associated with the use of the chemical product and said new data set may be used to update the digital twin.

In an embodiment, the digital twin is generated by a decentral participant network node of a decentral network. The decentral participant node may be in communication with a decentral data providing network node providing access to the digital twin. The decentral participant node may be associated with a decentral data providing network node providing access to the digital twin. The decentral network may be a decentral peer-to-peer communication network. The decentral network may include participant network nodes associated with participants of the chemical supply chain and may be configured to perform data transactions. The decentral participant node may comprise a network node of the decentral network. The network nodes associated with participants of the chemical supply chain may be associated with raw chemical product supplier, intermediate chemical products manufacturer, intermediate part manufacturer, component manufacturer, component assembly manufacturer or end product manufacturer. The data transactions may be based on a transaction protocol including authentication and/or authorization mechanism(s). Based on the authentication and/or authorization mechanism(s) a peer-to-peer communication between decentral network nodes associated with participants of the chemical supply chain may be established. The one or more authentication mechanism(s) may be associated with or linked to the decentral identifier included in the digital twin and/or the digital access element. The one or more authentication mechanism(s) associated with the decentral identifier included in the digital twin and/or the digital access element may be accessible by the decentral data providing network node and/or the decentral data consuming network node. The decentral configuration allows for more efficient use of computing resources and strengthens control by the data owners of the decentral network.

In an embodiment, the decentral data providing network node and the one or more decentral data consuming network node(s) may be part of the decentral network. The decentral data consuming network node and the decentral data providing network node may be regarded as decentral participant node(s) of the decentral network.

The chemical product may be produced by a chemical production from one or more input material(s). The materials may include raw materials, intermediate chemical products or chemical products received from a supplier. The chemical production may be a chemical production network including multiple interlinked processing steps. The chemical production network may be an integrated chemical production network with interrelated production chains. The chemical production network may include multiple different production chains that have at least one intermediate product in common. The chemical production network may include multiple stages of the chemical value chain. The chemical production network may include multiple production chains that produce from one or more inbound material(s) as input chemical products as output. The chemical production network may include multiple tiers of a chemical value chain. The chemical production network may include a physically interconnected arrangement of production sites. The production sites may be at the same location or at different locations. In the latter case, the production sites may be interconnected by means of dedicated transportation systems such as pipelines, supply chain vehicles, like trucks, supply chain ships or other cargo transportation means. The chemical production may be controlled by an operating system. The operating system may be configured to perform the methods disclosed herein. The operating system may comprise the apparatuses and systems disclosed herein. The chemical product may comprise a physical identifier. The physical identifier may be present on the packaging of the produced chemical product. The physical identifier may be a code, such as a QR code or an embossed code, an NFT tag or the like. The physical identifier may be assigned to the decentral identifier of the digital twin to associate the generated digital twin and the chemical product data set(s) contained therein with the physical entity of the chemical product.

In an embodiment, the data related to the chemical product includes one or more chemical product identifiers associated with the chemical product. The one or more chemical product identifiers may include a batch number, a chemical product name, a chemical product ID, a part number, a LOT number or a combination thereof. The LOT number may be assigned to the chemical product on production. The chemical product identifier(s) allow to uniquely identify the physical entity of the respective chemical product, thus linking all data associated with said identifier(s) to the physical entity of the chemical product. In an embodiment, the data related to the at least one aspect model includes identifier(s) associated with the respective aspect model(s). The identifier(s) allow to uniquely identify the respective aspect model. The identifier may include an ID, a name, or a combination thereof.

In an embodiment, the data associated with the chemical product includes chemical product data. Chemical product data may comprise data related to the use of the chemical product, data related to the production of the chemical product, one or more chemical product identifiers, a chemical product name, a chemical product composition, measured and/or determined chemical and/or physical properties of the chemical product, emission data of the chemical product, recyclate content data of the chemical product, bio-based content data of the chemical product, renewable content data of the chemical product, chemical product production data, chemical product declaration data, chemical product safety data, certificate of analysis data associated with the chemical product, certificates associated with the chemical product or a combination thereof. Data related to the use of the chemical product may include data related to further processing of the chemical product, for example by using the chemical product as reactant in further chemical reaction(s) and/or data related to the use of the chemical product, for example data related to the use of the chemical product in a treatment process and/or within a manufacturing process. Data related to the production of the chemical product may comprise any data related to the production of the chemical product at any stage in the chemical supply chain. Said data may include chemical production data from the production of the chemical product. Production data may include monitoring and/or control data associated with the production of the chemical product. Production data may include measurement data related to a product quality at any stage in the chemical supply chain, preferably a chemical product. The at least one chemical product identifier may correspond to the chemical product identifier(s) contained in the received request. This may allow to identify the chemical product the gathered data is associated with.

Emission data may comprise any data related to environmental footprint. The environmental footprint may refer to an entity and its associated environmental footprint. The environmental footprint may be entity specific. For instance, the environmental footprint may relate to a product, a company, a process such as a manufacturing process, a raw material or basic substance, a chemical product or material, a component, a component assembly, an end product, combinations thereof or additional entity-specific relations. Emission data may include data relating to the carbon footprint of the chemical product or a Product Carbon Footprint (PCF). Emission data may include data relating to greenhouse gas emissions e.g. released in production of the chemical product. Emission data may include data related to greenhouse gas emissions. Greenhouse gas emissions may include emissions such as carbon dioxide (CO₂) emission, methane (CH₄) emission, nitrous oxide (N₂O) emission, hydrofluorocarbons (HFCs) emission, perfluorocarbons (PFCs) emission, sulfur hexafluoride (SF₆) emission, nitrogen trifluoride (NF₃) emission, combinations thereof and additional emissions. Emission data may include data related to greenhouse gas emissions of an entities or companies own operations (production, power plants and waste incineration). Scope 2 may comprise emissions from energy production which is sourced externally. Scope 3 may comprise all other emissions along the value chain. Specifically, this may include the greenhouse gas emissions of raw materials obtained from suppliers. Product Carbon Footprint (PCF) may sum up greenhouse gas emissions and removals from the consecutive and interlinked process steps related to a particular product. Cradle-to-gate PCF may sum up greenhouse gas emissions based on selected process steps: e.g. from the extraction of resources up to the factory gate where the product leaves the company. Such PCFs may be called partial PCFs. In order to achieve such summation, each company providing any products may provide the scope 1 and scope 2 contributions to the PCF for each of its products.

Recyclate content data, bio-based content data and renewable content data may comprise any data related to the recyclate content or the bio-based content or the renewable content used for producing or manufacturing a physical entity of the chemical product.

The chemical product data may be stored within one or more distributed data sources. The one or more distributed data sources may be associated with a chemical production producing the chemical product from one or more inbound materials. The chemical product data may include different classes of chemical product data. At least one class of chemical product data may include chemicals data e.g. data required by regulation or regulatory data for chemicals. Chemicals data may include chemical product declaration data, chemical product safety data and certificate of analysis data. At least one class of chemical product data may include emission data, recyclate content data, bio-based content data and/or production data associated with the physical entity of the chemical product. Each class may be associated with access rule(s). The access rule(s) for each class may differ from each other. This allows to define access to the digital twin on a more granular level, hence increasing the security and avoiding undesired access to a class containing more sensitive information, like the composition of the chemical product, by unauthorized decentral data consuming services.

In an embodiment, the data owner includes an entity generating the data associated with the chemical product and/or the data owner is the data owner of the data associated with the chemical product and/or of the digital twin data set(s). The data generating node may be coupled to the entity owning the physical entity of the chemical products from or for which data is generated. The data, in particular the chemical product data and/or the digital twin data set(s), may be generated by a third-party entity on behalf of the entity owning the physical entity of the chemical products from or for which data is generated. The data owner may be the chemical product producer. The data owner may hence directly or indirectly own the chemical product data and/or the digital twin data set(s). The chemical product data and/or the digital twin data set(s) may be stored in a data base of or associated with the data owner. The chemical product data and/or the digital twin data set(s) may be stored in a data base of or under control by the data owner. The chemical product data and/or the digital twin data set(s) may be stored in a data base accessible by the data owner. The data owner may control access to the chemical product data and/or the digital twin data set(s), for instance via a decentral data providing network node associated with the data owner. The chemical product data and/or the digital twin data set(s) may be associated with the data owner. The data owner may be the owner of the chemical product data or the chemical product data owner. The data owner may be the owner of the digital twin data set(s) or the digital twin data set(s) owner. In this sense, the data owner is to be construed broadly as the entity having access to the chemical product data and/or the digital twin data set(s) and controlling access by decentral data consuming network nodes of the decentral network to the chemical product data and/or the digital twin data set(s).

In an embodiment, gathering the data associated with the chemical product includes gathering said data from one or more distributed data sources containing data instances that relate to the chemical product. A data instance may relate to the aforementioned chemical product data. For instance, a data instance relating to the chemical product may include at least one measured physical and/or chemical property of the chemical product and/or at least one physical and/or chemical property determined from collected data associated with the production and/or the use of the chemical product. The distributed data sources may include master databases, operational databases, data warehouses, or other data sources that are used to store data associated with the chemical product. The use of distributed data sources to store data associated with the chemical product allows improved tunability, platform autonomy, fault tolerance, scalability, location transparency, site autonomy and enhanced security.

In an embodiment, gathering the data associated with the chemical product includes
providing one or more distributed data sources containing data associated with the chemical product, wherein at least one of the distributed data sources contains data instances that relate to said chemical product,
determining—based on the received data related to the chemical product—one or more chemical product identifiers associated with the chemical product,
gathering data associated with the chemical product from the provided distributed data sources(s) using the determined chemical product identifier(s).

Determining the one or more chemical product identifiers may include retrieving said identifiers from the received data related to the chemical product. For instance, the request may contain one or more chemical product identifiers, such as batch number(s), associated with the chemical product. Determining said identifiers may include retrieving said identifiers based on the received data related to the chemical product. For instance, the request may contain the name of the chemical product and the one or more chemical product identifiers may be retrieved from a database based on the received name.

Gathering the data associated with the chemical product may include retrieving said data based on the chemical product identifiers from the one or more distributed data sources and storing the retrieved data as a data set in a data storage, such as a database. The data may be retrieved via APIs connecting the data gathering unit with the respective distributed data sources. Gathering the data may include gathering said data from the one or more distributed data sources to a persistent or non-persistent log. This may include event-driven gathering of data in a non-persistent log based on distributed data updates. The gathered data may be provided from the persistent or non-persistent log as a data set to a downstream data collector, such as a database.

In an embodiment, the decentral identifier is provided by a central network node or by one or more decentral network nodes. The one central network node or the one or more decentral network nodes may be part of a decentral network comprising a plurality of decentral participant nodes. The decentral identifier as generated by one central network node or by one or more decentral network nodes may be provided to a decentral network node generating the digital twin and to at least one authentication data registry network node, preferably accessible by the decentral data providing network node and/or the decentral data consuming network node. This enables customized data sharing or exchange with respect to the chemical product and the chemical supply chain the chemical product is supplied to. In particular, the decentral data providing network node and/or the decentral data consuming network node may customize data sharing or exchange protocols based on the anchoring of the decentral identifier to the chemical product data set(s). The authentication data registry network node may be a central registry network node such as a central file system, a centrally managed distributed database, and/or a centrally managed peer-to-peer network. The central configuration allows for more control and standardization via a central network node. The authentication data registry network node may be a decentral registry such as a distributed ledger, a decentralized file system, a distributed database, and/or a peer-to-peer network. The decentral configuration allows for more efficient use of computing resources and strengthens control by the data owner. In addition, the decentral configuration is independent from centrally managed nodes and as such increases reliability and flexibility of the system.

In one embodiment, the decentral identifier is provided upon receiving a request to provide said decentral identifier. The request may include an owner or product identifier associated with the chemical product data owner or the chemical product, respectively. The request may be generated by a requestor and may be provided to a decentral identifier generator. The requestor may be associated with the chemical production, such as a chemical production network, producing the chemical product. The request may be triggered upon detecting a packaging unit of the produced chemical product. For instance, the packaging line may comprise a labelling device detecting each packaging unit. Based on such recognition, the requestor may generate and sent a request to provide the decentral identifier to a decentral identifier generator. The owner identifier may be a string identifier associated with a data owner name. The product identifier may be a batch number, a LOT number, a chemical product ID or a combination thereof. The owner or product identifier may be provided by a physical identifier provider, such as a bar code or a tag like a RFID tag, via a barcode or QR code. Such communication can also be completed via ad hoc WIFI, BLE beacon, and/or NFC. The communications may be performed via any available communication channels, including but not limited to, web servers, ad hoc WIFI, BLE beacon signal, NFC, a barcode or QR code scanning, etc. The owner or product identifier may be provided from an ERP system controlling the chemical production producing the chemical products. Through the owner identifier, the generated digital twin can be associated with the chemical product data owner by including the owner identifier. The owner identifier may be used for data transaction, such as sharing or exchanging chemical product data set(s). The owner identifier may be provided to a transaction manager. Providing the decentral identifier and the owner identifier of the data owner to a transaction manager or a data consuming service may simplify tracking of data transactions. Any transaction in the data ecosystem can e.g. be associated with the clear name of the data owner.

In an embodiment, the decentral digital twin identifier is associated with a physical entity of the chemical product. The decentral digital twin identifier may be associated with the physical entity of the chemical product the digital twin is generated for. The decentral digital twin identifier may be associated with the physical entity of the chemical product the generated chemical product data sets are associated with. The decentral digital twin identifier may be associated with the physical entity the chemical product will be supplied for and the gathered data/chemical product data sets is/are associated with. For instance, the decentral digital twin identifier may be associated with the physical entity of the component, the component assembly, the end product or the like. The decentral digital twin identifier may be associated with more than one physical entity the chemical product will be supplied for and the gathered data/chemical product data sets is/are associated with. For instance, the decentral digital twin identifier may be associated with the physical entity of the component, the component assembly and the end product. Associating the decentral digital twin identifier with different physical entity stages in the chemical supply chain allows for virtually tracking the supplied chemical product in the supply chain. This way the chemical product with its associated chemical product data sets may be tracked e.g. up to the end of life of the end product.

In one embodiment, the decentral digital twin identifier is or is assigned to a physical identifier connected to the chemical product. The connection of the physical identifier with the chemical product may be provided by means of physical connection to the physical product or physical entity. For instance, the physical identifier may be connected with the physical entity of the chemical product. The physical entity may be a raw material or an intermediate product. The physical identifier may have one-to-one correspondence to a virtual identity or to a physical identity by means of a physical connection to the physical entity. In an embodiment, the physical identifier is physically attached to the chemical product via an identifier element. Physical identifier or physical identifier element may refer to any virtual or physical arrangement that associates the decentral identifier with the chemical product. The physical identifier may be any identifier for the produced chemical product, such as a batch number or a part number. The physical identifier element may comprise a passive or active element, e.g. QR-code, RFID-tag, but is not limited thereto. The physical identifier element may be a physical identifier physically connected to the chemical product. The identifier element may include markers embedded in materials, a bar code, a QR-Code, a tag like a RFID tag or similar physical arrangement that allows to digitally identify the chemical product.

In one embodiment, an identifier element containing the physical identifier is physically attached to the chemical product. The physical identifier may be provided from a sensor reading a physical identifier element, wherein the physical identifier element is physically connected to the chemical product. The decentral identifier may be provided from a sensor reading a physical identifier element, wherein the physical identifier element is physically connected to the chemical product. The identification element may be physically connected to the chemical product, uniquely identifying the chemical product. The identification element may be physically connected to any component of the chemical product, e.g., the packaging of the chemical product, uniquely identifying a chemical product.

In an embodiment, at least one retrieved aspect model is related to environmental attribute(s) associated with chemical products. The chemical products may be chemical products produced by the chemical production producing the chemical product. The chemical products may be chemical products generally produced by the chemical industry. The environmental attribute(s) may relate to recyclate content of chemical products, renewable content of chemical products, bio-based content of chemical products, emission data associated with chemical products and/or certificates associated with chemical products. For instance, one aspect model may be related to a recyclate content associated with chemical products, e.g. that aspect model may contain the structure and properties of recyclate content data and chemical product data. Use of aspect model(s) related to environmental attribute(s) allows to generate digital twin data set(s) reflecting the respective environmental attribute(s) of the chemical product, hence allowing the sharing of said attributes in a secure and efficient manner via the generated digital twin. One aspect model may be related to exactly one environmental attribute. This may allow to achieve a higher level of granularity concerning the environmental attributes associated with the chemical product in the generated digital twin, thus allowing to request-for instance by a decentral data consuming network node-each environmental attribute separately (e.g. via its corresponding chemical product data set) without having to retrieve the complete digital twin or the complete digital twin data set containing more than one environmental attribute. One aspect model may be related to at least two different environmental attributes. This may allow to reduce the number of digital twin data set(s) that need to be generated.

In an embodiment, each digital twin data set is generated by applying the respective retrieved aspect model to the gathered data. The number of retrieved aspect models thus equals the number of digital twin data sets resulting from the application of the retrieved aspect models. For instance, if three different aspect models are retrieved and applied to the gathered data, three different digital twin data sets are generated. Each generated digital twin data set contains the data structure and the data defined by the respective aspect model used for its generation. Use of different aspect models allows a higher level of granularity with respect to the digital twin data set(s) contained in the digital twin. Hence, retrieval of data can be minimized by retrieving the respective digital twin data set instead of having to retrieve the complete digital twin including all relevant data. This reduces the amount of data that needs to be transferred in case the data contained in the digital twin is requested from a third party. Use of at least one aspect model ensures reliable data transfer and compliance with the respective decentralized data standard. The generated digital twin data set(s) may be stored on a data storage medium, such as a database. This may allow to retrieve the generated digital twin data set(s) and avoids the need to regenerate said digital twin data set(s). For instance, the generated digital twin data set(s) may be retrieved to generate a digital twin of the chemical product as described below.

In an embodiment, each digital twin data set is associated with the respective aspect model used to generate the digital twin data set. Each digital twin data set may include the aspect model identifier associated with the aspect model used to generate the respective digital twin data set. Each digital twin data set may be stored within a collection or partition associated with the respective aspect model used to generate the digital twin data set. For instance, each digital twin data set may be stored in a collection or partition associated with the aspect model used for its generation. This allows to easily identify the aspect models used to generate the respective digital twin data set and thus also the structure and data of the respective digital twin data set.

In an embodiment, the digital twin data set includes at least one chemical product identifier. The chemical product identifier(s) included in the digital twin data set may correspond to the chemical product identifier(s) included in the received request and/or may correspond to the chemical product identifier(s) included in the chemical product data. Use of at least one chemical product identifier within the chemical product data set allows to correlate said data set with the physical entity of the chemical product the chemical product identifier(s) are associated with.

In an embodiment, generating the digital twin includes assigning the decentral identifier to the at least part of the generated digital twin data set. The decentral identifier may be linked to each of the at least part of the digital twin data sets. If the decentral identifier contains digital twin data set identifiers, each digital twin data set identifier may be linked to a digital twin data set to be contained within the digital twin (e.g. each digital twin data set used for generation of the digital twin). Use of a combination of decentral digital twin identifier and digital twin data set identifier hence allows to retrieve the respective digital twin data set (e.g. a part of the generated digital twin), thus avoiding retrieval of the complete digital twin if only access to a specific digital twin data set of the digital twin is requested. Moreover, this allows to control the access to the digital twin more granular, because access may be controlled on the digital twin data set level. The decentral identifier may hence be used for sharing of the digital twin or a part thereof, e.g. digital twin set(s) contained within the digital twin, for example via a decentral data providing network node as described later on. The decentral digital twin identifier may be linked to the owner identifier associated with the data owner, in particular the data owner of the digital twin. This allows to identify the data owner associated with the digital twin and its corresponding digital twin data sets. Providing the decentral identifier and the owner identifier of the data owner to a transaction manager or a decentral data consuming network node may simplify tracking of data transactions as described previously.

In an embodiment, generating the digital twin includes assigning the decentral digital twin identifier to digital twin data set identifier(s), said digital twin data set identifier(s) being associated with digital twin data set(s) contained in the digital twin. Use of a combination of decentral digital twin identifier and digital twin data set identifier hence allows to retrieve the respective digital twin data set (e.g. a part of the generated digital twin), thus avoiding retrieval of the complete digital twin if only access to a specific digital twin data set of the digital twin is requested. Moreover, this allows to control the access to the digital twin more granular, because access may be controlled on the digital twin data set level.

In an embodiment, generating the digital twin includes generating access data and assigning the generated access data to the decentral digital twin identifier. Access data may include a digital representation pointing to the digital twin. Access data may include digital twin data set identifier(s), such as UUIDs. Access data may include digital representation(s) pointing to the digital twin data set(s). The digital representations may point directly or indirectly to the storage location of the digital twin/digital twin data set(s). The access data may be included in the digital twin. The access data assigned to the decentral digital twin identifier. The access data and interrelated decentral identifier may be stored on a data storage medium. The access data may be used-in combination with the decentral digital twin identifier-to access the digital twin or parts thereof. For instance, the digital twin data set identifier and corresponding access data may be used by a decentral data consuming network node to request the respective digital twin data set using the decentral digital twin identifier and associated access data, such as the digital twin data set identifier and digital representation pointing to said digital twin data set. Hence, generating the digital twin may include generation a DID document including the decentral digital twin identifier (e.g. DID) and the access data. The DID document or parts thereof may be propagated to a distributed ledger. The DID document or parts thereof may be used to retrieve the access data using the DID as described later on.

In an embodiment, the digital twin is generated via a user interface. This may include
providing a user interface configured to display data associated with physical entities of chemical products,
detecting a user input being indicative of selecting data associated with physical entities of chemical products, and
in response to the user input, generating the digital twin of the chemical product associated with the data selected by the user.

Data associated with physical entities of chemical products may include a name of the chemical product and/or chemical product identifier(s) associated with the chemical product. The user interface may be a graphical user interface. The user interface may contain a list of available data associated with the physical entities of chemical products. The user interface may contain a field allowing the user to enter at least part of the data associated with the physical entities of chemical products. The user interface may contain a search function allowing the user to search for specific chemical products based on key words.

The user input being indicative of selecting data may include selecting chemical product(s) from a displayed list of available chemical products. The user input being indicative of selecting data may include entering at least part of the data associated with the physical entities of chemical products and selecting data appearing on the user interface in response to the user input. The user input being indicative of selecting data may include selecting at least part of the data shown on the user interface in response to a search performed by the user.

The user input may trigger generation of a request to generate the digital twin, the request including data related to the chemical product and data related to at least one aspect model associated with chemical products. In response to the request, the digital twin may be generated as previously described.

In an embodiment, the digital twin is generated by the data owner of the data associated with the chemical product. The data owner of the data associated with the chemical product may be the chemical production producing the chemical product. The data owner of the data associated with the chemical product may be the legal entity operating the chemical production producing the chemical product. The data owner of the data associated with the chemical product may be the natural person operating the chemical production producing the chemical product. In an embodiment, the digital twin is generated on behalf of the data owner of the data associated with the chemical product. For instance, the digital twin may be generated by a third party based on a service provided by the third party to the data owner.

In an embodiment at least one digital twin data set contained in the digital twin includes the at least one measured physical and/or chemical property of the chemical product and/or the at least one physical and/or chemical property determined from collected data associated with the production and/or the use of the chemical product. The at least one measured physical and/or chemical property of the chemical product and/or the at least one physical and/or chemical property determined from collected data associated with the production and/or the use of the chemical product may correspond to the at least one measured physical and/or chemical property of the chemical product and/or at least one physical and/or chemical property determined from collected data associated with the production and/or the use of the chemical product included in the data associated with the chemical product.

In an embodiment, the digital twin includes at least two different measured and/or determined physical and/or chemical properties being present in different data sets. Data points within different data sets may overlap. The data sets may correspond to a data structure obtained upon applying an aspect model to gathered data associated with the physical entity of the chemical product as described previously. The data set may include values and/or value ranges defined in the aspect model used to generate the data set. Hence, each data set contains the data structure and data defined by the aspect model used for its generation. This ensures that each data set has a defined structure and contains defined data, thus allowing to simplify data exchange and processing of the exchanged data on chemical products.

In an embodiment, the digital twin further includes the aspect model identifier associated with each digital twin data set. This allows to determine the aspect model(s) used to generate the digital twin data set(s) contained in the digital twin. Hence, the data structure of the digital twin can be readily identified based on the aspect model identifiers contained in the digital twin.

In an embodiment, the digital twin further includes digital twin data set identifier(s) associated with the digital twin data set(s). The identifier(s) may include UUID(s), DID(s) or a combination thereof. The identifier(s) may be generated during or after generation of the digital twin. The identifier(s) may allow retrieval of the respective digital twin data set by the data providing service from the respective data storage as described in the following.

In an embodiment, the generated digital twin is stored in a data storage. The data storage may be a database associated with the data owner. Access to the database may be controlled by the data owner, for example via the decentral data providing network node associated with the data owner. The data storage may serve as an intermediate layer between the data gathering and the consumption of the digital twin, for example by a decentral data consuming network node. The division between data gathering and consumption of the generated digital twin or associated digital twin data set(s) may result in a high and stable availability of digital twin data set(s) within a decentralized network can be achieved.

In an embodiment, the method further includes a step of providing the generated digital twin or parts thereof (e.g. digital twin data set(s) contained in the digital twin) to a decentral data providing network node for access by a decentral data consuming network node. Access to the digital twin or parts thereof may be controlled by the decentral data providing network node. The decentral data providing network node may comprise computer-executable instructions for providing and/or processing data, such as chemical product data set(s), by a data consuming service. The decentral data providing network node may be connected to one or more dedicated data storage(s) storing the digital twin data set(s) referenced or contained in the digital twin. The dedicated data storage(s) may be under control of the data owner of the digital twin data set(s). The data owner may have access to the dedicated data storage(s).

The decentral data consuming network node may comprise computer-executable instructions for accessing and/or processing data within the decentral network, such as chemical product data set(s), provided by a decentral data providing network node. The decentral data consuming network node may be controlled or owned by or associated with a consumer or a user of the chemical product. The consumer may be any entity processing the chemical product. The consumer may be any entity operating a production configured to process the chemical product. Processing may include using the chemical product to produce further chemical products, component, assemblies or end products. The consumer may be a downstream participant of the chemical value chain the produced chemical product is associated with, e.g. the chemical product is used in. For instance, the consumer may be a discrete product processor, such as a discrete product producer or a participant of the recycling process of the discrete product. Discrete products may be finished products that are distinct items capable of being easily identifiable, for example by counting. Examples of discrete products include automobiles, airplanes, shoes, etc. A discrete product may be broken down at the end of its lifecycle so that its components can be recycled. The consumer may receive the chemical product from the entity producing the chemical product, such as a chemical product producer. Via the decentral data consuming network node, the consumer of the chemical product may access the digital twin or a part thereof associated with supplied chemical products, thus allowing to improve production or recycling by using the accessed data. For instance, the accessed data may be used to enhance the properties of the resulting further chemical product, component or discrete product or the overall production efficiency. In another instance, the accessed data associated with the supplied chemical product and may be used control the production involving the supplied chemical product. In yet another instance, the accessed data may be used to reliably determine the chemical composition of the components to be recycled, thus improving recycling efficiency by determining the correct recycling process, recycling parameters, recycling plant, etc.

The access to the digital twin or parts thereof may be controlled by the decentral data providing network node. The decentral data providing network node may be associated with the data owner of the digital twin data set(s). The decentral data providing network node may be associated with the data owner of the digital twin. Access to the digital twin or parts thereof may hence be under control of the data owner associated with the decentral data providing network node. This allows to retain full control over access to the digital twin or parts thereof by the data owner but at the same time enabling sharing of the digital twin or parts thereof under controlled conditions, for example by using appropriate authorization and authentication mechanisms or schemes.

Providing the generated digital twin to the decentral data providing network node may include:
providing access data associated with the generated digital twin, and
providing the access data and the decentral digital twin identifier included in the generated digital twin to the decentral data providing network node.

The access data associated with the generated digital twin may include a digital representation pointing to the generated digital twin. The digital representation pointing to the digital twin may comprise at least one interface to a decentral data providing network node. It may further include at least one interface to a decentral data consuming network node. It may include an endpoint for data exchange or sharing (resource endpoint) or an endpoint for service interaction (service Endpoint), that is uniquely identified via a communication protocol. The digital representation(s) pointing to the digital twin may hence be uniquely associated with the decentral identifier. The digital representation(s) pointing to the digital twin may be regarded as locator(s) indication the location or dedicated data storage(s) where the respective digital twin is stored.

The access data associated with the digital twin may include a digital twin data set identifier and a digital representation pointing to the respective digital twin data set. The digital twin data set identifier may be one or more Universally Unique Identifier(s) (UUID(s)). The digital representation pointing to the at least one digital twin data set may comprise at least one interface to a decentral data consuming network node. It may further include at least one interface to a decentral data consuming network node. It may include an endpoint for data exchange or sharing (resource endpoint) or an endpoint for service interaction (service Endpoint), that is uniquely identified via a communication protocol. The digital representation(s) pointing to the at least one digital twin data set may hence be uniquely associated with the decentral identifier and the digital twin data set identifier. The digital representation(s) pointing to the at least one digital twin data set may be regarded as locator(s) indicating the location or dedicated data storage(s) where the respective digital twin data set is stored.

Providing the access data and the decentral identifier to the decentral data providing network node may include sending a POST request containing the aforementioned data as payload to the decentral data providing network node, for example via a respective API. The decentral data providing network node may store the received data in a database associated with the decentral data providing network node. Providing the access data and decentral digital twin identifier to the decentral data providing network node allows the decentral data providing network node to retrieve the respective digital twin using the access data from one or more downstream databases upon receiving a request for said data from a decentral data consuming network node. This allows to store the digital twin separately from the decentral data providing network node, thus ensuring a higher level of security since appropriate authentication and authorization schemes can be implemented for communications between the downstream database(s) and the decentral data providing network node. Moreover, only minimum amount of data is stored in the database associated with the decentral data providing network node, hence reducing the risk of unwanted data leakage in case the contents of the database of the decentral data providing network node are accessed unauthorized.

In an embodiment of the method for generating a digital access element, the digital access element comprises a decentral access element identifier and access data. The digital access element may represent a DID document associated with the decentral identifier, such as a Decentralized Identifier (DID). The DID document may be generated upon generation of the DID. The DID document may be generated after generation of the DID, for example upon generation of the digital twin. The DID document may contain the DID, further identifiers associated with the DID, such as chemical product data set identifiers, and access data. The access data may refer to any data for accessing the digital twin or parts thereof, such as chemical product data set(s) contained in the digital twin. The access data may be indispensable, i.e. strictly necessary for accessing the chemical product data set(s). Alternatively, the access data may be suitable for accessing the chemical product data set(s), while the chemical product data set(s) could also be accessed in different ways, without the access data based on which the digital access element is generated. Access data may include an endpoint for data exchange or sharing (resource endpoint) or an endpoint for service interaction (service endpoint), that is uniquely identified via a communication protocol. Access data may include authorization schemes and/or cryptographic information. For instance, the access data may include a public key, such as a public key needed for decrypting the chemical product data set(s). Access data may include authentication schemes associated with the decentral identifier. The access data may be uniquely associated with the decentral identifier. The access data may be provided to the data consuming service. The access data may be provided by a decentral network database, a database associated with the data consuming service, the data providing service associated with the data owner or combinations thereof. Use of access data within the digital access element allows the data owner to retain the control over the digital twin because appropriate authorization and authentication is required to access the data contained in said set(s). This allows to openly share the contents of the digital access element, for example on public web platforms, without having to disclose the digital twin or parts thereof associated with the digital access element via the decentral identifier. Thus, transparency about existing digital access elements can be provided while at the same time ensuring the required level of confidentiality of the data contained in the digital twins associated with said digital access elements.

In an embodiment of the method for generating a digital access element associated with a digital twin of a chemical product, access data includes a digital representation pointing to at least one of the digital twin data sets associated with the digital twin. The access data may further include digital twin data set identifier(s) associated with digital twin data set(s) contained in the digital twin. The digital twin data set identifier may be one or more Universally Unique Identifier(s) (UUID(s)) or one or more Decentralized Identifier(s) (DID(s)). The digital twin data set identifier(s) may be requested from an ID generator prior to providing the generated digital twin to the decentral data providing network node. The digital twin data set identifier(s) may be retrieved from the digital twin. The digital twin data set identifier(s) may be retrieved from a digital access element, such as a DID document, generated upon generating the digital twin as described below. The digital representation may indirectly relate to a database storing the digital twin data set(s) and being associated with or accessible by the data owner associated with the digital twin data set(s). This may enhance security. The digital representation pointing to the at least one digital twin data set may include an endpoint for data exchange or sharing (resource endpoint) or an endpoint for service interaction (service Endpoint), that is uniquely identified via a communication protocol as previously described. The digital representation(s) pointing to the at least one digital twin data set may hence be uniquely associated with the decentral identifier. The digital representation(s) pointing to the at least one digital twin data set may be regarded as locator(s) indication the location or dedicated data storage(s) where the respective digital twin data set is stored.

In an embodiment of the method for generating a digital access element associated with a digital twin of a chemical product, the request to provide the decentral access element identifier associated with the digital twin may include a product identifier and/or an owner identifier and/or access data as previously described. The request may be generated by a requestor as previously described.

In an embodiment of the method for generating a digital access element associated with a digital twin of a chemical product, providing the decentral access element identifier may include retrieving the decentral digital twin identifier contained in the digital twin and providing the retrieved decentral digital twin identifier. This may allow to avoid generation of a further decentral identifier and linking of said further decentral identifier with the decentral digital twin identifier contained in the digital twin. For instance, the DID or UUID contained in the digital twin may be retrieved and may be provided as decentral access element identifier.

In another embodiment of the method for generating a digital access element associated with a digital twin of a chemical product, providing the decentral access element identifier may include generating a further decentral identifier and providing the generated further decentral identifier. In this case, the request may be received at a decentral ID generator which may generate the further decentral identifier in response to the request. The generated further decentral identifier may be provided to a decentral identifier provider. The decentral identifier provider may provide the further decentral identifier to an assignor configured to assign the further decentral identifier to a physical identifier associated with the chemical product, for example by generating a code having embedded the decentral identifier. This allows to link the digital access element to the chemical product. The assignor may also be configured to link the received further decentral identifier to the decentral digital twin identifier contained in the digital twin. The decentral identifier provider may provide the further decentral identifier to a digital access element generator configured to generate the digital access element including the received further decentral identifier and access data. The further decentral identifier may be a DID as previously described. Use of a further decentral identifier-apart from the decentral identifier of the digital twin-allows to use different access schemes associated with different decentral identifiers. For instance, the decentral digital twin identifier included in the digital twin may be a UUID and the further decentral identifier requested upon generation of the digital access element may be a DID. Use of a DID allows to obtain the digital representation pointing to the digital twin data set(s) of the digital twin as well as the chemical product data set identifier(s) via a DID document associated with the DID. Hence, only the DID needs to be provided to the chemical product consumer since the DID allows retrieval of the associated DID document. The chemical product consumer may then retrieve the associated DID document and may determine the digital representations and digital twin data set identifier(s). The respective digital twin set(s) associated with the DID may be accessed via a decentral data consuming network node using the DID, the digital twin data set identifier(s) as well as the respective digital representations contained in the DID document. Use of different access schemes may improve the security with respect to the access to the chemical product data set(s) contained in the digital twin.

In an embodiment of the method for generating a digital access element associated with a digital twin of a chemical product, the digital access element is generated for each digital twin data set included in the digital twin. This allows a finer granularity with respect to access to the data, such as digital twin data set(s), contained in the digital twin and avoids retrieval of the complete data of the digital twin each time only part of the digital twin, such as one or more digital twin data set(s), is to be provided via the data providing service.

Use of the digital access element allows to separate external endpoint addresses, e.g. endpoint addresses associated with the decentral data providing network node, from internal endpoint addresses, e.g. endpoint addresses associated with database(s) storing the digital twins of chemical products. This allows to improve data security and avoids unwanted data access to internal endpoints since only external endpoints, the decentral identifier and digital twin data set identifier(s) are provided to external parties, such as data consuming services. Hence, use of the digital access element allows to share digital twins of chemical products or parts of such digital twins in a decentral network in a secure and reliable manner under the control of the data owner of the digital twin.

### BRIEF DESCRIPTION OF THE SEVERAL VIEWS OF THE DRAWINGS

In the following, the present disclosure is further described with reference to the enclosed figures. The same reference numbers in the drawings and this disclosure are intended to refer to the same or like elements, components, and/or parts.

FIG. 1A to FIG. 1C illustrate example embodiments of a centralized computing environment (FIG. 1A), a decentralized computing environment (FIG. 1B) and a distributed computing environment (FIG. 1C).

FIG. 2A illustrates an example of a chemical production controlled by an operating system comprising an apparatus to generate digital twins and optionally an apparatus to generate chemical product passports.

FIG. 2B illustrates an example of a chemical production controlled by an operating system to provide a chemical product associated with a digital twin.

FIG. 2C illustrates another example of a chemical production controlled by an operating system to provide a chemical product associated with a digital twin.

FIG. 3 illustrates an example of a production system providing a chemical product associated with a one or more digital twin(s).

FIG. 4A illustrates an example apparatus for generating a digital twin of a physical entity of a chemical product.

FIG. 4B illustrates an example of a layered system for generating a digital twin of a physical entity of a chemical product.

FIG. 5 illustrates an example system and associated methods for generating a digital twin associated with a chemical product produced by a chemical production and providing access to the generated digital twin.

FIG. 6 illustrates an example of a method for generating a digital twin of a physical entity of a chemical product using at least two different aspect models.

FIG. 7 illustrates a flow chart of a method for generating a digital twin of a physical entity of a chemical product in accordance with an example embodiment of the present disclosure.

FIG. 8 illustrates a flow chart of a method for generating a digital access element associated with a digital twin of a chemical product in accordance with an example embodiment of the present disclosure.

FIG. 9 illustrates an example of an apparatus and associated methods for generating a digital access element associated with a digital twin of a chemical product produced by a chemical production.

FIG. 10 illustrates an example of a digital access element including DID owner data, DID document data and decentral identity infrastructure.

FIG. 11 illustrates an example of a digital access element including certificate-based data, ID-based chemical product passport data and decentral identity infrastructure.

FIG. 12A illustrates a first example of a linkage between a digital twin, associated digital twin data sets and a digital access element via the decentral digital twin identifier.

FIG. 12B illustrates a second example of a linkage between a digital twin, associated digital twin data set and digital access elements via the decentral digital twin identifier.

FIG. 13 shows a schematic illustration of providing access via a decentral data providing network node associated with a data owner to a digital twin or a part thereof associated with a chemical product using a decentral data consuming network node associated with data user.

FIGS. 14A, 14B illustrate examples of authentication protocols between a decentral data consuming network node and a decentral data providing network node.

### DETAILED DESCRIPTION

The following embodiments are mere examples for implementing the methods, apparatuses, systems, digital twins or chemical product passports disclosed herein and shall not be considered limiting.

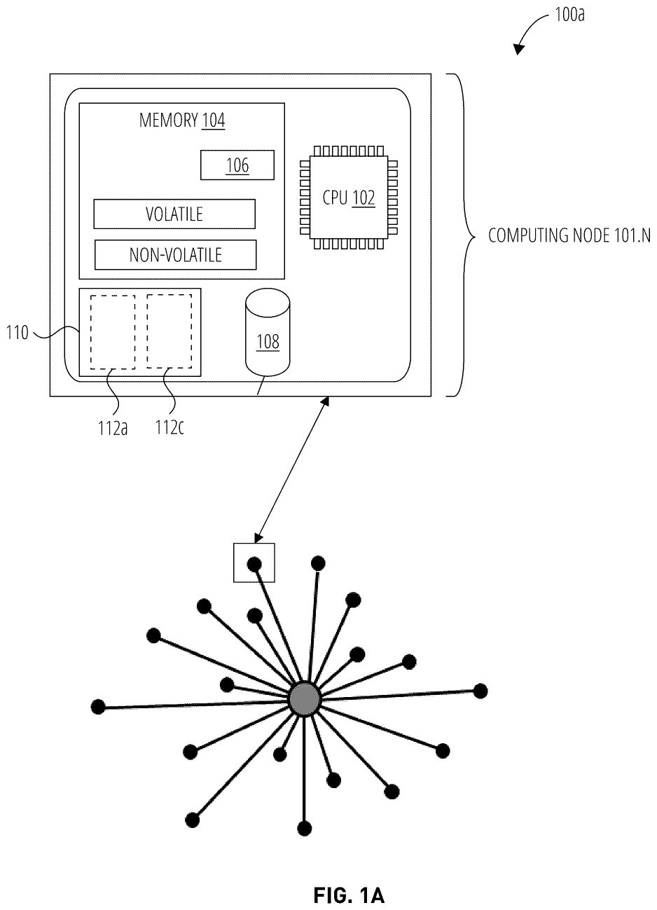

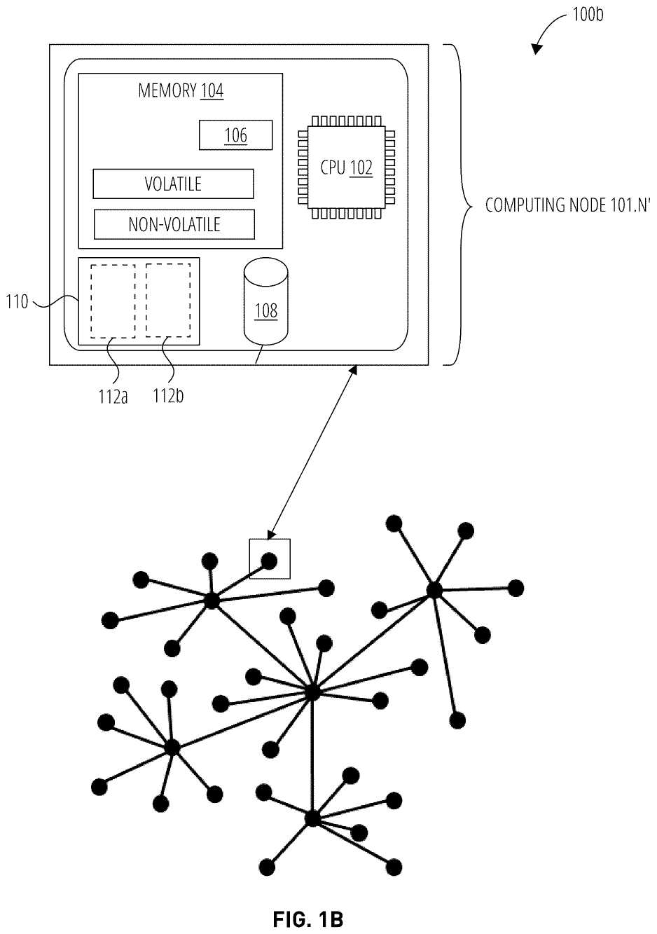

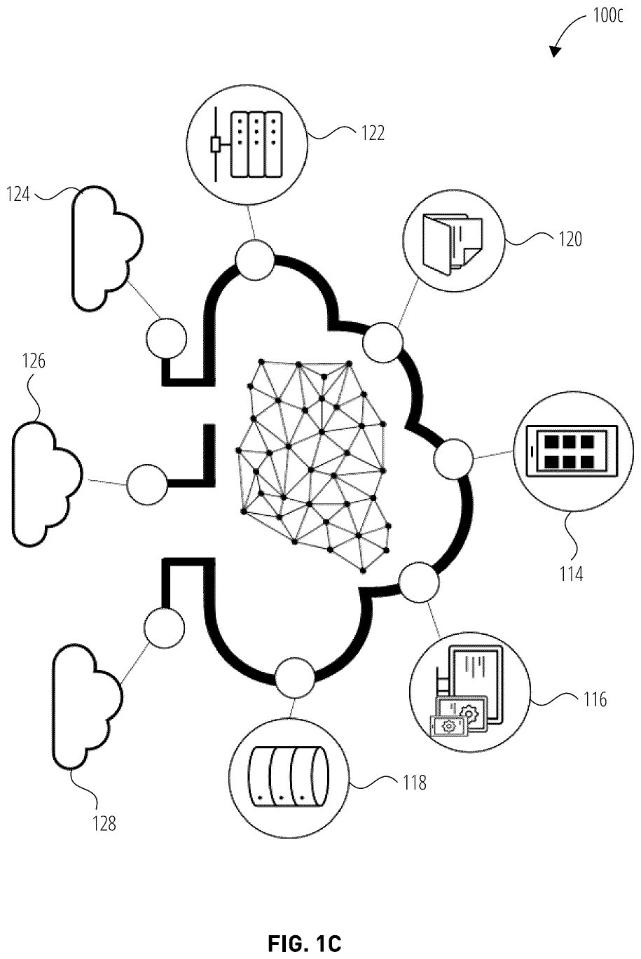

FIG. 1A to FIG. 1C illustrate different computing environments, central, decentral and distributed. The methods, apparatuses, systems, digital twins, chemical product passports, uses, computer elements of this disclosure may be implemented in decentral or at least partially decentral computing environments. In particular, for data sharing or exchange in ecosystems of multiple players different challenges exist. Data sovereignty may be viewed as a core challenge. It can be defined as a natural person's or corporate entity's capability of being entirely self-determined with regard to its data. To enable this particular capability related aspects, including requirements for secure and trusted data exchange in business ecosystems, may be implemented across the chemical value chain. In particular, chemical industry requires tailored solutions to deliver chemical products in a more sustainable way by using digital ecosystems.

FIG. 1A illustrates an example embodiment of a centralized computing system 100a comprising a central computing node (filled circle in the middle) and several peripheral computing nodes 101.1 to 101.N (denoted as filled circles in the periphery). The computing system may include one or more computing nodes, a system of nodes or combinations thereof.

In this example, the peripheral computing nodes 101.1 to 101.N may be connected to one central computing system (or server). In another example, the peripheral computing nodes 101.1 to 101.N may be attached to the central computing node via e.g. a terminal server (not shown). The majority of functions may be carried out by or obtained from the central computing node (also called remote centralized location). One peripheral computing node 101.N has been expanded to provide an overview of the components present in the peripheral computing node. The central computing node may comprise the same components as described in relation to the peripheral computing node 101.N. Each computing node 101, 101.1 to 101.N may include at least one hardware processor 102 and memory 104.

The computing nodes 101, 101.1 . . . 101.N may include program code which is schematically represented as a plurality of structures 106. The multiple structures 106 may be referred to as an executable component, executable instructions, computer-executable instructions or instructions. Executable component or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 101, 101.1 . . . 101.N, whether such an executable component exists in the heap of a computing node 101, 101.1 . . . 101.N, or whether the executable component exists on computer-readable storage media. In such a case, one of ordinary skill in the art will recognize that the structure of the executable component exists on a computer-readable medium such that, when interpreted by one or more processors of a computing node 101, 101.1 . . . 101.N (e.g. by a processor thread), the computing node 101, 101.1 . . . 101.N is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing. Examples of executable components implemented in hardware include hardcoded or hard-wired logic gates, which are implemented exclusively or near-exclusively in hardware, such as within a field-programmable gate array (FPGA), an application-specific integrated circuit (ASIC), or any other specialized circuit. In this description, the words component, agent, manager, service, engine, module, virtual machine or the like are used synonymous with executable component. The processor 102 of each computing node 101, 101.1 . . . 101.N may direct the operation of each computing node 101, 101.1 . . . 101.N in response to having executed computer-executable instructions that constitute an executable component. For example, such computer-executable instructions may be embodied on one or more computer-readable media that form a computer program product. The computer-executable instructions may be stored in the memory 104 of each computing node 101, 101.1 . . . 101.N. Computer-executable instructions comprise, for example, instructions and data which, when executed at a processor 101, cause a general purpose computing node 101, 101.1 . . . 101.N, special purpose computing node 101, 101.1 . . . 101.N, or special purpose processing device to perform a certain function or group of functions. Alternatively, or in addition, the computer-executable instructions may configure the computing node 101, 101.1 . . . 101.N to perform a certain function or group of functions. The computer executable instructions may be, for example, binaries or even instructions that undergo some translation (such as compilation) before direct execution by the processors, such as intermediate format instructions such as assembly language, or even source code.

Each computing node 101, 101.1 . . . 101.N may contain communication channels 108 that allow each computing node 101.1 . . . 101.N to communicate with the central computing node 101, for example, a network enabling the transport of electronic data between computing nodes 101, 101.1 . . . 101.N and/or modules and/or other electronic devices. When information is transferred or provided over a network or another communications connection (either hardwired, wireless, or a combination of hardwired or wireless) to a computing node 101, 101.1 . . . 101.N, the computing node 101, 101.1 . . . 101.N may view the connection as a transmission medium. Transmission media can include the network and/or data links which can be used to carry desired program code means in the form of computer-executable instructions or data structures and which can be accessed by a general-purpose or special-purpose computing nodes 101, 101.1 . . . 101.N. Combinations of the above may also be included within the scope of computer-readable media.

The computing node(s) 101, 101.1 to 101.N may further comprise a user interface system 110 for use in interfacing with a user. The user interface system 110 may include output mechanisms 110A as well as input mechanisms 110B. The principles described herein are not limited to the precise output mechanisms 110A or input mechanisms 110B as such will depend on the nature of the device. However, output mechanisms 110A might include, for instance, displays, speakers, displays, tactile output, holograms and so forth. Examples of input mechanisms 110B might include, for instance, microphones, touchscreens, holograms, cameras, keyboards, mouse or other pointer input, sensors of any type, and so forth.

FIG. 1B illustrates an example embodiment of a decentralized computing environment 100b with several computing nodes 101.1′ to 101.N′ denoted as filled circles. In contrast to the centralized computing environment 100a illustrated in FIG. 1A, the computing nodes 101.1′ to 101.N′ of the decentralized computing environment are not connected to a central computing node and are thus not under control of a central computing node. Instead, resources, both hardware and software, may be allocated to each individual computing node 101.1′ . . . 101.N′ (local or remote computing system) and data may be distributed among various computing nodes 101.1′ . . . 101.N′ to perform the tasks. Thus, in a decentral system environment, program modules may be located in both local and remote memory storage devices. One computing node 101.N′ has been expanded to provide an overview of the components present in the computing node 101.N′. In this example, the computing node 101.N′ comprises the same components as described in relation to FIG. 1A.

FIG. 1C illustrates an example embodiment of a distributed computing environment 100c. In this example, the distributed cloud computing environment 100c may contain the following computing resources: mobile device(s) 114, applications 116, databases 118, data storage 120 and server(s) 122. The cloud computing environment 100c may be deployed as public cloud 124, private cloud 126 or hybrid cloud 128. A private cloud 126 may be owned by an organization and only the members of the organization with proper access can use the private cloud 126, rendering the data in the private cloud at least confidential. In contrast, data stored in a public cloud 124 may be open to anyone over the internet. The hybrid cloud 128 may be a combination of both private and public clouds 124, 126 and may allow to keep some of the data confidential while other data may be publicly available.

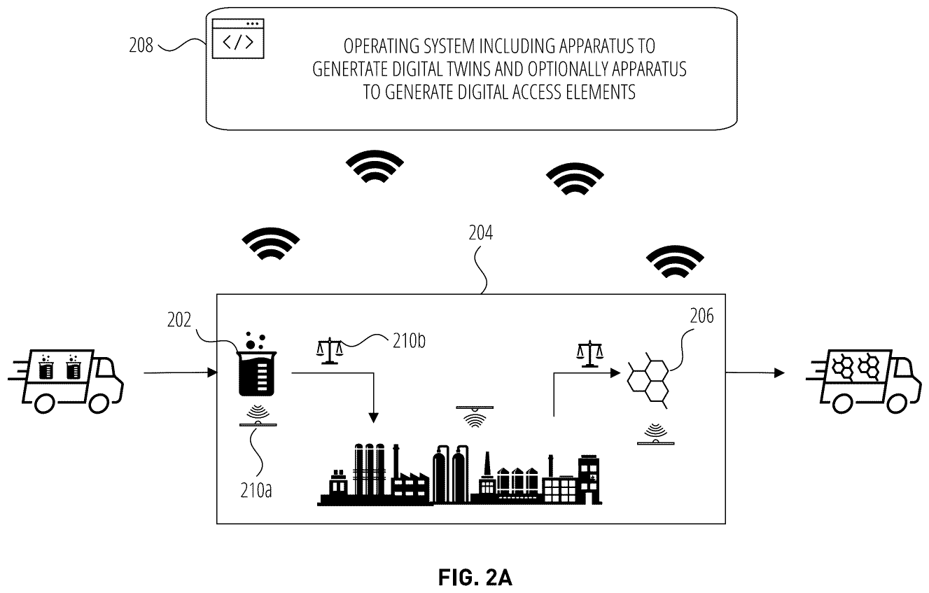

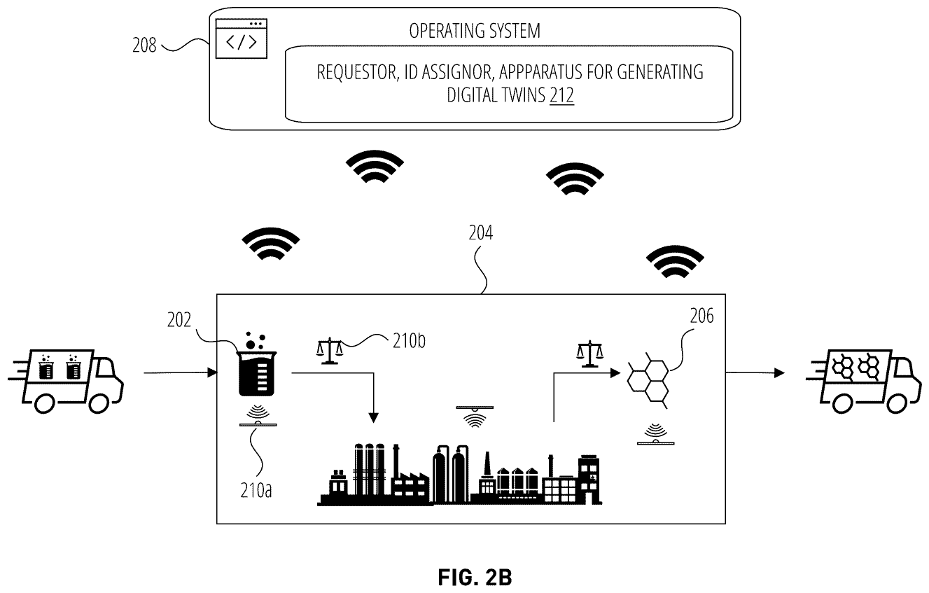

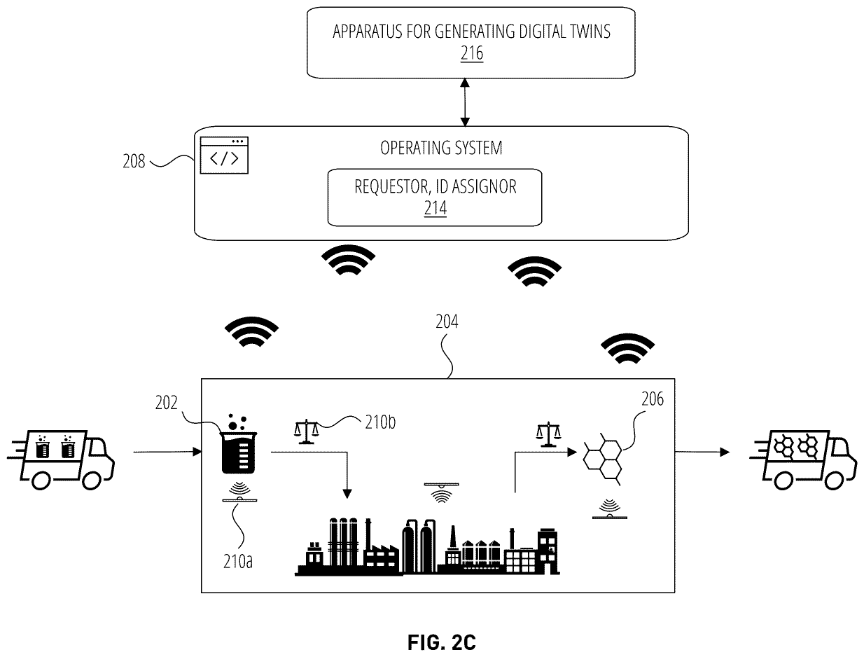

FIG. 2A illustrates an example of a chemical production 204 producing one or more chemical products(s) from one or more inbound material(s) 202 in connection with an operating system 208 including a digital twin management system. The operating system 208 may be used to operate the chemical production 204, for example by managing different production chains present within the chemical production. For producing one or more chemical product(s) 206, different chemical materials 202 (also called inbound material 202 hereinafter) may be provided as physical inputs from material providers or suppliers. The physical inputs to the chemical production 204 may include chemical materials, such raw materials, intermediate materials or a combination thereof. Raw materials may be virgin or recycled raw materials. The inbound material 202 may be fed into the chemical production 204 at any entry point. The inbound material 202 may be fed into the chemical production 204 at the start of the chemical production 204. The inbound materials may be considered input for the chemical production 204.

The chemical production 204 may be a chemical production network including multiple interlinked processing steps. The chemical production network may be an integrated chemical production network with interrelated production chains. The chemical production network may include multiple different production chains that have at least one intermediate product in common. The chemical production network may include multiple stages of the chemical value chain. The chemical production network may include multiple production chains that produce from one or more inbound material(s) as input chemical products as output. The chemical production network may include multiple tiers of a chemical value chain. The chemical production network may include a physically interconnected arrangement of production sites. The production sites may be at the same location or at different locations. In the latter case, the production sites may be interconnected by means of dedicated transportation systems such as pipelines, supply chain vehicles, like trucks, supply chain ships or other cargo transportation means.

The chemical production 204 may include multiple production steps. The production steps included in the chemical production 204 may be defined by the system boundary of the chemical production 204. The system boundary may be defined by location or control over production processes. The system boundary may be defined by the site of the chemical production 204. The system boundary may be defined by production processes controlled by one entity or multiple entities jointly. The system boundary may be defined by value chain with staggered production processes to an end product, which may be controlled by multiple entities separately.

The chemical production 204 may convert inbound material 202 to one or more chemical products 206 that exit the chemical production 204. The conversion may be performed via intermediate chemical products. The conversion may be a chemical reaction or any other processing step, such as physical processing. The chemical reaction may result in a mixture of different chemical product(s) since the yield of the chemical reaction may be less than 100%. Hence, a chemical reaction of one or more starting materials, such as inbound material(s) 202, may result in a mixture of different chemical product(s). Chemical reactions may therefore be characterized by a one-to-many or many-to-many relationship between starting materials and resulting reaction productions. This is in contrast to discrete manufacturing, where a many-to-one relationship between parts/components and assemblies is existing, e.g. the result of a discrete manufacturing step is a concrete and predictable assembly. Since the yield of a chemical reaction is not 100%, the amount of desired chemical product 206 (e.g. chemical product(s) to be supplied to upstream participants of the chemical ecosystem) is less than the theoretical amount of said chemical product calculated from the amount of starting materials. Such mixtures typically require separation of the different chemical products contained in said mixture. This allows to avoid a negative influence of impurities and unreacted inbound material(s) 202 on the further processing of the chemical product 206. Separation may include distillation, washing, extraction, crystallization and recrystallization. The resulting mixture may contain unreacted starting material, such as unreacted inbound material 202. Unreacted starting material may be reintroduced into the chemical reaction to reduce the amount of required starting material. The resulting mixture may contain desired chemical product(s) 206 to be supplied to upstream participants of the chemical ecosystem, such as chemical product consumers or chemical product processors. The resulting mixture may contain intermediate chemical product(s) used as input material in further chemical reactions performed within the chemical production 204. This allows to reduce the amount of waste associated with the disposal of said intermediate chemical products and/or the amount of energy associated with transportation of these intermediate products to another chemical production. The resulting mixture may contain waste chemical product(s), e.g. chemical product(s) which cannot be used any further and which need to be disposed, for example by burning. Waste chemical products may be produced from undesired chemical side reactions.

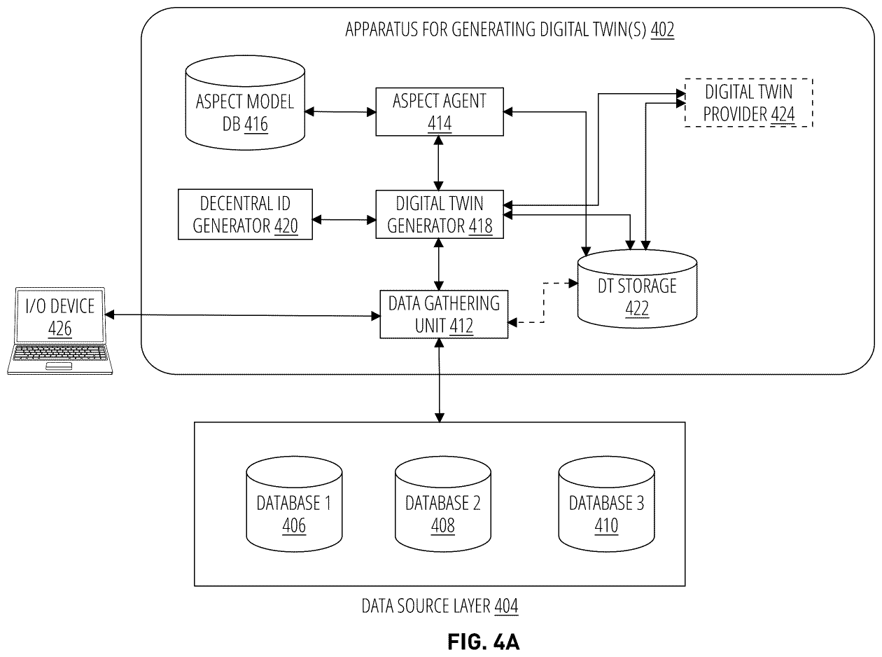

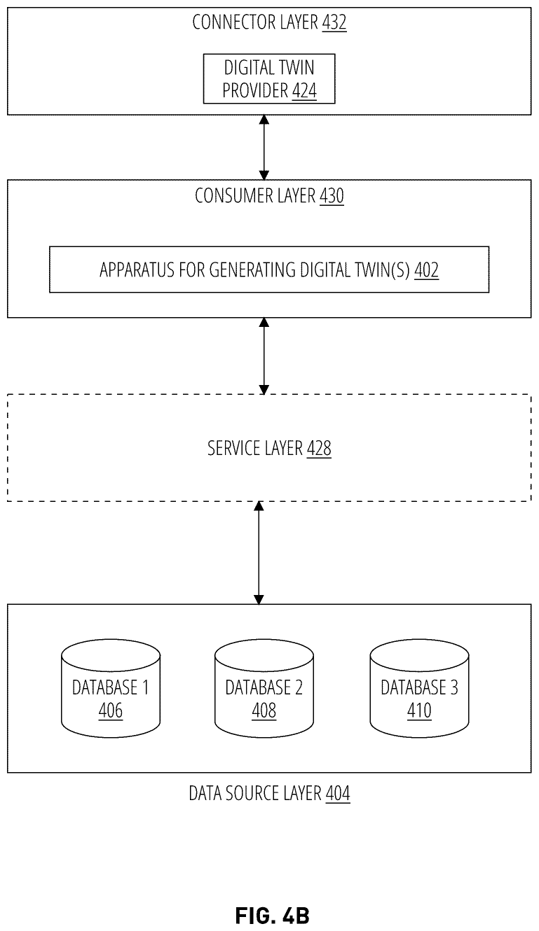

The chemical production 204 may comprise a plurality of sensors 210a, 210b. The sensors 210a, 210b may measure at least one chemical and/or physical property of the chemical product(s) 206 produced by the chemical production 204. The sensors 210a, 210b may measure at least one chemical and/or physical property of the inbound material(s) 202 provided to the chemical production 204. The sensors 210a, 210b may include sensors 2010b configured to determine the amount of inbound material(s) 202 and/or produced chemical product(s). Examples of such sensors may include scales or flow meters. The sensors 210a, 210b may include sensors 210a configured to measure at least one chemical and/or physical property of the inbound material(s) 202. Measurement of chemical and/or physical properties of the inbound material(s) 202 allows to control production processes based on the measured data. The sensors 210a, 210b may include sensors 210a configured to determine chemical and/or physical properties of the produced chemical product 206. Sensors 210a configured to measure chemical properties may measure data associated with or corresponding to the heat of combustion, enthalpy of formation, toxicity, chemical stability in a given environment, flammability, oxidation state(s), ability to corrode, combustibility, acidity and basicity and pH value. Sensors 210a configured to measure physical properties may measure data associated with or corresponding to absorption, brittleness, boiling point, capacitance, color, concentration, density, ductility, distribution, efficacy, elasticity, electric charge, electrical conductivity, electrical impedance, electric potential, flow rate, fluidity, hardness, heat capacity, inductance, intrinsic impedance, luminance, luminescence, luster, mass, melting point, opacity, permeability, permittivity, plasticity, pressure, radiance, resistivity, reflectivity, refractive index, solubility, specific heat, strength, stiffness, temperature, tension, thermal conductivity, thermal resistance, viscosity, volume and wave impedance. Data measured by sensors 210a, 210b may be stored in one or more databases, for example databases contained in data source layer 420 of FIG. 4B. The one or more databases may be distributed databases. The stored data may be interrelated with input material identifier(s) and/or chemical product identifier(s), respectively.

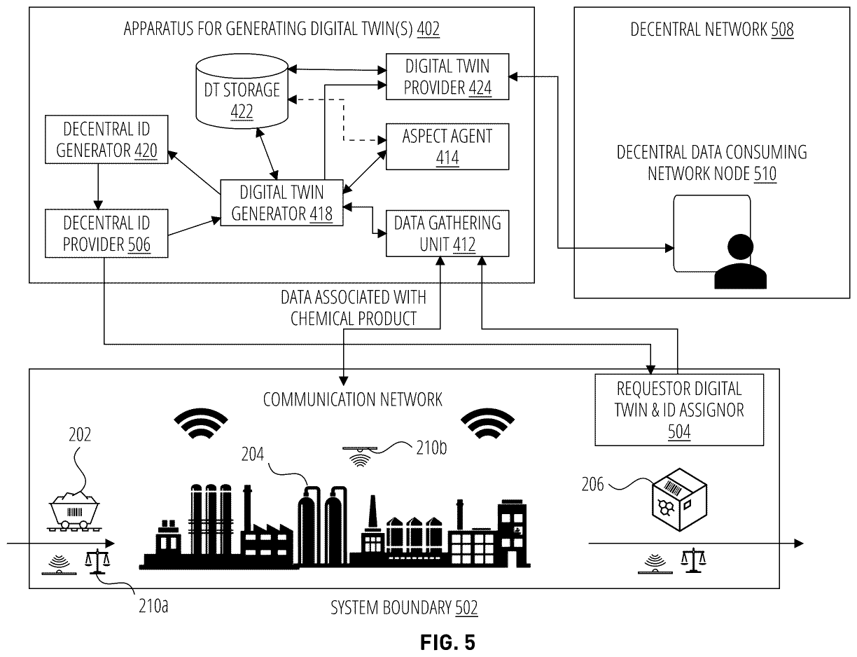

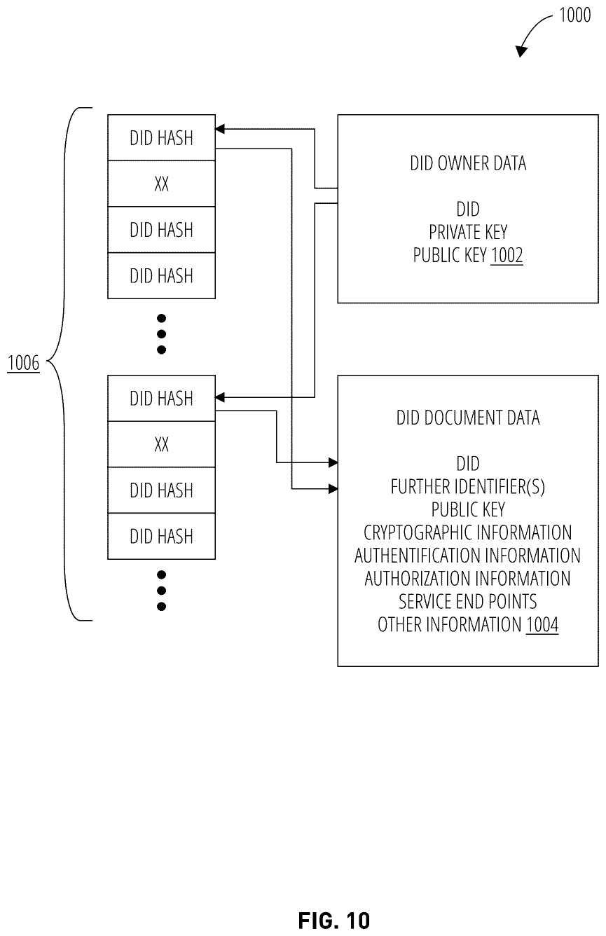

The operating system 208 of the chemical production may monitor and/or control the chemical production 204 based on operating parameters associated with the different processes performed by the chemical production 204. One process step monitored and/or controlled may be the feed of inbound materials 202 or the release of produced chemical product(s) 206. Another process step monitored and/or controlled may be the separation of chemical product(s) contained in mixtures resulting from chemical reactions performed within the chemical production 204. Another process step monitored and/or controlled may be the determination of chemical and/or physical properties of produced chemical product(s) 206 from data collected associated with the production of the chemical product, such as data measured by sensors 210a, 210b before, during and/or after production of the chemical product(s) 206. Another process step monitored and/or controlled may the generation of digital twins, for example using the apparatus for generating digital twins, such as the apparatus and system described in the context of FIGS. 4A to 4C. Yet another process step monitored and/or controlled may be the provisioning of the generated digital twins to a decentral data providing network node for access by a decentral data consuming network node, for example as described in the context of FIG. 5. Yet another process step monitored and/or controlled may be the generation of digital access elements associated with digital twins of produced chemical products, for example using an apparatus for generating digital access elements described in the context of FIG. 10.

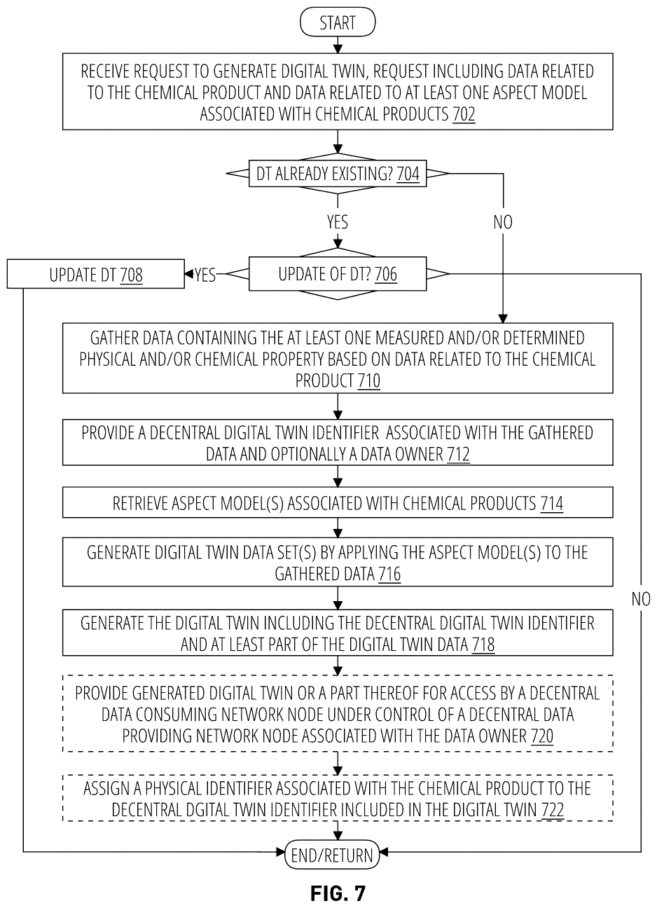

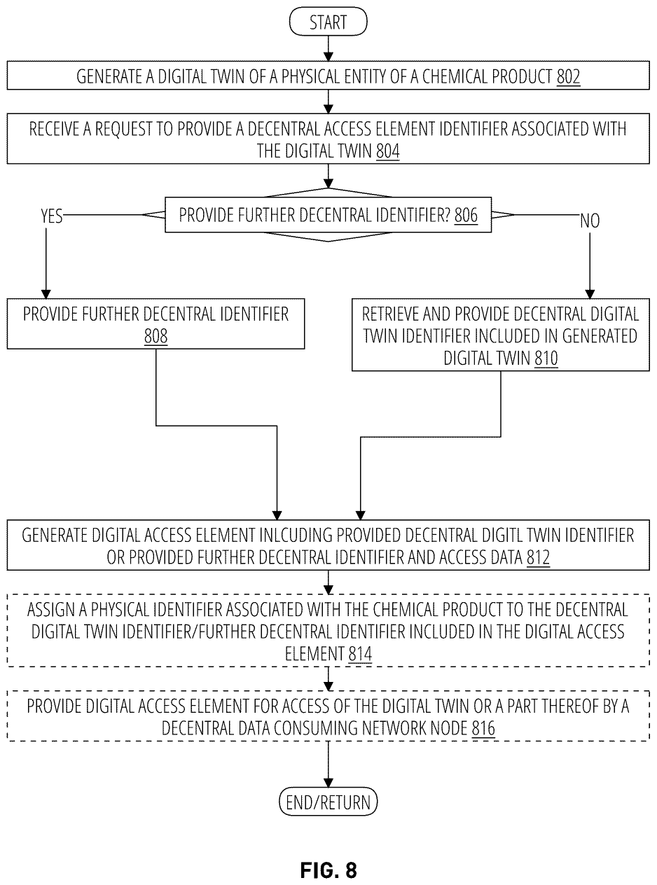

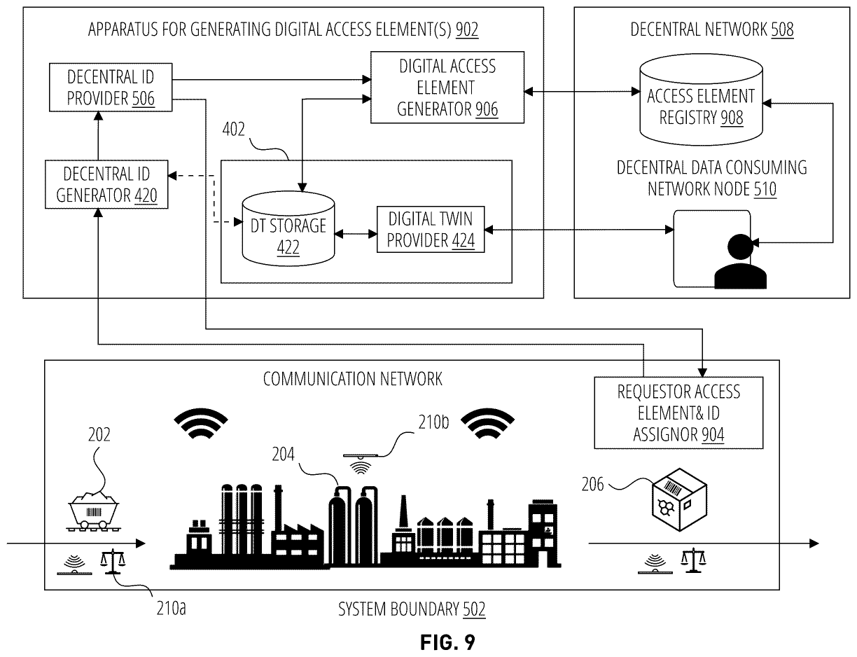

The operating system 208 may be configured to determine physical and/or chemical properties of the chemical product from collected data associated with the production of the chemical product. The operating system 208 may be configured to generate a digital twin of a chemical product, for example as described in the context of FIGS. 4A and 7. The operating system 208 may be configured to generate a digital access element, for example as described in the context of FIG. 4A, FIG. 8 and FIG. 9.

FIG. 2B illustrates another example of a chemical production 204 controlled by an operating system 208 to produce a chemical product associated with a digital twin and optionally a digital access element.

The process steps described in the context of FIG. 2A may be executed via an operating system 208 of the chemical production 204 in interaction with a requestor, an ID assignor, and an apparatus for generating digital twins of chemical products 212. The operating system 208 may further be in interaction with an apparatus for generating digital access elements (not shown). In this embodiment, the operating system 208 may be communicatively connected to the chemical production 204 and may comprise the requestor, the ID assignor, and the apparatus for generating digital twins of chemical products 212.

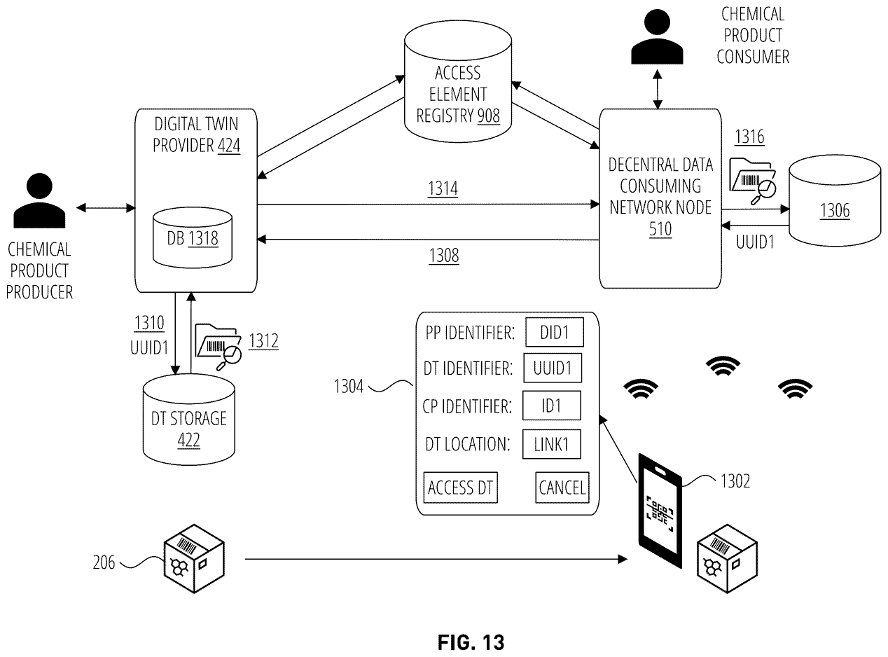

The apparatus for generating digital twins of chemical products may include a data gathering unit 412 configured to gather data associated with the chemical product from the chemical production 204 (see for example FIGS. 4A, 5). The data associated with the chemical product may include at least one measured physical and/or chemical property of the chemical product and/or at least one physical and/or chemical property determined from collected data associated with the production and/or the use of the chemical product. The apparatus for generating digital twins may further include a decentral ID generator 420 and a decentral ID provider 506 configured to generate the decentral digital twin identifier and to provide the generated decentral identifier (see for example FIGS. 4A and 5). The apparatus for generating digital twins of chemical products may further include an aspect agent 414 configured to receive at least one aspect model associated with the chemical product and to generate—for each received aspect model—a digital twin data set from the data associated with the chemical product and gathered by the data gathering unit according to the received aspect models, for example as described in the context of FIGS. 4A to 7. The apparatus for generating digital twins may further include a digital twin generator 418 configured to generate the digital twin including the decentral digital twin identifier and at least part of the digital twin data set(s) as described in the context of FIGS. 4A to 7. At least one digital twin data set contained in the digital twin may include the at least one measured physical and/or chemical property of the chemical product and/or at least one physical and/or chemical property determined from collected data associated with the production and/or the use of the chemical product. The apparatus for generating digital twins may further include a digital twin provider 424, such as a decentral data providing network node of a decentral network, configured to provide the digital twin or a part thereof, such as one or digital twin product data set(s) contained in the digital twin, to a decentral data consuming network node (not shown, see for example FIG. 5). The decentral data consuming network node may be associated with the consumer of the chemical product (see for example FIG. 13)

The requestor may be configured to generate a request to generate the digital twin. The request may contain data related to the chemical product, such a batch number, LOT number and/or chemical product ID, and data related to at least one aspect model associated with chemical products as previously described. The request may be received at the data gathering unit 412 of the apparatus for generating digital twins and the data gathering unit may, in response to the request, initiate generation of the digital twin by gathering data associated with the chemical product. The request may be received at the digital twin generator 418 of the apparatus for generating digital twins and the digital twin generator 418 may, in response to the request, initiate gathering data associated with the chemical product by the data gathering unit 414. The requestor may further be configured to generate a request to generate a digital access element. The request may contain an owner identifier and/or a product identifier and/or access data as previously described. The request may be received at the apparatus for generating the digital access element. The apparatus for generating the digital access element may be configured to retrieve the decentral digital twin identifier contained in the digital twin or to generate a further decentral identifier. The retrieved or generated further decentral identifier may be provided to a digital access element generator of said apparatus, said digital access element generator being configured to generate the digital access element.

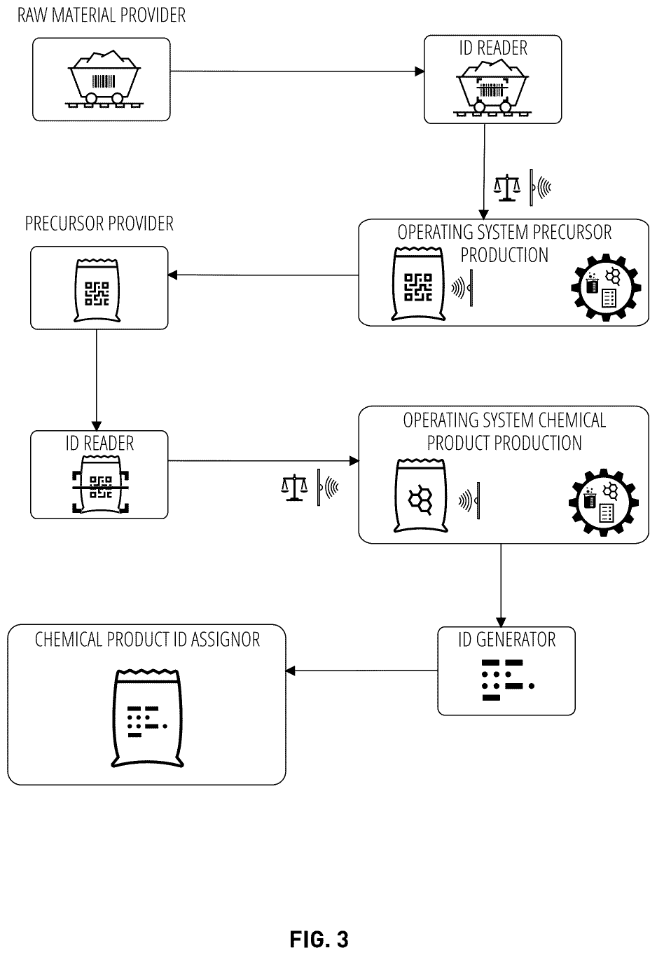

The ID assignor may be configured to assign the decentral digital twin identifier included in the digital twin and/or the decentral access element identifier associated with the digital twin, and associated information to a physical identifier of the produced chemical product as described in the context of FIG. 3. For instance, the ID assignor may generate a physical identifier having embedded the decentral digital twin identifier and/or the digital access element identifier and may provide the physical identifier to a labeling device.

The ID assignor, the requestor, the apparatus for generating digital twins and/or the apparatus for generating digital access elements may be configured as decentral services or applications executed via the decentral network.

FIG. 2C illustrates another example of a chemical production 204 controlled by an operating system 208 to produce a chemical product associated with a digital twin and optionally a digital access element.

The process steps described in the context of FIG. 2A may be executed via an operating system 208 of the chemical production 204 in interaction with a requestor, an ID assignor, and an apparatus for generating digital twins of chemical products. The operating system 208 may further be in interaction with an apparatus for generating digital access elements (not shown). In this embodiment, the operating system 208 may be communicatively connected to the chemical production 204 and may comprise the requestor and the ID assignor 214. The operating system 208 may be communicatively connected to the apparatus for generating digital twins 216.

The apparatus for generating digital twins 216 may include the data gathering unit 412, the aspect agent 414, a decentral ID generator 420 and a decentral ID provider 506, a digital twin generator 418 and a digital twin provider 424 as described in the context of FIG. 2B and FIG. 4A.

The requestor may be configured to generate a request to generate the digital twin as described in the context of FIG. 2B. The requestor may further be configured to generate a request to generate a digital access element as described in the context of FIG. 2B.

The ID assignor may be configured to assign the decentral digital twin identifier and/or the decentral access element identifier and associated information to the physical identifier of the produced chemical product as described in the context of FIG. 2B and FIG. 3. The requestor, the ID assignor, the apparatus for generating digital twins of chemical products and/or the apparatus for generating digital access elements may be configured as decentral services or applications executed via the decentral network. FIG. 2B and FIG. 2C only show two example embodiments and any combination of the system components shown in FIG. 2B and FIG. 2C may be possible. For instance, the requestor may be configured as part of the operating system 208, while the ID assignor may not be configured as part of the operating system 208.

FIG. 3 illustrates an example for generating digital twins for different chemical products in the chemical ecosystem. FIG. 3 specifically illustrates an example for generating a digital twin for a precursor material (e.g. intermediate chemical product) and for generating a digital twin for a chemical product produced at least in part from said precursor material. The chemical product, such as chemical product 206, may be produced by a chemical production 204 comprising an operating system 208, for example as described in the context of FIG. 2A to FIG. 2C.

The production of a chemical product may comprise a two-step process: 1) production of intermediate chemical product(s) from one or more inbound material(s), and 2) production of the chemical product at least in part from the intermediate chemical product(s). To produce the intermediate chemical product(s), inbound materials may be used as physical inputs. The inbound materials may be provided from raw material provider(s). The inbound materials may include virgin or recycled materials. The inbound materials may be provided to an intermediate chemical product production as inbound material 202. The intermediate chemical product production may be a chemical production 204 as described in the context of FIG. 2A to FIG. 2C. The inbound materials may comprise a physical identifier. The physical identifier may be or may be associated with a decentral inbound material identifier. The decentral inbound material identifier may be associated with a digital twin of the inbound materials. The operating system, such as the operating system 208 described in the context of FIG. 2A to FIG. 2C, of the intermediate chemical product production may comprise or be in communication with an ID reader configured to read the physical identifier and to determine the decentral inbound material identifier associated with said physical identifier. The decentral inbound material identifier may be associated with a digital twin or a part thereof of the respective inbound material. The digital twin of the inbound materials may be generated as described in the context of FIG. 7 below. The digital twin may include a measured physical and/or chemical property and/or a physical and/or chemical property determined from collected data associated with the production and/or the use of the inbound material. The physical and/or chemical property may be measured with sensors as described in the context of FIG. 2A to FIG. 2C. The physical and/or chemical property may be determined from collected data as described in the context of FIG. 2A to FIG. 2C. The digital twin may further include the inbound material name, inbound material producer, inbound material declaration data, inbound material safety data, emission data, recyclate content data, biobased content data, certificate of analysis data associated with the inbound material, certificates associated with the inbound material or a combination thereof.

The operating system may be configured to access the digital twin or a part thereof of inbound material(s) provided to the intermediate chemical product production based on the determined decentral inbound material identifier(s) e.g. from decentral data providing network node(s) associated with the inbound material provider(s) (see for example FIG. 13). Such data may be used to operate the chemical production producing the intermediate chemical product(s). For instance, if the inbound material(s) are recycled material(s), production steps purifying the recycled material(s) may be performed. For instance, if the inbound material(s) are virgin materials, purification steps may be omitted. The intermediate chemical product(s) may be formed by chemically reacting the inbound material(s) and/or by physically processing the inbound material(s). Chemical reactions may include polymerization, precipitation and other chemical reactions commonly known. Physical processing may include mixing, grinding, extruding, etc. The intermediate chemical product production may include sensors, such as sensors 210a, 210b, measuring physical and/or chemical properties of the intermediate chemical product(s) produced by the intermediate chemical product production as described in the context of FIG. 2A to FIG. 2C. The operating system may be configured to determine physical and/or chemical properties from collected data associated with the production of the intermediate chemical product(s), for example as described in the context of FIG. 2A to FIG. 2C.

The operating system may be configured to generate digital twin(s) for the produced intermediate chemical product(s) as described in the context of FIG. 7 below. Each digital twin may include a decentral intermediate chemical product identifier and at least one chemical and/or physical property of the respective intermediate chemical product measured by sensors 210a, 210b and/or at least one physical and/or chemical property of the respective intermediate chemical product determined from collected data. The digital twin may further include decentral inbound material identifier(s) of inbound material(s) used to produce the respective intermediate chemical product. This allows to track the inbound materials used to produce the respective intermediate chemical product. The digital twin may further include data previously described in relation with the digital twin of the inbound material(s). Intermediate chemical product digital access element(s) may be generated, for example as described in the context of FIG. 8 and FIG. 9. The produced intermediate chemical product(s) may be packaged, and the packaging may include a physical identifier, such as a QR code, an embossed code or an optical holographic code, such as zero-order diffractive microstructure. The physical identifier may be assigned to the respective decentral intermediate chemical product identifier of the digital twin and/or the respective decentral passport identifier of the intermediate chemical product digital access element. The assignment of the physical identifier and the decentral intermediate chemical product identifier may be executed through an ID assignor running locally, in a decentral system and/or in a distributed system. For instance, the packaging line may comprise a labelling device detecting the packaging of the produced intermediate chemical product(s). Based on such recognition, a requestor may generate a request to generate the digital twin and the respective decentral intermediate chemical product identifier included in the generated digital twin may be assigned, for example by the ID assignor, to the respective physical identifier (see also FIGS. 7A, 7B below). Assigning may include encoding the respective decentral intermediate chemical product identifier in a physical identifier and providing the physical identifier, such as a code, to the labelling device configured to attach the physical identifier to the respective intermediate chemical product, such as the packaging of the respective intermediate chemical product. The ID assignor may be part of the labelling device or may be a separate device.

In a second step, the intermediate chemical product(s) produced in step 1) may be provided to a chemical production as inbound material 202 to produce the chemical product 206. The chemical production may be the chemical production 204 described in the context of FIG. 2A to FIG. 2C. The chemical production may be the chemical production producing the intermediate chemical product(s). The chemical production may be different from the chemical production producing the intermediate chemical product(s). Apart from the intermediate chemical product(s) produced in step 1), further inbound material(s) may be provided to the chemical production and may be used to produce the chemical product 206. The intermediate chemical product(s) may comprise recycled intermediate chemical product(s) and/or intermediate chemical product(s) produced by a different intermediate chemical product production than the intermediate chemical product production described in the context of step 1). Such intermediate chemical product(s) may be associated with a physical identifier. The physical identifier may be associated with a decentral intermediate chemical product identifier via which the digital twin or a part thereof of the respective intermediate chemical product may be accessible. An ID reader may be used to read the physical identifier associated with the respective decentral intermediate chemical product identifier as described above. The digital twin or a part thereof may be retrieved via a decentral data consuming network node using the decentral intermediate chemical product identifier as described above.

Production data from the intermediate chemical product production of the intermediate chemical product may be used by the operating system, such as operating system 208 described in the context of 2A to FIG. 2C, of the chemical production to produce the chemical product 206 as described above. The chemical production may include sensors, such as sensors 210a, 210b, measuring physical and/or chemical properties of the chemical product produced by the chemical production as described in the context of 2A to FIG. 2C. The operating system may be configured to determine physical and/or chemical properties from collected data associated with the production of the chemical product, for example as described in the context of 2A to FIG. 2C.

The operating system may be configured to generate a digital twin for the produced or packaged chemical product as described above. The digital twin may include a decentral chemical product identifier and at least one measured and/or determined physical and/or chemical property as outlined above. The digital twin may include decentral intermediate chemical product identifier(s). This allows to track the intermediate chemical product(s) used to produce the chemical product and also indirectly the inbound material(s) used to produce the intermediate chemical product(s). The digital twin may include further data as outlined above, such as the producer name, producer brand, producer identifier, chemical product name, chemical product brand and chemical product identifier.

A digital access element associated with the chemical product may be generated, for example as described in the context of FIG. 9 and FIG. 10. The decentral chemical product identifier and/or the digital access element may be associated with the chemical product via a physical identifier as described above. The digital access element may include a decentral access element identifier and access data. Access data may include a digital representation pointing to the digital twin or parts thereof. The decentral access element identifier may correspond to or be associated with the decentral chemical product identifier.

FIG. 4A illustrates an example apparatus 402 for generating a digital twin of a physical entity of a chemical product. The apparatus may be a decentral participant node of a decentral network. The apparatus 402 may be included in the operating system 208 of a chemical production 204 producing chemical products from one or more inbound materials (see for example FIGS. 2A and 2B). The apparatus 402 may be communicatively coupled to the operating system 208 of a chemical production 204 producing chemical products (see FIG. 2C). The apparatus 402 may be configured to generate a digital twin of a chemical product, for example using the method described in the context of FIG. 7.

The apparatus 402 may be coupled to a data source layer 404 comprising one or more distributed data sources 402, 406, 408. The apparatus 402 may comprise the data source layer 404 (not shown). The one or more distributed data sources may be distributed databases. The distributed data source may be a data lake comprising data associated with chemical products from a plurality of distributed data sources. In this example, the data source layer 404 contains three distributed data sources. However, the data source layer 404 may also comprise less or more distributed data sources. The one or more distributed data sources may contain data associated with chemical products, such as chemical products produced by chemical production 204 from one or more inbound materials 202 as described in the context of FIGS. 2A to 3. The data associated with chemical products may include at least one measured physical and/or chemical property of each chemical product and/or at least one physical and/or chemical property determined from collected data associated with the production and/or the use of each chemical product. The at least one physical and/or chemical property may be measured using sensors, such as sensors 210a, 210b, and the measured chemical and/or physical property/properties may be stored in the distributed data sources. The at least one physical and/or chemical property may be determined from data acquired from sensors, such as sensors 210a, 210b, before, during and/or after production and the determined chemical and/or physical property/properties may be stored in the distributed data sources. The one or more distributed data sources may further contain chemical product names, chemical product producer, chemical product declaration data, chemical product safety data, emission data, recyclate content data, biobased content data, certificate of analysis data associated with the chemical products, certificates associated with the chemical products or a combination thereof.

The data associated with chemical products may be acquired before, during and/or after production of the chemical products 206. The acquired data may be provided to the data source layer 404 for storage. The data source layer 404 may be owned or controlled by the data owner of the data associated with chemical product data. The data source layer 404 may be associated with the data owner of the data associated with chemical product data. At least one of the distributed data sources may contain data instances that relate to the chemical product 206 for which apparatus 402 is configured to generate the digital twin. At least one data instance may contain at least one measured physical and/or chemical property of the chemical product and/or at least one physical and/or chemical property determined from collected data associated with the production and/or the use of the chemical product. The data source layer 404 may be connected, for example via a communication interface such as a network or an API, to a data gathering unit 412. The data source layer 404 may be connected directly to the data gathering unit 412 or may be connected to a further layer being present in between the data source layer and the data gathering unit 412 (not shown, see for example FIG. 4B).

Data gathering unit 412 may be configured to receive a request to generate a digital twin associated with a chemical product 206 produced by chemical production 204. The request may contain data related to the chemical product and data related to at least one aspect model associated with chemical products. Data related to the chemical product may include chemical product identifier(s) associated with the produced chemical product 206, such as a batch number, a LOT number, an ID, or a combination thereof. Data related to the at least one aspect model may include aspect model identifier(s). The data gathering unit 412 may be configured to gather data associated with the chemical product from the data source layer 404 based on the received data related to the chemical product. For instance, a chemical product identifier may be received with the request, such as a batch number, and said received chemical product identifier may be used to gather data associated with said chemical product identifier. In another instance, a chemical product identifier may be received and may be used to determine a further chemical product identifier, such as a chemical product number, a LOT number or a batch number. Said further chemical product identifier may then be used to gather the data associated with said chemical product based on the determined further chemical product identifier. In yet another instance, the chemical product identifier may be received from a user via an input/output device 426. The input/output device 426 may be connected to data gathering unit 412 via a communication interface, such as a network, and may be configured to display a graphical user interface displaying chemical product data associated with chemical products, such as chemical product names and associated chemical product identifiers. The input/output device 426 or the data gathering unit 412 may be configured to detect a user input being indicative of selecting chemical product data associated with chemical products. In response to the detected user input, the data gathering unit 412 may be configured to gather the data associated with the chemical product based on the detected user input.

Data gathering unit 412 may be configured to determine, upon receiving the request to generate the digital twin, whether a digital twin associated with said chemical product is already contained in digital twin (DT) storage 422. For instance, the data gathering device 412 may use the chemical product identifier contained in the received request to determine whether a digital twin associated with said chemical product identifier is already contained in DT storage 422. This avoids generation of digital twins for chemical products, for which digital twins are already existing in DT storage 422 (e.g. for which a digital twin has already been generated previously).

Apparatus 402 may further comprise digital twin generator 418 configured to generate the digital twin including a decentral digital twin identifier, such as a decentral digital twin identifier provided by decentral ID generator 420, and one or more digital twin data set(s), such as digital twin data set(s) generated by aspect agent 414. The decentral identifier may include one or more DID(s) and/or one or more UUID(s). The one or more DID(s) and/or UUID(s) may be associated with the digital twin and/or the digital twin data set(s) contained in the digital twin. The one or more DID(s) and/or UUID(s) may further be associated with the chemical product. The digital twin generator 418 may be configured to generate the digital twin according to the method described in the context of FIGS. 5 and 7. The digital twin generator 418 may be configured to request the decentral digital twin identifier. Said request may include at least one authentication mechanism or may include selecting at least one of multiple authentication mechanisms. The request may include an owner identifier and/or a chemical product identifier and/or access data. The digital twin generator 418 may be configured to generate the access data. Access data may include digital representation(s) pointing to the digital twin data set(s). Access data may further include chemical product data set identifier(s). The digital twin generator 418 may be configured to assign the decentral digital twin identifier received from decentral ID generator 420 to at least part of the digital twin data sets generated by aspect agent 414. For instance, the digital twin generator 418 may assign the chemical product identifier contained in at least part of the digital twin data sets to the received decentral digital twin identifier such that at least part of the digital twin data sets of the chemical product are associated with the decentral digital twin identifier. Assigning may include interrelating the decentral digital twin identifier with at least part of the digital twin data sets associated with the chemical product and stored in DT storage 422, such as digital twin data sets stored by aspect agent 414 in DT storage 422 as outlined below. The digital twin generator 418 may be configured to assign the decentral digital twin identifier received from decentral ID generator 420 to digital twin data set identifier(s) associated with at least part of the digital twin data set(s) generated by aspect agent 414. The digital twin generator 418 may be configured to provide the generated digital twin or a part thereof (e.g. digital twin data set(s), also denoted as assets or aspects of the digital twin hereinafter) to digital twin provider 424. The digital twin generator 418 may be configured to provide the decentral digital twin identifier and access data associated with the digital twin to the digital twin provider 424. The digital twin generator 418 may be configured to provide access rules associated with each digital twin or each digital twin data set to the digital twin provider 424 as described later on.

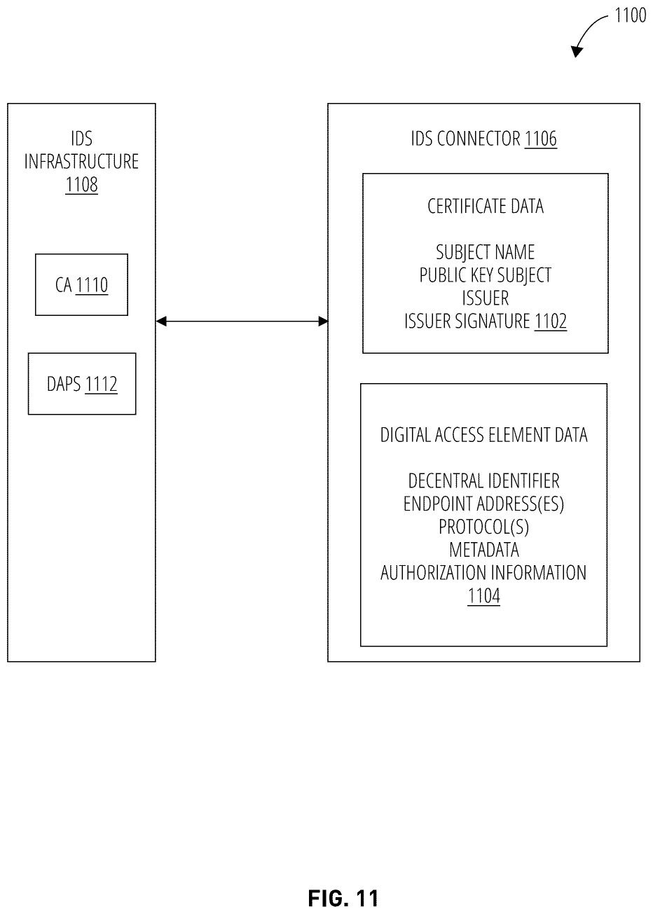

The apparatus 402 may further comprise a decentral ID generator 420 configured to generate and provide a decentral digital twin identifier associated with the data associated with the chemical product and optionally a data owner, such a data owner of the data associated with the chemical product. The decentral ID generator 420 may be configured to generate-apart from the decentral digital twin identifier -digital twin data set identifier(s). The decentral ID generator 420 may be communicatively coupled to apparatus 402, e.g. apparatus 402 may not comprise said decentral ID generator 418 (not shown). The decentral digital twin identifier may further be associated with a data owner of the data associated with the chemical product and/or the digital twin data set(s), such as the entity operating the chemical production. The decentral ID generator 420 may be a central or decentral network node configured to generate a decentral ID, such as a DID or UUIDv4 as described in relation to FIGS. 10 and 11. The decentral ID generator 420 may be computing node that acts as a DID owner's management module, user agent, ID hub and/or certification issuer. The decentral ID generator 420 may be configured to receive a request to provide a decentral digital twin identifier associated with the data associated with the chemical product gathered by data gathering unit 412 and optionally a data owner. Said request may include at least one authentication mechanism or may include selecting at least one of multiple authentication mechanisms. The request may include an owner identifier and/or a chemical product identifier and/or access data as previously described. Decentral ID generator 420 may be configured to generate the decentral digital twin identifier as well as data related to the authentication mechanism and to provide the generated digital twin decentral identifier and data related to the authentication mechanism to digital twin generator 418.

The aspect agent 414 may be configured to retrieve-based on the data related to the at least one aspect model contained in the received request-at least one aspect model from an aspect model database 416 connected via a communication interface to the aspect agent 414. Each aspect model may include the structure of at least a portion of the digital twin data set, and/or properties of the digital twin data set. The aspect model database 416 may contain aspect model(s) related to environmental attributes associated with the chemical products. The environmental attributes may relate to emission data, such as CO₂ footprint data, recyclate content, bio-based content, renewable content, certificates, or a combination thereof.

The aspect agent 414 may be configured to use predefined aspect model identifier(s) associated with available aspect model(s). Use of different aspect models allows to generate different digital twin data sets containing different data associated with the chemical product. The different digital twin data sets allow the data owner to more granularly structure the data associated with the chemical product that is contained in the digital twin, thus allowing to control access and define access to said data more granularly. For instance, a digital twin data set containing access restricted data, such as data related to environmental properties, the composition of the chemical product, etc., may be associated with an access policy strictly regulating access to said digital twin data set while a digital twin data set containing data required from a regulatory point of view may not be associated with an access policy or may be associated with an access policy granting access to said data less strictly.

The aspect agent 414 may be configured to generate-for each retrieved aspect model-a digital twin data set associated with the chemical product by applying each retrieved aspect model to the gathered data received from digital twin generator 418. For instance, the aspect agent 414 may map the data associated with the chemical product and gathered from the one or more distributed data sources to the structure and/or properties of the respective aspect model. The aspect agent 414 may be configured to store at least part of the generated digital twin data sets in the DT storage 422. This allows to avoid unnecessary data transfer between the aspect agent 414 and the digital twin generator 418. Moreover, this allows to separate the digital twin generation and the digital twin accessing, hence improving the overall stability and availability of the digital twin generation and provision. At least part of digital twin data sets may contain a chemical product identifier to allow linkage of the generated digital twin data set(s) to the respective chemical product. For instance, each generated digital twin data set may include the same chemical product identifier.

Each digital twin data set associated with the decentral identifier of the digital twin may be regarded as an asset or aspect of the digital twin. Each asset or aspect may be uniquely identified by digital twin data set identifier. Hence, the combination of decentral digital twin identifier and digital twin data set identifier may allow to uniquely identify a digital twin data set associated with a chemical product. Moreover, said combination also allows to specifically retrieve such digital twin data set, for example via a decentral data consuming network node using the decentral digital twin identifier, the digital twin data set identifier and access data as described in the context of FIG. 13.

The apparatus 402 may further comprise DT storage 422 configured to store the digital twin data set(s) generated by aspect agent 414. DT storage 422 may be configured to store data associated with the chemical product gathered by data gathering unit 414. The digital twin data set(s) stored in DT storage 422 may be interrelated with the decentral digital twin identifier provided by decentral ID generator 420 to allow retrieval of said digital twin data set(s) based on the decentral digital twin identifier. The digital twin data set(s) may be further interrelated with the digital twin data set identifier(s) to allow retrieval of a specific digital twin data set based on the decentral digital twin identifier in combination with the digital twin data set identifier(s). This allows to retrieve specific assets or aspects of the digital twin without having to provide all data contained in the digital twin. Moreover, this allows to define access rights on asset/aspect level, thus allowing a more granular control of access to the data contained in the respective asset/aspect of the digital twin.

The apparatus 402 may further comprise a digital twin provider 424 configured to provide the digital twin or a part thereof generated by digital twin generator 418 for access, for example by a decentral data consuming network node associated with a consumer of the chemical product (see also FIG. 13). The digital twin provider may be a decentral data providing network node. The apparatus 402 may be communicatively coupled to a digital twin provider 424 configured to provide the digital twin generated by digital twin generator 418 for access (not shown, see for example FIG. 4B). The digital twin provider 424 may be configured to receive the generated digital twin or a part thereof (e.g. assets or aspects of the digital twin) from the digital twin generator 418. The digital twin provider 424 may be configured to receive the decentral digital twin identifier and access data associated with the digital twin from the digital twin generator 418. The digital twin provider 424 may store the received data in a database (not shown). This may allow digital twin provider 424 to retrieve the digital twin or a part thereof, for example from DT storage 422, and provide the respective data to a decentral data consuming network node, for example as described in the context of FIG. 5 and FIG. 13. For instance, the database may store the decentral digital twin identifier associated with each digital twin and the access data. Storing access data for each digital twin data set in combination with the decentral digital twin identifier allows to avoid unnecessary data traffic, since only the requested digital twin data set and not the complete data contained in the digital twin needs to be retrieved upon request, for example by a decentral data consuming network node. Based on the decentral digital twin identifier and the access data stored in the database, digital twin provider 424 may retrieve the digital twin or a part thereof from DT storage 422 and may provide the retrieved data to a decentral data consuming network node.

The digital twin provider 424 may be configured to receive access rules associated with each digital twin or a part thereof from digital twin generator 418. The digital twin provider 424 may be configured to store the received access rules in a database of digital twin provider 424. The access rules may include a list of decentral participant identifiers associated with decentral data consuming network nodes allowed to access the data contained in the digital twin or the digital twin data set(s). The access rules may include usage policies defining processing, aggregating or forwarding data of the digital twin or data of the digital twin data set(s). The access rules may be associated with the decentral digital twin identifier of the digital twin and/or the digital twin data sets of the digital twin. The access rules may be further associated with the digital twin data set identifier(s).

The usage policies may be bound to data being exchanged and enforcement of attached usage policies may be continuously controlled, for example by the decentral data consuming network node receiving the data or by a decentral data processing network node processing received data. Usage policies may be instantiated on the target system. Usage policies may be adhered to the data (also called sticky policy). Sticky policies are one way to cope with the distribution of the usage restrictions. In this approach, machine-readable usage policies may stick to data when it is exchanged. There exist different realization possibilities. For instance, data may be encrypted and can only be decrypted when the adherence to the usage restrictions are guaranteed.

Usage policies may include additional information provided e.g. by a policy information registry. Additional information may include information about contextual information such as previous data usages or the geographical location of an entity, pre-or post-conditions that have to hold before (e.g. integrity checks) and after (e.g. data item is deleted after usage) the decision-making and on-conditions that have to hold during usage (e.g. only during business hours). For instance, the policy information registry may be used to resolve the ID of a supplier to a postal address and the postal address to GPS coordinates.

Usage control may be implemented by encrypting the data within a decentral network node connected to a storage infrastructure before transferring the data to the storage infrastructure. Using the data is only possible by using the decentral network node to decrypt the data. Hence, every usage is controlled by the decentral network node. In such cases, usage restrictions such as data lifetime or time constraints can be enforced by deleting the cryptographic key material. Additionally or alternatively, the storage infrastructure may include a usage control enforcement component that monitors and/or controls the usage of the data.

FIG. 4B illustrates an example of a layered system for generating a digital twin of a physical entity of a chemical product. The layered system may be included in the operating system 208 of a chemical production 204 producing chemical products 206 from one or more inbound materials 202 (see for example FIGS. 2A and 2B). At least part of the layered system may be included in the operating system 208 while another part may be communicatively coupled to said operating system 208 (see for example FIG. 2C).

The layered system may comprise a data source layer 404, such as the data source layer 404 described in the context of FIG. 4A. The data source layer 404 may comprise one or more distributed data sources 402, 406, 408. The distributed data sources may contain data instances that relate to chemical products 206 produced by the chemical production 204 as described in the context of FIG. 3 and FIG. 4A.

The system may further comprise a service layer 428, this layer generally being optional. The service layer may be configured to gather data associated with chemical products from the data source layer 404. The service layer may be configured to gather data according to predefined selection criteria. The service layer may be configured to apply one or more semantic models on the gathered data to generate a uniform data collection. The service layer may be configured to provide the uniform data collection to a data streaming platform included in the service layer. The streaming platform may include a platform that is deployed across a number of hosts, clusters, data centers, and/or other collections of computing resources. The streaming platform may include one or more client processes that generate records of activity and publish the records to one or more event streams. For instance, when a certain type of activity occurs in the data source layer 404, for example provision of a new uniform data collection, production of a new batch of chemical product, collection of new data associated with produced chemical product, etc., the one or more client processes may generate a record of the activity and publish said record to one or more event streams. The data streaming platform may then propagate the record to one or more components subscribing to the same event streams(s). The data propagated to one or more components may be stored in a database present within the service layer or the consumer layer. The data streaming platform thus allows activity occurring in multiple distributed data sources of the data source layer 404 to be captured and transmitted in a unified, scalable manner.

The system may further comprise a consumer layer 430. The consumer layer 430 may include an apparatus for generating digital twin(s), such as apparatus 402 described in the context of FIG. 4A. The consumer layer 430 may be configured to gather data associated with the chemical product from the data source layer 404, for example as described in the context of FIG. 4A. The consumer layer 430 may be configured to consume data from the service layer 438, for example from one or more database(s) of the service layer 428 comprising the data stored by consumer components of the data streaming platform of service layer 428. The consumer layer 430 may be configured to generate digital twins of chemical products from the data gathered from data source layer 404 or data consumed from service layer 428 as described in the context of FIGS. 4A, 5 and 7. The consumer layer 430 may be connected to an input/output device (not shown), for example input/output device 426 of FIG. 4A. The input/output device 426 may be used to trigger generation of a digital twin of a chemical product as described in the context of FIG. 4A.

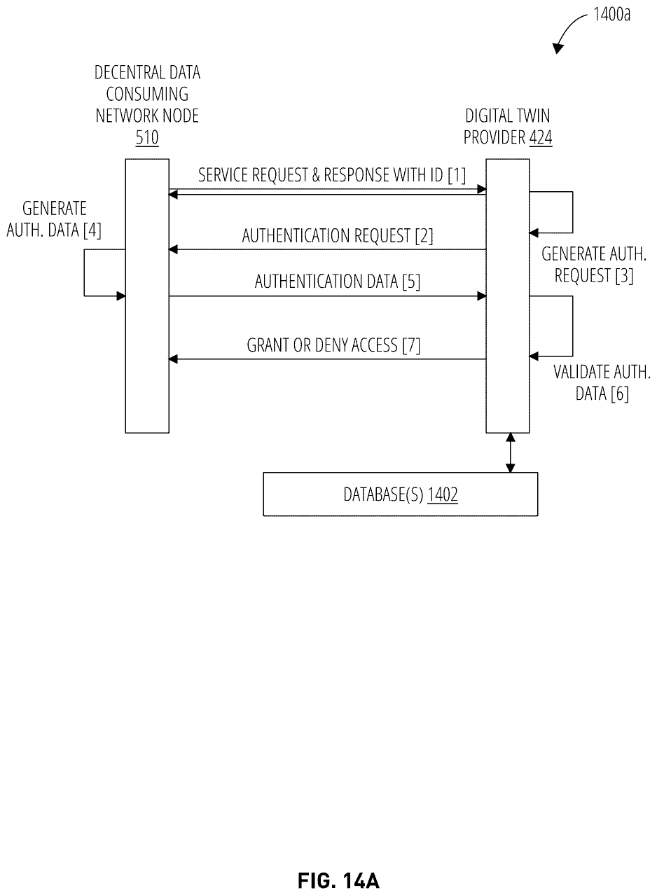

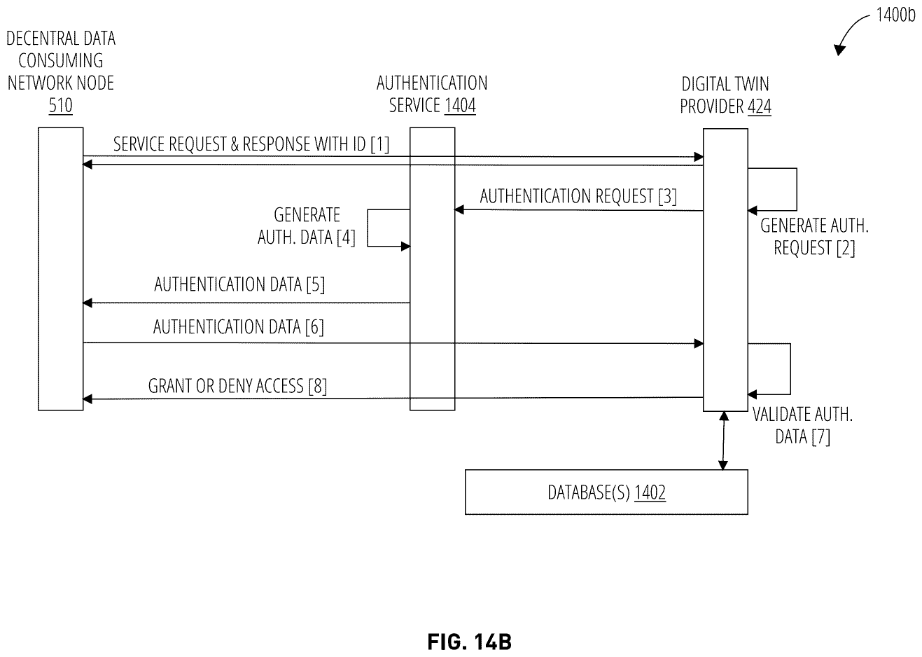

The system may further comprise a connector layer 432. The connector layer 432 may be configured to provide the digital twin or a part thereof generated in the consumer layer 430 for access. The connector layer 432 may comprise a digital twin provider 424, such as a decentral data providing network node described in the context of FIGS. 5 and 13, configured to provide access to the digital twin or a part thereof. The access may be controlled via the digital twin provider 424 by the data owner of the digital twin or a part thereof, for example by access rules associated with the digital twin or a part thereof as described in the context of FIG. 4A. The digital twin provider 424 of the connector layer 432 may be configured to exchange data, such as data contained in the digital twin, with a decentral data consuming network node. The decentral data consuming network node may be associated with a consumer or processor of the chemical product (see for example FIG. 13). The decentral data providing network node and the decentral data consuming network node may perform authentication steps, for example as described in relation to FIGS. 14A and 14B prior to exchange of data. The digital twin provider 424 may apply access rules associated with the digital twin or a part thereof requested by the decentral data consuming network node prior to providing said data to said decentral data consuming network node, for example as described in the context of FIG. 4A. The digital twin provider 424 may deny access to the digital twin or a part thereof based on said access rules. The digital twin provider 424 may grant access to the digital twin or a part thereof based on said access rules. The digital twin provider 424 may modify access to the digital twin or a part thereof based on said access rules. The access may be granted for all data contained in the digital twin (e.g. all data associated with the decentral digital twin identifier) or a part thereof, such as specific digital twin data set(s) contained in the digital twin.

The layered system allows to achieve availability, integrity and confidentiality of the data contained in a digital twin or the digital twin data set(s). The connector layer allows to configure and ensure technically that only predefined decentral network participants can access and retrieve data associated with the digital twin. For instance, separation of the digital twin generation and the consumption of data contained in the digital twin allows to achieve a high and stabile availability of data contained in the digital twin within the decentral network.

FIG. 5 illustrates an example system and associated methods for generating a digital twin associated with a chemical product produced by a chemical production and providing access to the generated digital twin. The apparatus for generating digital twin(s) may be apparatus 402 described in the context of FIG. 4. The apparatus for generating digital twin(s) may be included in operating system 208 of a chemical production 204 (see for example FIG. 2A, FIG. 2B). The apparatus for generating digital twin(s) of chemical product(s) may be communicatively coupled to the operating system 208 of a chemical production 204 (see for example FIG. 2C). The digital twin may be generated by the system described in the context of FIG. 4C

The chemical production may be chemical production 204 described in relation to FIGS. 2 to 2C. The chemical production 204 may produce at least one chemical product 206 from one or more inbound material(s) 202. The inbound materials may be provided to the chemical production 204, for example as described in the context of FIG. 2A to FIG. 2C. The inbound materials may enter the system boundary 504 of the chemical production 204 at the entry point, such as a production plant or a material storage associated with the chemical production 204. The amount of inbound material entering the system boundary 504 of the chemical production 204 may be measured, for example using sensor 210b described in the context of FIG. 2A to FIG. 2C. Chemical and/or physical properties of the inbound material may be measured, for example using sensor 210a described in the context of FIG. 2A to FIG. 2C, upon passing system boundary 504 of the chemical production 204. The measured data may be used to determine at least one chemical and/or physical property of the inbound material.

The inbound materials may be used in the chemical production 204 to produce one or more chemical product(s) from the inbound materials, for example as described in the context of FIG. 2A to FIG. 2C. The operating system 208 of the chemical production 204 may monitor and/or control the chemical production 204 based on operating parameters of the different processes. The operating system 208 may receive production demand data associated with the production planning for the chemical production 204. The production demand data may be produced from target production capacities for one or more chemical product(s) produced by the chemical production 204. The production demand data may be produced from pre-defined production capacities or data-driven models that relate production capacities to market demand data or quantities consumed at the consumption location. The production demand data may include target capacities for chemical products produced by the chemical production 204. The operating system 208 may further receive a bill of materials associated with chemical products to be produced. The bill of materials may include material data associated with the materials used to produce the chemical product, process data associated with the production chain for producing the chemical product and/or chemical product data associated with the chemical product, such as a product specification data or data on the amount of chemical product to be produced.

Based on the received production demand data and the bill of materials, material demand data may be determined. The material demand data may include data on the amount of material required to produce the target capacities of chemical product. The material demand data may include material identifiers associated with materials required to produce the chemical product and data on amounts of material for respective materials. The material demand data may include one or more material specifier(s) per material identifier signifying the material specification. The material demand data may include data on the material amount per material identifier signifying the amount of material to be supplied. The material demand data may specify the production chain(s) of the chemical production 204. The material demand data may include a bill of materials for one or more production chain(s) of the chemical production 204. The material demand data may include one or more recipe(s) specifying one or more material(s) for production process(es) of the chemical production 204. The determined material demand data may be provided for access by a supplier system associated with a supplier outside the physical system boundary of the chemical production 204. Material supply may be triggered by the supplier system accessing the material demand data.

The amount of chemical product(s) resulting from processes performed within chemical production 204, such as chemical reactions and/or physical processing, may be measured using a sensor, such as sensor 210b described in the context of FIG. 2A to FIG. 2C. Since chemical reactions may result in more than one reaction product, e.g. a chemical reaction is associated with a many-to-many relationship between starting materials and resulting reaction products (see also FIG. 2A to FIG. 2C), measuring the amount of chemical product(s) resulting from each chemical reaction performed within chemical production 204 allows to track material flows within the chemical production 204. The measured data may be stored in one or more databases associated with operating system 208. Moreover, chemical reactions and/or physical processes may be monitored using sensors, such as sensors 210b, and the generated monitoring data may be stored in one or more databases associated with operating system 208. The measured amounts of produced chemical products as well as the monitoring data may be used to generate a digital twin of each production process performed within chemical production 204. The measured amounts of produced chemical products as well as the monitoring data may be used to generate a digital twin of the chemical production 204. This digital twin allows to reliably track and account for flows of inbound material, intermediate chemical products and chemical products despite the many-to-many relationships between starting materials and reaction products associated with chemical reactions. Physical and/or chemical properties of produced chemical products may be measured by sensors, such as sensors 210a, and/or determined as described in the context of FIG. 2A to FIG. 2C. The measured and/or determined chemical and/or physical properties of the produced chemical products 206 may be stored in one or more databases associated with operating system 208.

The produced chemical products 206 may be provided at one or more exit points of the chemical production. The chemical product 206 may exit the system boundary 502 of the chemical production 204. Upon producing the chemical product 206 or upon exiting of the chemical product 206 of the chemical production 204, the digital twin may be generated. The apparatus 402 may be configured to generate the digital twin as described in the context of FIGS. 4A and 7. A requestor 504 may be configured to generate the request to generate the digital twin. The requestor 504 may be included in a labelling device, for example as described in the context of FIG. 3. The request may contain data related to the chemical product, such as a batch number. The request may further contain data associated with aspect model(s) related to chemical products, such as aspect model identifier(s). The request to generate the digital twin may be provided to data gathering unit 412 of apparatus 402. In response to the request, data gathering unit 412 may be configured to gather data associated with the chemical product, for example from a data layer such as data source layer 404 (not shown, see for example FIGS. 4A and 4B), based on the data contained in the received request (see FIG. 4A, FIG. 4B). The data gathering unit 412 may be configured to determine whether a digital twin associated with the produced chemical product 206 is already contained in DT storage 422 (see FIG. 4A). The request to generate the digital twin may be provided to digital twin generator 418 of apparatus 402 (not shown). In response to the request, digital twin generator 418 may be configured to initiate gathering of data associated with the chemical product by data gathering unit 412.

Data gathering unit 412 may provide the gathered data to digital twin generator 418. Digital twin generator 418 may be configured to request a decentral digital twin identifier associated with the gathered data and optionally a data owner from decentral ID provider 506, for example as described the context of FIG. 4A. Digital twin generator 418 may be configured to retrieve digital twin data set(s) from aspect agent 414. The digital twin generator 418 may be configured to generate the digital twin as described for example in the context of FIGS. 4A and 7. The digital twin may include the decentral digital twin identifier and at least part of the digital twin data sets generated by aspect agent 414. The digital twin generator 418 may be configured to provide the generated digital twin to a digital twin provider 424.

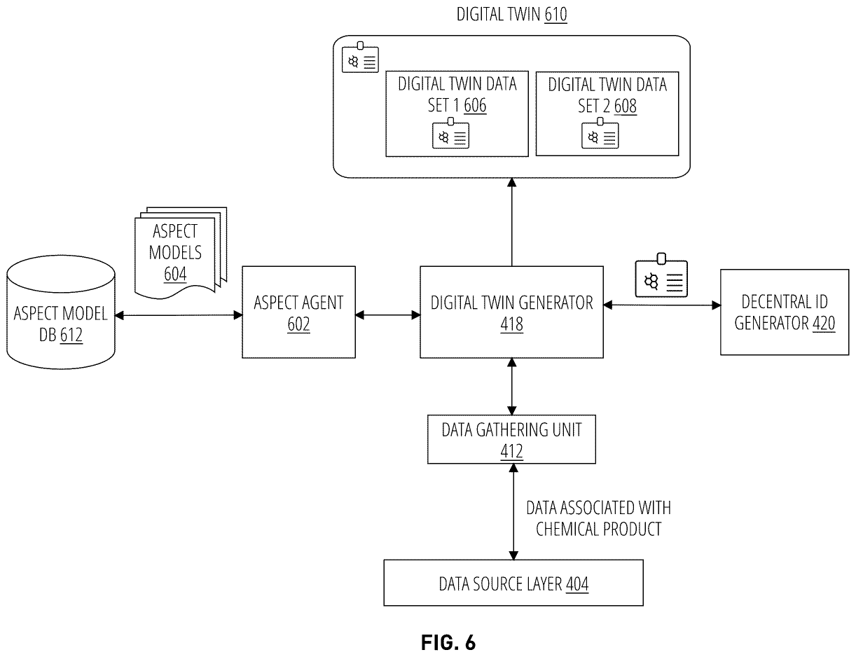

Aspect agent 414 may be configured to retrieve at least one aspect model from aspect model DB 416 (not shown, see for example FIG. 4) and to generate digital twin data set(s) for each retrieved aspect model (see for example FIG. 4 and FIG. 6). Aspect agent 414 may be configured to store at least part of the generated digital twin data sets in DT storage 422 (see FIG. 4A). Aspect agent 414 may be configured to provide at least part of the generated digital twin data set(s) to digital twin generator 418.

The decentral ID generator 420 may be configured to generate a decentral digital twin identifier associated with the gathered data and optionally a data owner, such a data owner of the data associated with the chemical product. Decentral ID generator 420 may be configured to generate a decentral identifier including or being associated with further identifier, such as data set identifier(s). For instance, decentral ID generator 420 may be configured to generate a digital twin identifier, such as a DID or a UUID. Decentral ID generator 420 may be configured to generate digital twin data identifier(s), such as DID(s) and/or UUID(s). Decentral ID generator 420 may comprise a component configured to generate Decentralized Identifier(s) (DID(s)). Decentral ID generator 420 may comprise a component configured to generated Universally Unique Identifiers (UUID(s)). The decentral identifier generated by decentral ID generator 420 may be one or more DID(s) and/or UUID(s). The one or more DID(s) and/or UUID(s) may be associated with the digital twin and/or the digital twin data set(s). The one or more DID(s) and/or UUID(s) may further be associated with the chemical product. For instance, the decentral digital twin identifier may include a digital twin identifier associated with the digital twin and one or more digital twin data identifier(s) associated with digital twin data. The decentral identifier may further include a chemical product identifier associated with the chemical product. Decentral ID generator 420 may be a central or decentral node or a computing node as described in the context of FIG. 4A. The decentral digital twin identifier may be requested by digital twin generator 418. The decentral digital twin identifier may be requested by the decentral ID provider, for example upon receiving a request from the digital twin generator 418 (not shown). The decentral ID generator 420 may be part of the apparatus 402. The decentral ID generator 420 may be communicatively coupled to apparatus 402 (not shown). The decentral ID generator 420 may be configured to provide the generated decentral digital twin identifier to a decentral ID provider 506. The decentral ID generator 420 and the decentral ID provider 506 may be separate devices as illustrated in FIG. 5. The decentral ID generator 420 and the decentral ID provider 506 may be contained within one device configured to generate the decentral identifier and to provide the generated decentral identifier, for example as illustrated in FIG. 4A.

The decentral ID provider 506 may be configured to provide the received decentral digital twin identifier to the requestor 504 configured to associate the received decentral digital twin identifier with the chemical product. For this purpose, the requestor 504 may include an ID assignor (see for example FIGS. 2B, 2C, 3). The decentral ID provider 506 may be configured to provide the received decentral digital twin identifier to an ID assignor configured to associate the received decentral identifier with the chemical product (not shown). Such association may include encoding the decentral identifier into a code, such as a bar code, a QR code, an embossed code, an optical holographic identifier, and providing the generated code for labelling of the chemical product. This way a physical identifier may be provided that relates the physical entity of the chemical product with the decentral digital twin identifier and hence the digital twin with the physical entity of the chemical product.

The digital twin provider 424 may be configured to provide the digital twin or a part thereof for access by a decentral data consuming network node 510. The decentral data consuming network node 510 may be part of a decentral network 508. The digital twin or a part thereof may be accessed by the decentral data consuming network node 510 using at least the decentral digital twin identifier. Access to the digital twin or a part thereof may be controlled by digital twin provider 424 (see for example FIG. 13). The digital twin provider 424 may be associated with the data owner of the digital twin data set(s). The digital twin provider 424 may be associated with the data owner of the digital twin. The digital twin provider 424 may be associated with the operator of the chemical production 204. The digital twin provider 424 may be a decentral data providing network node.

FIG. 6 illustrates an example apparatus for generating a digital twin of a physical entity of a chemical product using at least two different aspect models. The apparatus may correspond to the apparatus 402 described in the context of FIG. 4A. The apparatus may be included in an operating system 208 of a chemical production 204 producing chemical products 206 from one or more inbound materials 202 (see for example FIGS. 2A and 2B). The apparatus may be communicatively coupled to the operating system 208 of a chemical production 204 producing chemical products 206 from one or more inbound materials 202 (see for example FIG. 2C). The apparatus may be configured to generate a digital twin 608, for example as described in the context of FIG. 4A and FIG. 7. The apparatus of FIG. 6 may be connected to a data source layer 404 as described in the context of FIG. 4A.

The apparatus may comprise a data gathering unit 412 configured to gather data associated with a chemical product for which a digital twin is to be generated from the data source layer 404, for example as described in the context of FIGS. 4A, 5 and 7. The gathered data may be provided to digital twin generator 418. The gathered data may be retrieved by digital twin generator 418.

The digital twin generator 418 may be configured to request a decentral digital twin identifier from decentral ID provider 420, for example as described in the context of FIGS. 4A to 5. Digital twin generator 418 may be configured to provide data gathered by data gathering unit 412 to aspect agent 414. Digital twin generator 418 may be configured to retrieve or receive digital twin data set(s) generated by aspect agent 414. Digital twin generator 418 may be configured to retrieve or receive digital twin data set(s) from DT storage 422. Digital twin generator 418 may be configured to generate the digital twin of the chemical product from the received decentral digital twin identifier and at least part of the received or retrieved digital twin data set(s), for example as described in the context of FIGS. 4A, 5 and 7. For instance, the digital twin generator 418 may associate the received decentral digital twin identifier with each of the generated digital twin data sets to generate the digital twin 608. Hence, the decentral identifier allows to identify all digital twin data sets included in a digital twin 608 of a chemical product. Each digital twin data set may be uniquely identified by a digital twin data set identifier in combination with the decentral digital twin identifier as described in the context of FIG. 4A. The digital twin generator 418 may be configured to generate access data, for example as described in the context of FIG. 4A. The digital twin generator 418 may be configured to generate a DID document containing the decentral digital twin identifier (e.g. DID) received from decentral ID provider 420 and access data, such as chemical digital twin data set identifier(s) and respective digital representation(s) pointing to said digital twin data set(s). Digital twin generator 418 may be configured to store the generated digital twin 608 in the DT storage 422 as described in the context of FIGS. 4A and 5. Digital twin generator 418 may be configured to provide the generated digital twin 608 to a digital twin provider 424 as described the context of FIGS. 4A and 5 (not shown).

Aspect agent 414 may be configured to retrieve at least two different aspect models from aspect model DB 416, for example as described in the context of FIG. 4A. For instance, apparatus 402 may use predefined aspect model identifiers or may use aspect model identifiers contained in a request received by data gathering unit 412 (see FIG. 5). At least one of the retrieved aspect models may be related to environmental attribute(s) associated with chemical products as previously described. The aspect agent 414 may be configured to generate-for each retrieved aspect model-a digital twin data set from the gathered data received from data gathering unit 412 according to the respective aspect model. For instance, the aspect agent 414 may generate two digital twin data sets 604, 606 if two different aspect models are received. Each digital twin data set may be associated with the respective aspect model used for its generation. The aspect agent 414 may be configured to store the generated digital twin data set(s) and associated data, such as digital twin data set identifier(s), in DT storage 422 (see FIG. 4A). Aspect agent 414 may be configured to provide at least part of the generated digital twin data set(s) to digital twin generator 418.

The decentral ID generator 420 may be configured to generate and provide a decentral digital twin identifier to digital twin generator 418 as described in the context of FIG. 4A and FIG. 5. The decentral ID generator 420 may be a central node or a decentral node and may generate the decentral digital twin identifier upon receiving a request from the digital twin generator 418 (see for example FIG. 4A). The decentral ID generator 420 may be configured to generate access data, such as digital twin data set identifier(s).

FIG. 7 illustrates a flow chart of a computer-implemented method for generating a digital twin of a physical entity of a chemical product in accordance with an example embodiment of the present disclosure. The digital twin may be generated for a chemical product 206 produced by a chemical production 204 from one or more inbound materials 202. The chemical production may be a chemical production 204 as described in relation to FIGS. 2A to 3. The digital twin may be generated by the operating system 208 of the chemical production 204. The operating system may comprise an apparatus for generating digital twin(s) 402 as described in the context of FIG. 4A to FIG. 6. The request to generate the digital twin may be triggered manually by a user via a user interface, for example using I/O device 426 (see FIG. 4A). The request to generate the digital twin may be triggered automatically, for example upon detection of a packaging of the produced chemical product as described in the context of FIG. 3 and FIG. 5.

In block 702, a request to generate a digital twin of a chemical product may be received. The request may contain data related to the chemical product. The request may further contain data related to at least one aspect model associated with chemical products. The request may be generated manually or automatically, as previously described. Data related to the chemical product may include a chemical product identifier, such as a batch number, a LOT number, a chemical product name and/or a chemical product ID. Data related to at least one aspect model may include aspect model identifier(s).

In block 704, it is determined whether a digital twin for the chemical product is already existing. Hence, it may be determined whether the digital twin has already been generated and stored, for example in DT storage 422. This determination may be based on the data related to the chemical product contained in the received request, such as the chemical product identifier. For instance, the chemical product identifier may be used to determine whether a digital twin associated with said chemical product identifier is already existing, e.g. already stored in DT storage 422. If a digital twin of the chemical product is already existing, the method proceeds to block 706. Otherwise, the method proceeds to block 710 as described later on.

In block 706, it is determined whether the existing digital twin is to be updated. The determination may be made based on data contained in the received request. For instance, the request may contain data being indicative of updating the digital twin. If a digital twin is to be updated, the method proceeds to block 708. Otherwise, the method ends or proceeds to block 702.

In block 708, the digital twin is updated. Updating may include performing blocks 710, 714 and 716 described later on, e.g. generating further digital twin data set(s). Updating may include changing data contained in the existing digital twin or existing digital twin data set(s) or adding data contained in existing digital twins or existing digital twin data set(s).

In block 710, data associated with the chemical product may be gathered from one or more distributed data sources based on the data related to the chemical product contained in the request received in block 702. The gathered data may contain at least one measured and/or determined physical and/or chemical property of the chemical product. The data may be gathered as described in the context of FIGS. 4A to 5 from one or more distributed data sources, for example distributed data sources of data source layer 404. The data may be gathered directly from the one or more distributed data sources of data source layer 404. The data may be consumed the data from service layer 428, for example as described in the context to FIG. 4B. Apparatus 402 may determine whether the request contains chemical product identifier(s). If this is the case, the computing system may use said chemical product identifier(s) to gather the data from the distributed data source(s). Otherwise, the computing system may determine the chemical product identifier(s) from the data contained in the received request. For instance, the computing system may retrieve the chemical product identifier(s) from a database based on the data contained in the received request.

In block 712, a decentral digital twin identifier associated with the gathered data and optionally a data owner may be provided. The decentral digital twin identifier may be provided in response to a request generated, for example, by digital twin generator 418 (see FIG. 4A, FIG. 5). The request may contain a data owner identifier and/or a chemical product identifier. The data owner may be the data owner of the gathered data and/or the data contained in the distributed data sources. The data owner may be the chemical product producer. The data owner may be a data owner as previously described. The decentral digital twin identifier may be requested from a central or decentral node, for example as described in the context of FIG. 4A. The decentral identifier may be one or more DID(s) and/or UUID(s), for example as described in the context of FIG. 4A. Block 712 may also be performed after any one of blocks 714 and 716.

In block 714, aspect model(s) associated with chemical products may be retrieved, for example as described in the context of FIGS. 4A and 5. At least part of the aspect model(s) may be associated with environmental attributes associated with chemical products. The aspect model(s) may be retrieved based on aspect model identifier(s) contained in the received request or based on data contained in the received request. The aspect model(s) may be retrieved from a data storage, such as aspect model DB 416 (see for example FIG. 4A).

In block 716, a digital twin data asset may be generated for each aspect model retrieved in block 714. The digital twin data set may be generated by applying each aspect model retrieved in block 714 to the data gathered in block 710, for example as described in the context of FIG. 4A to FIG. 6.

In block 718, the digital twin may be generated. The digital twin may include the decentral digital twin identifier received in block 812 and the digital twin data set(s) generated in block 716. The decentral digital twin identifier may be linked to at least part of the digital twin data set generated in block 716 to generate the digital twin (see for example FIG. 6). The generated digital twin may contain digital twin data set identifier(s). The digital twin data set identifier(s) may be generated by the digital twin generator 418 (see for example FIG. 4A, FIG. 5). The digital twin may further include a chemical product identifier. The chemical product identifier may be the chemical product identifier contained in the received request. The generated digital twin may be stored in a DT storage 422 as described in the context of FIG. 4A. Storage of the digital twin in DT storage 422 may improve security with respect to the access to the digital twin, since appropriate authentication and authorization schemes may be implemented between DT storage 422 and the digital twin provider 424 providing the digital twin or a part thereof to authorized decentral data consuming network nodes. The generated digital twin and/or digital twin data set(s) contained therein may be provided to a digital twin provider 424 as described in the context of FIGS. 4A to 5.

In block 720, the generated digital twin may be provided to decentral data consuming network nodes under control of the digital twin provider 424, this block being generally optional. The digital twin may be provided to decentral data consuming network node(s) as described in the context of FIG. 13.

In block 722, a physical identifier may be assigned to the decentral digital twin identifier included in the digital twin, this block being generally optional. This block may be performed, for example, if the decentral digital twin identifier contained in the digital twin is used to generate the digital access element (see for example FIG. 9 and FIG. 10). This allows to link the decentral digital twin identifier and thus the digital twin to the physical entity of the chemical product. Assigning the decentral digital twin identifier to the physical identifier may include generating a physical identifier having embedded the decentral digital twin identifier. The physical identifier may be generated by an ID assignor, for example as described in the context of FIG. 5 and may be attached to the chemical product, for example using a labelling device.

FIG. 8 illustrates a flow chart of a method for generating a digital access element associated with a digital twin of a chemical product in accordance with an example embodiment of the present disclosure. Since the digital twin is associated with the physical entity of the chemical product, the digital access element is also, at least indirectly, associated with the physical entity of the chemical product. The digital access element may allow for an indirect access to the digital twin or a part thereof, i.e. an access to digital twin via the digital access element. Access to the digital access element itself can remain unrestricted while still allowing for controlled access to the digital twin or parts thereof. The chemical product may be produced by a chemical production from one or more inbound materials. The chemical production may be a chemical production 204 as described in the context of FIGS. 2A to 3. The chemical production may comprise or be associated with an operating system 208. The operating system may comprise an apparatus for generating digital twin(s) as described in the context of FIGS. 4A to 5. The operating system may comprise an apparatus for generating digital access element(s) as described in the context of FIG. 9. The operating system may be communicatively coupled to the apparatus for generating digital twin(s) and/or for generating digital access element(s). The digital access element may correspond to a DID document associated with the DID used to generate the digital twin. Such DID document may contain the DID contained in the generated digital twin, digital twin data set identifiers associated with digital twin data sets contained in the digital twin and access data. Access data may include digital representations pointing to the digital twin data set(s) as described in the context of FIG. 4A. The digital access element may correspond to a DID document associated with a further decentral identifier. The chemical digital access element may correspond to a data structure comprising a decentral digital twin identifier, further identifier(s) such as a digital twin data set identifier, and access data, for example as illustrated in FIG. 10.

In block 802, a digital twin of a physical entity of a chemical product may be generated. The digital twin may be generated by the method described in the context of FIG. 7. Block 802 may be performed using an apparatus for generating digital twin(s) as described in the context of FIGS. 4A to 5. The generated digital twin may be stored on a data storage medium, such as digital twin storage 422.

In block 804, a request to provide a decentral access element identifier associated with the digital twin may be received. The decentral identifier may further be associated with a data owner. The data owner may be the data owner of the digital twin data set(s) contained in the digital twin as described previously. The data owner may be the chemical product producer as described previously. The decentral access element identifier may be a DID. The decentral access element identifier may be a UUID. The request may be generated by a requestor, for example as described in the context of FIG. 9. The request may contain an owner identifier and/or a chemical product identifier as previously described.

In block 806, the method may determine whether a further decentral identifier is to be provided. The decision may be based on data, such as a decentral digital twin identifier, contained in the digital twin generated in block 802. For instance, the method may proceed to block 810 if the decentral digital twin identifier contained in the digital twin is a DID. Use of the decentral digital twin allows to avoid generation of a further decentral identifier, hence allowing a more effective generation of the digital access element. The decision may be based on the programming of the routine implementing the method. For instance, the routine may be programmed to provide a further decentral identifier. Use of a further decentral identifier allows to use different identifier schemes, such as UUID and DID. This may allow to store access data necessary to access the digital twin or a part thereof in a decentralized manner using a DID document (see for example FIG. 10). If a further decentral identifier is to be provided, the method proceeds to block 808. Otherwise, the method proceeds to block 810.

In block 808, a further decentral identifier may be provided. This may include generating a further decentral identifier and providing the generated further decentral identifier, for example as described in the context of FIG. 9. The further decentral identifier may be assigned to the decentral digital twin identifier. This allows to link the digital twin with the digital access element, hence allowing access the digital twin or a part thereof using the digital access element. The further decentral identifier may be a DID. The further decentral identifier may be assigned to the decentral digital twin identifier. This may allow to link the digital twin to the respective digital access element.

In block 810, the decentral digital twin identifier contained in the digital twin generated in block 802 may be retrieved. The retrieved decentral digital twin identifier may then be provided. For instance, the decentral digital twin identifier included in the generated digital twin may be retrieved from digital twin storage 422. The respective digital twin may be identified using the chemical product identifier contained in the request received in block 804. For instance, the chemical product identifier may be used to retrieve the decentral digital twin identifier contained in the digital twin associated with said chemical product identifier.

In block 812, the digital access element associated with the produced chemical product may be generated. The generated digital access element may include the decentral digital twin identifier included in the digital twin or the further decentral identifier, and access data. If the decentral digital twin identifier is a DID, the generated digital access element may correspond to a DID document associated with the DID. The access data may refer to any data for accessing the digital twin or a part thereof as previously described. For instance, the access data may include an endpoint for data exchange or sharing (resource endpoint) or an endpoint for service interaction (service endpoint), that is uniquely identified via a communication protocol. The endpoint may be represented by the digital twin provider 424 (see for example FIGS. 5 and 9). The access data may include multiple digital representations, each digital representation pointing to a different digital twin data set contained in the digital twin. The respective decentral identifier and the access data may be associated with each other. Hence, for instance, the decentral identifier based on which the digital access element is generated may be associated with authentication information which is used as access data based on which the digital access element is generated.

In block 814, a physical identifier associated with the chemical product may be assigned to the decentral digital twin identifier/further decentral identifier included in the digital access element generated in block 812, this block generally being optional. This allows to link the digital access element and hence the digital twin associated with the decentral digital twin identifier or indirectly associated with the further decentral identifier with the to the physical entity of the chemical product. The physical identifier may correspond to a code, such as a bar code, a QR code, an embossed code, an optical holographic code, such as zero-order diffractive microstructures, or a tag, such as an RFID tag. The physical identifier may be produced by a labelling machine, for example as described in the context of FIG. 9.

In block 816, the generated digital access element may be provided for access of the digital twin or a part thereof by a decentral data consuming network node, this block being generally optional. The decentral data consuming network node may be part of a decentral network. For instance, the digital access element may be provided to a passport registry accessible by the decentral data consuming network node (see for example FIG. 9). The decentral data consuming network node may use the data contained in the digital access element, such as the decentral access element identifier and the access data, to retrieve the digital twin or a part thereof associated with the decentral access element identifier from a decentral data providing network node, such as digital twin provider 424 as described, for example, in the context of FIG. 13. The decentral data providing network node 416 may authorize access to the digital twin based on the decentral digital twin identifier associated with the digital access element.

The generated digital access element allows a simplified and customizable data sharing or exchange of digital twin data associated with the produced chemical product from chemical industry to chemical supply chain participants.

FIG. 9 illustrates an example system and associated methods for generating a digital access element associated with a digital twin of a chemical product produced by a chemical production and providing access to the generated digital twin. The apparatus for generating digital access element(s) of digital twins associated with chemical product(s) may be included in operating system 208 of a chemical production 204 (see for example FIG. 2A, FIG. 2B). The apparatus for generating digital access element(s) of digital twins associated with chemical product(s) may be communicatively coupled to the operating system 208 of a chemical production 204 (see for example FIG. 2C). The digital twin may be generated as described in the context of FIGS. 4A to 5.

The chemical production 204 may produce at least one chemical product 206 from one or more inbound material(s) 202. The inbound materials may be provided to the chemical production 204, for example as described in the context of FIG. 2B and FIG. 2C. The inbound materials may enter the system boundary of the chemical production 204 at the entry point, such as a production plant or a material storage associated with the chemical production 204. The inbound materials may be used in the chemical production 204 to produce one or more chemical product(s) from the inbound materials, for example as described in the context of FIG. 2B and FIG. 2C. The operating system 208 of the chemical production 204 may monitor and/or control the chemical production 204 based on operating parameters of the different processes as described in the context of FIG. 5.

The produced chemical products 206 may be provided at one or more exit points of the chemical production. The chemical product 206 may exit the system boundary 502 of the chemical production 204. Upon producing the chemical product 206 or exiting of the chemical product 206 of the chemical production 204, the digital access element may be generated. The digital access element(s) may be generated by an apparatus for generating digital access element(s) 902. The apparatus 902 may be configured to generate the digital access element(s). The apparatus 902 may be configured to receive a request to provide a decentral access element identifier associated with the digital twin. The apparatus 902 may be configured to generate-in response to the received request-the digital access element(s). In this embodiment, the apparatus 902 may include an apparatus for generating digital twin(s), such as apparatus 402 described in the context of FIGS. 4A to 4C. In another embodiment (not shown), the apparatus 902 may be communicatively coupled to an apparatus for generating digital twin(s), such as apparatus 402 described in the context of FIGS. 4A to 4C.

In this embodiment, apparatus 902 may further include a decentral ID generator 420. In another embodiment (not shown), the decentral ID generator 420 may be part of apparatus 402, e.g. apparatus 902 may not comprise a further decentral ID generator 420. Instead, decentral ID generator 420 of apparatus 402 may be configured to provide the decentral access element identifier (see for example FIG. 4A).

In this embodiment, apparatus 902 may further include a decentral ID provider 506. In another embodiment (not shown), the decentral ID provider 506 may be part of apparatus 402, e.g. apparatus 902 may not comprise a further decentral ID generator 506. Instead, decentral ID provider 506 of apparatus 402 may be configured to provide the decentral access element identifier (see for example FIG. 4A). While the decentral ID generator 420 and the decentral ID provider 506 are shown in FIG. 9 as separate units, their functions may be combined within a single unit such that the apparatus 902 comprises a decentral ID providing unit configured to perform the functions of decentral ID generator 420 and decentral ID provider 506.

A requestor 904 may be configured generate the request for the decentral access element identifier. Said request may be triggered by a labelling system such as a QR Code generator. The request may include an owner identifier and/or a chemical product identifier as previously described. The request to provide the decentral access element identifier may be provided to a decentral ID generator 420 configured to provide the decentral access element identifier, for example as described in the context of FIG. 8. The decentral ID generator 420 may be configured to retrieve the decentral digital twin identifier included in the digital twin associated with the chemical product as described in the context of FIG. 8. For instance, the decentral ID generator 420 may have access to digital twin (DT) storage 422 and may retrieve the decentral digital twin identifier based on the chemical product identifier contained in the received request. The decentral ID generator 420 may be configured to generate a further decentral identifier. The decentral ID generator 420 may provide the generated further decentral identifier or the retrieved decentral digital twin identifier to a decentral ID provider 506.

The decentral ID provider 506 may provide the retrieved decentral digital twin identifier or the generated further decentral identifier to the requestor 904. The decentral ID provider 506 may associate the further decentral identifier to the decentral digital twin identifier. The requestor 904 may be configured to associate the received decentral digital twin identifier/further decentral identifier with the produced chemical product. The requestor 506 may hence contain an ID assignor configured to assign the decentral digital twin identifier/further decentral identifier to a physical identifier. Such association may include encoding the decentral identifier into a code, such as a bar code, QR code, embossed code, optical holographic code, or a tag, such as an RFID tag, and providing the code or tag for labelling the chemical product. This way a physical identifier may be provided that relates the physical entity of the chemical product with the decentral digital twin identifier/further decentral identifier received from decentral ID provider 506. Since the physical identifier is associated with the chemical product and its virtual digital access element and digital twin, the chemical product can be provided associated with the digital access element which in turn allows access to the digital twin or a part thereof associated with said chemical product. The chemical product associated with the physical identifier may hence be provided physically and the at least one digital access element and digital twin or part thereof associated with the physical identifier may be provided virtually.

The decentral ID provider 506 may provide the decentral digital twin identifier/further decentral identifier to a digital access element generator 908 configured to generate the digital access element based on the decentral digital twin identifier/further decentral identifier received from decentral ID provider 506 and access data. The digital access element generator 908 may generate the digital access element as described for example in the context of FIG. 8. The generated digital access element may include the decentral access element decentral identifier and access data. The decentral access element identifier may correspond to or be associated with the decentral digital twin identifier included in the digital twin. This allows to link the digital twin to the digital access element, thus allowing to use the digital access element as a vehicle to convey a digital asset, such as a digital twin or a part thereof, associated with the physical entity of a chemical product to the chemical product consumer. The access data may include digital representation(s) pointing to the digital twin or a part thereof. Said representation may include the endpoint address of the decentral data providing network node associated with the digital twin (i.e. the decentral data providing network node 424 associated with the respective digital twin storage 422). Use of the endpoint address of the decentral data providing network node allows to avoid disclosure of the internal endpoint address to the digital twin (DT) storage 422, thus improving the security and avoiding unintended access or leakage of the digital twin or a part thereof. The digital access element may include or be related to one or more authentication mechanisms associated with the decentral access element identifier and/or the access data. The authentication mechanisms may be used as described for example in the context of FIGS. 13, 14A and 14B. The digital access element may relate to one or more authorization mechanisms associated with the decentral access element identifier and/or the access data. The authorization mechanisms may be used as described for example in the context of FIG. 13.

The generated digital access element may be provided to a digital twin (DT) storage 422. This allows to store the generated digital access element and hence avoids regeneration of the digital access element. The generated digital access element may be provided to a digital twin provider 424 (not shown). The generated digital access element may be provided to access element registry 908. The access element registry 908 may be part of a decentral network 508. The access element registry 908 may be configured to store digital access element(s) and may serve as a central or decentral repository for existing digital access elements. For instance, the access element registry 908 may store decentral access element identifiers and associated access data. The access element registry 908 may be available to the public, hence allowing transparency on existing digital access elements and associated digital twins of chemical products. However, access to the digital twins or parts thereof associated with said digital access elements may be controlled by the data owner of the digital access element(s), for example by using a decentral data providing network node implementing appropriate authentication and authorization schemes. This allows to retrain the control of access and use of data with the data owner while at the same time allowing transparency on available digital twins and associated digital twin data set(s).

Decentral data consuming network node(s) 510 may have access to the access element registry 908 and may retrieve access data based on the decentral access element identifier, for example as described in the context of FIG. 13. The decentral data consuming network node(s) 510 may be part of a decentral network 508. The decentral data consuming network node(s) 510 may be associated with the chemical product consumer, for example as described in the context of FIG. 13. This allows transfer of or access to the digital twin or a part thereof in a controlled and secure manner.

The digital twin provider 424 may be configured to provide the digital twin or a part thereof for access by a decentral data consuming network node 510. The digital twin provider 424 may be configured to provide the digital twin or the part thereof based on a decentral digital twin identifier and optionally access data received from the decentral data consuming network node 510, for example as described in the context of FIG. 13. The digital twin provider 424 may control the access to the digital twin or the part thereof by the decentral data consuming network node 510. The digital twin provider 424 may be a decentral data providing network node associated with the chemical production 204. The digital twin provider 424 may be associated with or under control of a data owner of the digital twin. The digital access element may be used to access the digital twin or a part thereof, for example as described in the context of FIG. 13. The described system and associated method allow to generate digital access elements associated with digital twins of chemical products. The generated digital access elements allow a simplified and customizable data sharing or exchange of digital twin data associated with the produced chemical product from chemical industry to chemical supply chain participants.

FIG. 10 shows an example of decentral identifier-based owner data 1002, decentral identifier-based digital access element 1004 data and a decentralized identity manager 1006.

The decentral identifier may be a Decentralized Identifier (DID). The decentral identifier-based digital access element may in this case be a DID document 1004 associated with the DID. Besides the DID document 1004 serving as digital access element, FIG. 10 shows a DID owner data element 1002 including decentral identifier-based owner data. Generally, the decentral identifier-based owner data may include the decentral identifier associated with a subject such as digital twin data set(s) and may include one or more authentication mechanism(s). The decentral identifier-based owner data 1002 may include owner data that is electronically owned and controlled by the DID owner. In this context electronically owned may refer to data that is stored in an owner repository or wallet. Such data may be securely stored and/or managed on an organizational server or client device. The decentral identifier-based owner data 1002 may include a DID, a private key and a public key. The DID owner may own and control the DID that represents an identity associated with the DID subject, a private key and public key pair that are associated with the DID. DID may be understood as an identifier and authentication information associated with or uniquely linked to the identifier.

The DID subject may be a raw material, a basic substance, a chemical product, or an end product. The DID subject may be a machine, a system, or a device used for producing the raw material, the basic substance, the chemical product, the intermediate product, or the end product, or a collection of such machine(s), device(s) and/or system(s). The DID owner may be a supply chain participant or a manufacturer such as a chemical manufacturer producing chemicals. The DID owner may be an upstream participant in the supply chain of the chemical manufacturer such as a supplier that supplies raw chemical products or precursors to produce the chemical product. The DID owner may be a downstream participant in the supply chain of the chemical manufacturer such as a customer that consumes chemical products to produce an intermediate product, the component, the component assembly or the end product. The DID owner may be any participant of the supply chain including raw chemical product supplier, intermediate chemical products manufacturer, intermediate part manufacturer, component manufacturer, component assembly manufacturer or end product manufacturer.

The DID may be any identifier that is associated with the DID subject and/or the DID owner. Preferably, the identifier is unique to the DID subject and/or DID owner. The identifier may be unique at least within the scope in which the DID is anticipated to be in use. The identifier may be a locally or globally unique identifier for the raw material, the precursor, the basic substance, the chemical product, the intermediate product, the component, the component assembly, the end product or a collection thereof; the machine, the system, or the device used for producing the raw material, the basic substance, the chemical product, the intermediate product, the component, the component assembly or the end product, or the collection of such machine(s), device(s) and/or system(s); the chemical manufacturer producing chemicals, the upstream participant in the supply chain of the chemical manufacturer, the downstream participant in the supply chain of the chemical manufacturer or a collection thereof; any participant of the supply chain including raw chemical product supplier, intermediate chemical products manufacturer, intermediate part manufacturer, component manufacturer, component assembly manufacturer or end product manufacturer or a collection thereof.

The DID may be any identifier that is associated with the DID subject and the DID owner. Preferably, the DID is unique to the DID subject and/or DID owner. The DID may be unique at least within the scope in which the DID is anticipated to be in use. The DID may be a locally or globally unique identifier for any of the above mentioned possible DID subjects. The DID may also be a Uniform Resource Identifier (URI) such as a Uniform Resource Locator (URL). Moreover, the DID may be an Internationalized Resource Identifier (IRI). The DID may be a Uniform Resource Identifier (URI) such as a Uniform Resource Locator (URL). The DID may be an Internationalized Resource Identifier (IRI). The DID may be a random string of numbers and letters for increased security. In one embodiment, the DID may be a string of 128 letters and numbers e.g. according to the scheme did: method name: method specific-did such as did: example: ebfeb1f712ebc6f1c276e12ec21. The DID may be decentralized ID independent of a centralized, third-party management system and under the control of the DID owner.

The digital access element as DID document 1004 may be associated with the DID, i.e. the DID included in the decentral identifier-based owner data 1002. Accordingly, the digital access element may include a reference to the DID, which is associated with the DID subject that is described by the DID document 1004. The DID document 1004 may also include an authentication information such as the public key. The public key may be used by third-party entities that are given permission by the DID owner/subject to access information and data owned by the DID owner/subject. The public key may also be used for verifying that the DID owner, in fact, owns or controls the DID. The DID document may include authentication information, authorization information e.g. to authorize third party entities to read the DID document or some part of the DID document e.g. without giving the third party the right to prove ownership of the DID.

The digital access element 1004 may include one or more representations that digitally link to the digital twin data set(s), e.g. by way of service endpoints. A service endpoint may include a network address at which a service operates on behalf of the DID owner. In particular, the service endpoints may refer to services, such as decentral data providing network node(s), of the DID owner that give access to the digital twin or a part thereof. Such services may include services to read or analyze chemical product data contained in the digital twin or the part thereof. Chemical product data may include chemical product declaration data, chemical product safety data, certificate of analysis data, emission data, product carbon footprint data, product environmental footprint data, chemical product specification data, product information, technical application data, production data, preference data associated with the chemical product or combinations thereof.

The digital access element 1004 may include various other information such metadata specifying when the digital access element was created, when it was last modified and/or when it expires.

The DID and digital access element 1004 may be associated with a data registry node such as a centralized data service system or a decentralized data service system 1006, e.g. a distributed ledger or blockchain or a decentralized file system. The distributed ledger or blockchain may be used to store a representation of the DID that points to the digital access element 1004. A representation of the DID may be stored on distributed computing nodes of the distributed ledger or blockchain 1006. For example, DID hash may be stored on multiple computing nodes of the distributed ledger and point to the location of the digital access element 1004. In some embodiments, the digital access element 1004 may be stored on the distributed ledger 1006. Each of the computing nodes may store a copy of the distributed ledger 1006. In this way, each DID hash can be stored redundantly, thereby allowing for an increased data safety. DIDs associated with a plurality of different digital access element 1004 may be included in the distributed ledger 1006.

In some embodiments, the digital access element 1004 may be stored on the distributed ledger 1006, i.e. either additionally or alternatively to the associated DID representation being stored on the distributed ledger 1006. In other embodiments, the digital access element 1004 may be stored in a data storage (not illustrated) that is associated with the distributed ledger or blockchain or decentralized file system.

The distributed ledger or blockchain 1006 may be any decentralized, distributed network that includes various computing nodes that are in communication with each other. For example, the distributed ledger 1006 may include a first distributed computing node, a second distributed computing node, a third distributed computing node, and any number of additional distributed computing nodes (not shown). The distributed ledger or blockchain 1006 may include known technology stacks like Bitcoin (see e.g. Bitcoin documentation of Nov. 11, 2022 published https://en.bitcoin.it/wiki/Protocol_documentation), Ethereum (see e.g. Ethereum documentation of Aug. 15, 2022 published on https://ethereum.org/en/developers/docs/), Solana (see e.g. Solana documentation of Nov. 11, 2022 published on https://spl.solana.com/), Polygon (see e.g. Polygon documentation of Nov. 11, 2022 published on https://wiki.polygon.technology/) or other implementations with varying degree of data transactions performed on the distributed ledger. The description of the example framework is only for illustrative purposes and shall not be considered limiting.

FIG. 11 shows an example of certificate data 1102, digital access element data 1104 and an international data space (IDS) infrastructure 1108.

In contrast to the example of FIG. 10, the example of FIG. 11 is certificate-based. Certificate data 1102 may include authentication data of the subject and the certificate issuer. The subject may be the data owner or the IDS connector 1106 operated by or being under control of the data owner. Certificate data 1102 may further include the subject name the certificate is issued for, such as a data owner name, the data owner ID, the IDS connector name, the IDS connector ID or a combination thereof. The certificate may be a X.509 certificate such as X509v3. The certificate data 1102 may be associated with an IDS infrastructure 1108 including e.g. a certificate issuing service (CA) 1110 and/or a dynamic provisioning service (DAPS) 1112 providing dynamic attribute tokens (e.g. Oauth Access Tokens). Certificate data 1102 may further include various other information such metadata specifying when the certificate was created, when it was last modified and/or when it expires. The information required to verify the certificate data 1102 may be provided via an authentication registry associated with the certificate issuing service and/or a dynamic provisioning service. For instance, in the IDSA Reference Architecture Model, Version 3.0 of April 2019, an IDS connector 1106 associated with or under control of the data owner, a Certification Authority (CA) 1110, a Dynamic Attribute Provisioning Service (DAPS) 1112 and an IDS connector associated with the decentral data consuming network node (not shown) are used to verify the identity prior to performing a data exchange (see for example FIGS. 13 to 14B).

The certificate data 1102 and the digital access element data 1104 may be stored within the IDS connector 1106 (also denoted as decentral data providing network node). The IDS connector 1106 may be associated with or under control of the data owner of the chemical product data.

The digital access element data 1104 may include a decentral identifier, authorization data and endpoints associated with the chemical product data. The decentral identifier may be a Universally Unique Identifier (UUID), such as a UUIDv4. The UUIDv4 may conform to the following format: [0-9a-fA-F]{8}-[0-9a-fA-F}{4}-[0-9a-fA-F]{4}-[0-9a-fA-F]{4}-[0-9a-fA-F]{12}. The authorization information may be used to control access to the chemical product data or a part thereof, for example as described in the context of FIGS. 14A and 14B. Endpoints may include any digital representation pointing to the chemical product data or a part thereof (see for example FIG. 8 to 10). Chemical product data may include the data mentioned in the context of FIG. 10.

The digital access element data 1104 may include various other information such metadata specifying when the chemical product passport was created, when it was last modified and/or when it expires.

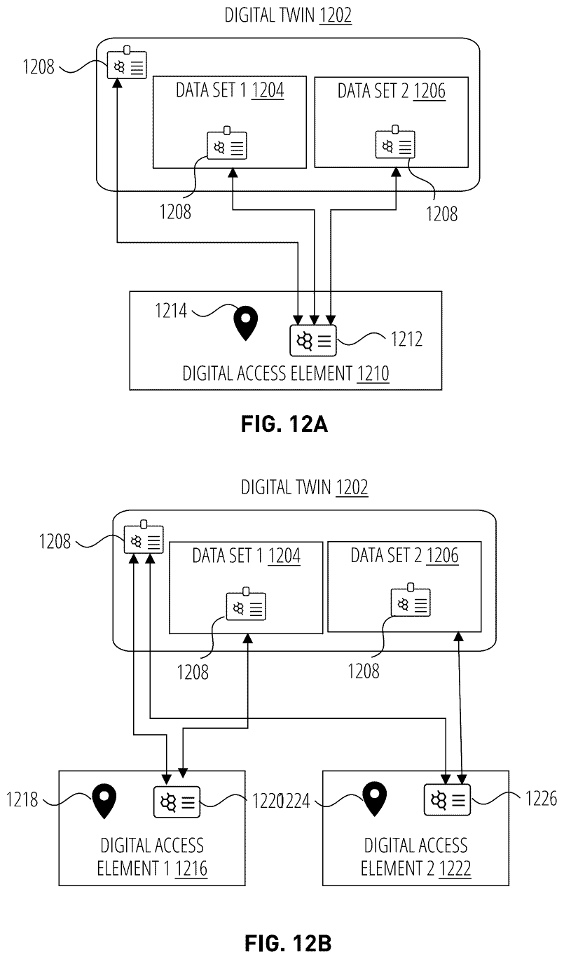

FIG. 12A illustrates a first example of a linkage between the data sets of a digital twin and a digital access element via the decentral digital twin identifier. The digital twin 502 may be generated as described in the context of FIGS. 4A and 7. The digital twin 502 may be stored in DT storage 422. The digital access element 1210 associated with the physical entity of the chemical product may be generated as described in FIG. 9 and FIG. 10. The data sets 1204, 1206 associated with the digital twin 1202 are each assigned to the decentral digital twin identifier 1208. Use of said decentral digital twin identifier 1208 hence allows to identify all existing data sets contained in digital twin 1202. The decentral digital twin identifier 1208 may include further identifiers, such as data set identifiers of data sets 1204, 1206. This allows to uniquely identify the data sets contained in the digital twin using the decentral digital twin identifier 1208 and the respective data set identifier.

The digital access element 1210 contains a decentral passport identifier 1212. The decentral passport identifier 1212 may be a decentral identifier linked to the decentral digital twin identifier 1208 included in the digital twin. The decentral passport identifier 1212 may correspond to the decentral digital twin identifier 1208 included in the digital twin 1202. The latter avoids generation of a new decentral identifier and linking of the newly generated decentral identifier to the decentral digital twin identifier included in the digital twin.

The digital access element further contains access data 1214. The access data 1214 may include digital representation(s) pointing directly or indirectly to the storage structure storing the digital twin or a part thereof (e.g. data sets 1204, 1206), such as DT storage 422 (not shown). The access data 1214 may include a digital representation pointing to the decentral data providing network node associated with DT storage 422 (not shown).

The digital access element 1210 is linked via the decentral passport identifier 1212 to the digital twin 1202 and hence also to the data sets contained in the digital twin, thus allowing to retrieve the digital twin or a part thereof (e.g. the data set 1204, 1206) using the decentral passport identifier 1212 and access data 5112 included in the digital access element 1210 as described in the context of FIG. 13.

FIG. 12B illustrates a second example of a linkage between the digital twin 1202, associated data sets 1204, 1206 and digital access elements 1216, 1222 via the decentral digital twin identifier 1208 and decentral passport identifiers 1220, 1226. The digital twin 1202 may be generated as described in in the context of FIGS. 4A and 7. The digital access elements 1216, 1222 associated with the physical entity of the chemical product may be generated as described in FIG. 9 and FIG. 10. The data sets 1204, 1206 associated with the digital twin 1202 are assigned to the decentral digital twin identifier 1208. Use of said decentral digital twin identifier 1208 thus allows to identify all existing data sets contained in digital twin 1202.

In this example, a first digital access element 1216 is generated for data set 12504 and a second digital access element 1222 is generated for data set 1206. Digital access elements may be generated for each data set or for at least part of the data sets contained in a digital twin. Each digital access element is linked by the decentral passport identifier 1220, 1226 via the decentral digital twin identifier 1208 to the respective data set. Each digital access element 1216, 1222 contains access data 1218, 1224. Said access data 1218, 1224 may include a digital representation pointing to the product data set as described in the context of FIG. 12A.

FIG. 12A and FIG. 12B only show two example embodiments and any number of digital access elements and any number of data sets within the digital twin may be possible. For instance, a first digital access element may be generated for a first number of data sets while a second digital access element may be generated for a second number of data sets. The number of data sets may include one or more data sets. FIG. 13 shows a schematic illustration of providing access by a decentral data providing network node to a digital twin or a part thereof associated with a chemical product using a digital access element. Access to the digital twin or the part thereof may be requested by a decentral data consuming network node. The chemical product 206 may be produced by a chemical production, such as chemical production 204 described in the context of FIGS. 2A to 2C. The digital twin may include the decentral digital twin identifier and at least one measured physical and/or chemical property of the chemical product and/or at least one physical and/or chemical property determined from collected data associated with the production and/or the use of the chemical product.

A digital access element may be generated upon or after production of the chemical product, for example as described in the context of FIG. 9 and FIG. 10. The digital access element may be associated with the digital twin or the part thereof. The digital access element may contain a decentral access element identifier and access data. The decentral access element identifier may correspond to or be associated with the decentral digital twin identifier of the digital twin. The access data may include digital representation(s) pointing to the digital twin or parts thereof. The access data may include digital twin data identifier(s) associated with digital twin data set(s) contained in the digital twin (see for example FIG. 10 and FIG. 11). Examples of digital access elements are illustrated in FIGS. 10 and 11. The digital access element may further include or relate to authentication and/or authorization information linked to the decentral access element identifier. The authentication and/or authorization information may be provided for authentication and/or authorization of the digital twin provider 424 and/or the decentral data providing network node 510. The digital access element may be provided to a decentral registry 908, for example as described in the context of FIG. 10. Decentral access element registry 908 may store decentral access element identifier(s) and associated access data.

The chemical product 206 as produced by the chemical production network 204 may be provided in association with the digital access element to a consumer. The consumer may process the chemical product to produce further chemical and/or discrete products. The chemical product 206 may be connected to a code, such as a bar code or QR-code, having encoded the decentral passport identifier. The consumer of the chemical product 206 may read the code through a code reader 1302. The code reader 1302 may be a smartphone running a code reading application, such as a QR code reader app. The data obtained by the code reading application may be used to determine the decentral access element identifier. The data obtained by the code reading application may be used to determine the decentral digital twin identifier. The data obtained by the code reading application may be used to determine the chemical product identifier. The data obtained by the code reading application may be used to determine the access data. The decentral access element identifier, decentral digital twin identifier, chemical product identifier and access data may be determined by code reader 1302. For instance, the decentral passport identifier determined by the code reader 1302 may be a DID and the code reader 1202 may be configured to retrieve the associated DID document containing the decentral digital twin identifier and the access data, for example using a DID resolver (see also FIG. 10). In another instance, the chemical product identifier is determined by code reader 1302 and used to retrieve the decentral access element identifier and associated access data, for example from a database, such as decentral registry 908. Hence, code reader 1302 may be configured to retrieve the digital access element containing the decentral passport identifier and digital twin location data from decentral registry 908. Code reader 1302 may be configured to provide the decentral passport identifier and/or the decentral digital twin identifier to a database 1306 associated with the consumer of the chemical product. Code reader 1302 may be configured to provide the determined decentral access element identifier, decentral digital twin identifier and access data to decentral data consuming network node 510.

Code reader 1302 may be configured to display determined/retrieved data on a user interface as illustrated by reference sign 1304. The user interface may display the determined decentral access element identifier (PP identifier), the determined decentral digital twin identifier (DT identifier) and the determined access data (DT location). In this embodiment, the decentral access element identifier and the decentral digital twin identifier differ from each other. In another embodiment, the decentral access element identifier is equal to the decentral digital twin identifier. The user interface may further display the determined chemical product identifier (CP identifier). The user interface may also allow to initiate retrieval of the digital twin or a part thereof based on the decentral access element identifier and the access data as described in the following. This process may be initiated by the button denoted “Access DT”. Upon pressing said button, code reader 1302 may send a request to access the digital twin or the part thereof to decentral data consuming network node 510.

The decentral data consuming network node 510 associated with the consumer of the chemical product may generate a request to access the digital twin or a part thereof. Decentral data consuming network node 510 may generate the request based on the data received from code reader 1302. For instance, decentral data consuming network node 510 may generate the request based on the decentral digital twin identifier received from code reader 1302. Data consuming network node 510 may generate the request based on the decentral access element identifier and/or decentral digital twin identifier provided to database 1306. For example, decentral data consuming network node 510 may be configured to retrieve the decentral digital twin identifier and access data from decentral registry 908 based on the decentral access element identifier stored in database 1306. The request generated by decentral data consuming network node 510 may include the decentral digital twin identifier and a decentral participant identifier associated with decentral data consuming network node 510. Decentral data consuming network node 510 may be configured to determine the digital twin provider 424 associated with the digital twin based on the access data provided by code reader 1302 or retrieved from decentral registry 908.

Decentral data consuming network node 510 may sent the request to access the digital twin or a part thereof to the determined digital twin provider 424 as signified by arrow 1308. The digital twin provider 424 may be associated with the chemical product producer. The digital twin provider 424 may be associated with the chemical production producing the chemical product. The digital twin provider 424 may be associated with the data owner of the digital twin. In addition to the request, authentication and/or authorization information may be provided by decentral data consuming network node 510, for example as described in the context of FIGS. 14A and 14B.

The request may be authenticated (see FIGS. 14A and 14B). The request may be validated by the digital twin provider 424, for example by retrieving access rules from a database of the digital twin provider 424 based on the decentral digital twin identifier contained in the received request. At least part of the retrieved access rules may be applied to the received request. This allows to filter decentral data consuming network nodes requesting access based on the decentral participant identifier(s) associated with said network nodes. If the request is not valid, e.g. if the decentral data consuming network node is not authorized to access the digital twin data, the peer-to-peer communication channel will be terminated by digital twin provider 424 and no digital twin will be provided.

If the request is valid, digital twin provider 424 may initiate contract negotiations with decentral data consuming network node 510. Digital twin provider 424 may provide an electronic contract to decentral data consuming network node 510. The electronic contract may include access rule(s) associated with the decentral digital twin identifier. This allows the data consumer to determine access and usage conditions associated with the desired data. Digital twin provider 424 and decentral data consuming network node 510 may be configured to negotiate an electronic contract and to sign the negotiated electronic contract. Use of the electronic contract ensures that the decentral data consuming network node 510 and further systems handling the digital twin or a part thereof are complying to access rule(s) associated with the digital twin. Upon signature of the electronic contract, digital twin provider 424 may retrieve or request the digital twin stored in DT storage 422 based on the decentral digital twin identifier contained in the received request as designated by arrows 1310 and 1312. Digital twin provider 424 may apply determined access rule(s) to the retrieved or received digital twin. Afterwards digital twin provider 424 may provide the digital twin or parts thereof according to the applied access rule(s) to the decentral data consuming network node 510 as signified by arrow 1314.

The digital twin provided by digital twin provider 424 may be stored in database 1306 associated with the decentral data consuming network node 510 according to the access rule(s) as signified by arrow 1316. Through the decentral digital twin identifier, the digital twin can be uniquely associated with the chemical product. Through the decentral network, the digital twin or a part thereof may be transferred between the producer of the chemical product and the consumer of the chemical product in a standardized and secure way, allowing the producer of the chemical product to control access to the digital twin or the part thereof by multiple decentral data consuming network nodes existing within the decentral network. This way, the digital twin or the part thereof can be shared with unique association to the chemical product and without central intermediary directly between the participants of the chemical product ecosystem. This allows for transparency of digital twins within the chemical product ecosystem.

The generation of a digital twin of a physical entity of a produced chemical product as well as the generation of a digital access element associated with said digital twin allows to share chemical product data set contained in the digital twin under simplified and customizable conditions without compromising data security and data sovereignty.

FIG. 14A and FIG. 14B each show an example method for authentication to access a digital twin or a part thereof associated with a chemical product.

In the process of authentication, various communication patterns may be implemented to verify identities. FIG. 14A illustrates one example communication pattern that may occur between a digital twin provider or decentral data providing network node 424 and a decentral data consuming network node 510. In this case, the decentral data providing network node 424 may act as verifying entity and no separate service may be used for authentication. The decentral data consuming network node 510 may request a service from the decentral data providing network node 424 (see step [1] of FIG. 14A). The request may include the decentral identifier, such as a DID, or a certificate of the decentral data consuming network node 510. In response to the request, the decentral data providing network node 424 may access a registry such as a central or decentral authentication registry to retrieve data related to the authentication mechanism(s) associated with the decentral identifier. For instance, the central authentication registry may provide data related to authentication mechanism via an authentication service issuing access token. Further for instance, the decentral authentication registry may provide data related to authentication mechanism by generating a request token. Data related to authentication mechanism may include a public key of the decentral data consuming network node 510.

Based on the retrieved data related to the authentication mechanism(s), the decentral data providing network node 424 may generate an authentication request (corresponding for example to authentication request tokens or dynamic attribute tokens) (see step [2] of FIG. 14A). The authentication request may be generated based on a public key of the decentral data consuming network node 510 and/or the private key of the decentral data providing network node 424. The generated authentication request may be sent to the decentral data consuming network node 510 (see step [3] of FIG. 14A).

Based on the received authentication request, the decentral data providing consuming node 510 may generate authentication data for responding to the authentication request (see step [4] of FIG. 14A). The generated authentication data may be sent back to the decentral data providing network node 424 (see step [5] of FIG. 14A).

Receiving the response including the authentication data from decentral data consuming network node 510, the decentral data providing network node 424 may then validate the authentication data (see step of FIG. 14A). In response to the validation, the decentral data providing network node 424 may grant or deny the service request of the decentral data consuming network node 510 (see step [7] of FIG. 14A). In case access is granted, the decentral data consuming network node 510 may provide a decentral digital twin identifier associated with the digital twin to be retrieved and the decentral participant identifier associated with the decentral data consuming network node 510 and the decentral data providing network node 424 may authenticate the received request and -upon authentication-may provide the digital twin or a part thereof, for example as described in FIG. 13.

FIG. 14B illustrates another example communication pattern that may occur between a digital twin provider or decentral data providing network node 424, a decentral data consuming network node 510 and an authentication service 1404.

First, the decentral data consuming network node 510 may request a service or initiates a communication with the decentral data providing network node 424 (see step [1] of FIG. 14B). The request may include the decentral identifier, such as a DID, of the decentral data consuming network node 510 as described in relation to FIG. 14A.

Receiving the request, the decentral data providing network node 424 may access a distributed ledger to retrieve one or more authentication mechanism(s) associated with the decentral identifier. Based on the retrieved authentication mechanisms(s), the decentral data providing network node 424 may generate an authentication request (see step [2] of FIG. 14B).

Here, the at least one of the retrieved authentication mechanism(s) may be provided via the authentication service 1404. As such, in some embodiments, the generated authentication request may be sent to the authentication service 1404 directly (see step [3] of FIG. 14B). Receiving the authentication request from the decentral data providing network node 424, the authentication service 1404 may generate the authentication data (see step [4] of FIG. 14B).

The authentication data generated by the authentication service 1404 may be sent to the decentral data consuming network node 510 (see step [5] of FIG. 14B).

Decentral data consuming network node 510 then, in turn, may pass on the authentication data to the decentral data providing network node 424 (see step [6] of FIG. 14B). Receiving the authentication data, the decentral data providing network node 424 may then validate the authentication data (see step [7] of FIG. 14B). In response to the validation, the decentral data providing network node 424 may grant or deny the service request of the decentral data consuming network node 510 (see step [8] of FIG. 14B). In case access is granted, the decentral data consuming network node 510 may provide a decentral digital twin identifier associated with the digital twin to be retrieved and the decentral participant identifier associated with the decentral data consuming network node 510 and the decentral data providing network node 424 may authenticate the received request and—upon authentication—may provide the digital twin or a part thereof, for example as described in FIG. 13.

Alternatively, in some embodiments, after the decentral data providing network node 424 may generate an authentication request, the decentral data providing network node 424 may send the authentication request to decentral data consuming network node 510. The decentral data consuming network node 510 may pass on the authentication request to the authentication service 1404.

Further, after the authentication service 1404 may generate the authentication data, in some embodiments, the authentication service 1404 merely contacts the decentral data consuming network node 510 to notify the receipt of the authentication request and to obtain consent. When the decentral data consuming network node 510 receives the notification, the decentral data consuming network node 510 consents and sends the consent back to the authentication service 1404. Receiving the consent, the authentication service 1404 then sends the authentication data directly to the decentral data providing network node 424.

Finally, in many transactions, the authentication may be mutually performed by both parties. In such a mutual authentication situation, each involved party is both a subject entity and a verifying entity. Decentral data consuming network node 510 and decentral data providing network node 424 have control over their decentral identities. At the beginning, services exchange their decentral identities. Next, each of the services accesses a distributed ledger to obtain each other's authentication mechanism(s). Each service then generates its own authentication request based on the other IDs authentication method(s). The generated authentication data is then sent to the other service. Receiving each other's authentication data, each service validates the received authentication data. Based on the validation results, the services may then perform additional communications, e.g., one service may grant or deny the service request of the other service as previously described.

FIG. 14A and FIG. 14B only show examples of authentication protocols. Also, although the communication arrows were discussed in a certain order or illustrated in a sequence of communications, no particular ordering is required unless specifically state, or required because a communication is dependent on another communication being completed prior to the communication being transmitted.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. An apparatus for generating a digital twin of a physical entity of a chemical product, the apparatus comprising: one or more computing nodes; and one or more computer-readable media having thereon computer-executable instructions which, when executed by the one or more computing nodes, configure the apparatus to perform the steps of:
receiving a request to generate the digital twin, the request including data related to the chemical product and data related to at least one aspect model associated with chemical products,
gathering data associated with the chemical product from one or more distributed data sources based on the received data related to the chemical product, wherein the data associated with the chemical product includes at least one measured physical and/or chemical property of the chemical product and/or at least one physical and/or chemical property determined from collected data associated with a production and/or a use of the chemical product,
providing a decentral digital twin identifier associated with the gathered data and optionally a data owner,
retrieving—based on the received data related to the at least one aspect model—at least one aspect model associated with chemical products,
generating—for each retrieved aspect model—a digital twin data set associated with the chemical product by applying the respective aspect model to the gathered data, and
generating the digital twin including the decentral digital twin identifier and at least part of the generated digital twin data sets.

2. The apparatus of claim 1, wherein the data associated with the chemical product includes chemical product data, in particular wherein the chemical product data includes data related to the use of the chemical product, data related to the production of the chemical product, one or more chemical product identifiers, a chemical product name, a chemical product composition, chemical and/or physical properties of the chemical product, emission data of the chemical product, recyclate content data of the chemical product, bio-based content data of the chemical product, renewable content data of the chemical product, chemical product production data, chemical product declaration data, chemical product safety data, certificate of analysis data associated with the chemical product, certificates associated with the chemical product or a combination thereof.

3. The apparatus of claim 1, wherein the digital twin further includes digital twin data set identifier(s) associated with the digital twin data set(s).

4. The apparatus of claim 1, wherein at least one digital twin data set contained in the digital twin includes the at least one measured physical and/or chemical property of the chemical product and/or the at least one physical and/or chemical property determined from collected data associated with the production and/or the use of the chemical product.

5. The apparatus of claim 1, wherein gathering the data associated with the chemical product includes
providing one or more distributed data sources containing data associated with the chemical product, wherein at least one of the distributed data sources contains data instances that relate to said chemical product,
determining—based on the received data related to the chemical product—one or more chemical product identifiers associated with the chemical product, and
gathering data associated with the chemical product from the provided distributed data sources(s) using the determined chemical product identifier(s).

6. The apparatus of claim 1, wherein at least one retrieved aspect model is related to environmental attribute(s) associated with chemical products.

7. The apparatus of claim 1, wherein the apparatus is a decentral participant network node of a decentral network.

8. The apparatus of claim 1, further including a step of providing the generated digital twin or a part thereof to a decentral data providing network node associated with a data owner of the digital twin for access by a decentral data consuming network node, wherein the access to the digital twin or the part thereof is controlled by the decentral data providing network node associated with the data owner.

9. A computer-implemented method for generating a digital twin of a physical entity of a chemical product, the method comprising:
receiving a request to generate the digital twin, the request including data related to the chemical product and data related to at least one aspect model associated with chemical products,
gathering data associated with the chemical product from one or more distributed data sources based on the received data related to the chemical product, wherein the data associated with the chemical product includes the at least one measured physical and/or chemical property of the chemical product and/or at least one physical and/or chemical property determined from collected data associated with a production and/or a use of the chemical product,
providing a decentral digital twin identifier associated with the gathered data and optionally a data owner,
retrieving—based on the received data related to the at least one aspect model—at least one aspect model associated with chemical products,
generating—for each retrieved aspect model—a digital twin data set by applying the respective aspect model to the gathered data, and
generating the digital twin including the provided decentral digital twin identifier and at least part of the generated digital twin data sets.

10. A system for generating a digital twin of a physical entity of a chemical product, the system comprising,
a data source layer configured to provide data associated with the chemical product from one or more distributed data source(s), wherein the data associated with the chemical product includes at least one measured physical and/or chemical property of the chemical product and/or at least one physical and/or chemical property determined from collected data associated with a production and/or a use of the chemical product,
optionally a service layer configured to gather the data provided by the one or more distributed data source(s), to optionally transform the gathered data, and to provide the gathered or transformed data,
a consumer layer configured to consume the data provided by the one or more distributed data sources or provided by the service layer and to generate the digital twin according to the computer-implemented method of claim 9, and
optionally a connector layer comprising at least one decentral data providing network node configured to provide access to the generated digital twin and/or to at least one digital twin data set contained in the digital twin by at least one decentral data consuming network node associated with a decentral network participant.

11. A method for providing a chemical product associated with a digital twin, the method comprising:
producing the chemical product from one or more input materials by a chemical production,
generating the digital twin by the apparatus according to claim 1, and
assigning a physical identifier associated with the produced chemical product to the decentral identifier included in the digital twin.

12. A method for processing a chemical product associated with a digital twin comprising using a digital twin as generated by the apparatus according to claim 1.

13. A digital twin as generated by the apparatus according to claim 1.

14. A computer-implemented method for generating a digital access element associated with a digital twin of a chemical product, said method comprising:
generating the digital twin associated with the chemical product by the apparatus according to claim 1,
receiving a request to provide a decentral access element identifier associated with the digital twin of the chemical product,
in response to the request, providing the decentral access element identifier and generating the digital access element including the provided decentral access element identifier associated with the digital twin and access data, and
optionally providing the generated digital access element for access to the digital twin or a part thereof by a decentral data consuming network node under control of a decentral data providing network node associated with a data owner of the digital twin or the part thereof.

15. A computer element with instructions which when executed by a computing node or a computing system, direct the computing node or computing system to carry out the steps of the computer-implemented method of claim 9.

16. A method for providing a chemical product associated with a digital twin, the method comprising:
producing the chemical product from one or more input materials by a chemical production,
generating the digital twin according to the computer-implemented method of claim 9, and
assigning a physical identifier associated with the produced chemical product to the decentral identifier included in the digital twin.

17. A computer-implemented method for generating a digital access element associated with a digital twin of a chemical product, said method comprising:
generating the digital twin associated with the chemical product according to the computer-implemented method of claim 9,
receiving a request to provide a decentral access element identifier associated with the digital twin of the chemical product,
in response to the request, providing the decentral access element identifier and
generating the digital access element including the provided decentral access element identifier associated with the digital twin and access data, and
optionally providing the generated digital access element for access to the digital twin or a part thereof by a decentral data consuming network node under control of a decentral data providing network node associated with a data owner of the digital twin or the part thereof.

18. A computer element with instructions which when executed by the apparatus according to claim 1, direct the apparatus to carry out steps the apparatus is configured to execute.
